(19) United States
(12) Patent Application Publication
(10) Pub. No.: US 2022/0058664 A1
(43) Pub. Date: Feb. 24, 2022

(54) METHODS AND APPARATUS FOR AUDIENCE MEASUREMENT ANALYSIS

(71) Applicant: The Nielsen Company (US), LLC, New York, NY (US)

(72) Inventors: Michael Richard Sheppard, Holland, MI (US); DongBo Cui, New York, NY (US); Jake Ryan Dailey, San Francisco, CA (US); Edward Murphy, Uncasville, CT (US); Diane Morovati Lopez, West Hills, CA (US); Jessica Lynn White, Plant City, FL (US); David Forteguerre, Brooklyn, NY (US)

(21) Appl. No.: 17/406,886

(22) Filed: Aug. 19, 2021

Related U.S. Application Data
(60) Provisional application No. 63/068,874, filed on Aug. 21, 2020.

(51) Int. Cl. G06Q 30/02; G06F 16/21

(52) U.S. Cl. CPC G06Q 30/0201; G06F 16/211

(57) ABSTRACT

Methods, apparatus, systems, and articles of manufacture are disclosed for audience measurement analysis including at least one memory, instructions, and processor circuitry to execute the instructions to scale at least one of subscriber duration values or total census-level duration values to generate a scaled duration value that corresponds to an impression count of at least a threshold amount of duration time, determine cross-demographic total census parameter values based on the scaled duration value, determine a search space of possible cross-demographic total census parameter values, the search space to include the determined cross-demographic total census parameter values, determine census-level metrics based on the determined cross-demographic total census parameter values, the census-level metrics including demographic census-level audience size data and demographic census duration values, output a report of the census-level metrics.

### RELATED APPLICATION

This patent claims the benefit of U.S. Provisional Patent Application No. 63/068,874, filed Aug. 21, 2020, which is hereby incorporated herein by reference in its entirety. Priority to U.S. Patent Application No. 63/068,874 is hereby claimed.

### FIELD OF THE DISCLOSURE

This disclosure relates generally to computer-based measurement and, more particularly, to methods and apparatus for audience measurement analysis.

### BACKGROUND

Media is accessible to users through a variety of platforms. For example, media can be viewed on television sets, via the Internet, on mobile devices, in-home or out-of-home, live or time-shifted, etc. Understanding consumer-based engagement with media within and across a variety of platforms (e.g., television, online, mobile, and emerging) allows media providers and website developers to increase user engagement with their media.

### BRIEF DESCRIPTION OF THE DRAWINGS

FIG. 1 illustrates an example environment in which duration values, impression count values, and audience size values are used to estimate census-level data for different demographics.

FIG. 2 is a block diagram of an example implementation of the audience metrics estimation circuitry 140 of FIG. 1.

FIGS. 3-6 are flowcharts representative of example machine readable instructions that may be executed by example processor circuitry to implement the example audience metrics estimation circuitry 140.

FIG. 7 is an example audience metrics table (e.g., data table, output table) illustrating different data types available to the audience metrics estimation circuitry 140.

FIG. 8A is a logic table illustrating different scenarios based on which data types are known (e.g., given to, received) by the audience metrics estimation circuitry 140.

FIG. 8B is the logic table of FIG. 8A with explicitly enumerated discrete cross-demographic total census parameter values.

FIG. 8C is the logic table of FIG. 8A with explicitly enumerated continuous cross-demographic total census parameter values.

FIG. 9 is an example triangular matrix of impression counts and duration values and an altered rectangular matrix of impression counts and duration values.

FIG. 10A is an example audience metrics tables (e.g., output table, data table) of FIG. 7 for the fourth discrete scenario 824 of FIG. 8B wherein the total census audience size is unknown, and the total census impressions (e.g., page-views) and total census discrete durations are known.

FIG. 10B is the example audience metrics table of FIG. 10A, wherein the census parameters are estimated (e.g., wherein the census audience sizes for the different demographics, the census impressions (e.g., page views) for the different demographics, the census discrete durations for the different demographics, the total census audience size, the total census impressions (e.g., page views), and the total census discrete duration are known).

FIG. 11A is an example audience metrics tables (e.g., output table, data table) of FIG. 7 for the eighth discrete scenario 832 of FIG. 8B wherein the total census audience size, the total census impressions (e.g., page-views), and the total census discrete durations are known.

FIG. 11B is the example audience metrics table of FIG. 11A, wherein the census parameters are estimated (e.g., wherein the census audience sizes for the different demographics, the census impressions (e.g., page views) for the different demographics, the census discrete durations for the different demographics, the total census audience size, the total census impressions (e.g., page views), and the total census discrete duration are known).

FIG. 12A is an example audience metrics tables (e.g., output table, data table) of FIG. 7 for the fourth continuous scenario 840 of FIG. 8C wherein the total census audience size is unknown, and the total census impressions (e.g., page-views) and total census continuous durations are known.

FIG. 12B is the example data table of FIG. 12A, wherein the census parameters are estimated (e.g., wherein the census audience sizes for the different demographics, the census impressions (e.g., page views) for the different demographics, the census continuous durations for the different demographics, the total census audience size, the total census impressions (e.g., page views), and the total census continuous duration are known).

FIG. 13A is an example audience metrics tables (e.g., output table, data table) of FIG. 7 for the eighth continuous scenario 848 of FIG. 8C wherein the total census audience size, the total census impressions (e.g., page-views), and the total census continuous durations are known.

FIG. 13B is the example audience metrics table of FIG. 13A, wherein the census parameters are estimated (e.g., wherein the census audience sizes for the different demographics, the census impressions (e.g., page views) for the different demographics, the census continuous durations for the different demographics, the total census audience size, the total census impressions (e.g., page views), and the total census discrete duration are known).

FIG. 13C is the example audience metrics table of FIG. 13A, wherein the duration data are in terms of hours instead of minutes.

FIG. 14 is an example joint probability density function including a first continuous dimension and a second discrete dimension.

FIG. 15 is a block diagram of an example processing platform including processor circuitry structured to execute the example machine readable instructions of FIGS. 3-6 to implement the audience metrics estimation circuitry of FIGS. 1-2.

FIG. 16 is a block diagram of an example implementation of the processor circuitry of FIG. 15.

FIG. 17 is a block diagram of another example implementation of the processor circuitry of FIG. 15.

FIG. 18 is a block diagram of an example software distribution platform (e.g., one or more servers) to distribute software (e.g., software corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to Internet-accessible media, such as digital television (DTV) media and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The techniques disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietor s to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

Techniques disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. Techniques disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporality available online after broadcast, TV media, etc.). For example, a user may start watching a first television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process to adjust cross-platform media exposure totals by reducing (e.g., eliminating) the double counting of individual audience members that were exposed to media via more than one platform and/or are represented in more than one database of media impressions used to determine the reach of the media.

As used herein, unique audience members are audience members who are distinguishable from one another. Furthermore, a unique audience is made up of unique audience members. Moreover, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing the size of a unique audience and, thus, reach, is useful for advertisers wishing to reach a larger audience base.

Notably, although third-party cookies are useful for third-party measurement entities in many of the above-described techniques to track media accesses and to leverage demographic information from database proprietors, use of third-party cookies may be limited or may cease in some or all online markets. That is, use of third-party cookies enables sharing anonymous personally identifiable information (PII) across entities which can be used to identify and deduplicate audience members across database proprietor impression data. However, to reduce or eliminate the possibility of revealing user identities outside database proprietors by such anonymous data sharing across entities, some websites, internet domains, and/or web browsers may stop (or have already stopped) supporting third-party cookies. This hampering of third-party cookies will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data may not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

As used herein, census data corresponds to impressions (e.g., exposures to a media item by an audience member) logged for a general audience in a population regardless of whether the impressions correspond to audience members that are identifiable by the AME. In such examples, census-level impressions are collected as anonymous impression data. In many cases, AMEs may only have access to partial census-level data (e.g., a total census-level impression count across all demographics) but not access to complete census-level data (e.g., a census-level impression count for each individual demographic). In examples disclosed herein, to enrich the anonymous impression collected census data, a database proprietor collects demographic impression data by monitoring media accesses by its subscribers and logging corresponding impressions in association with demographic data collected from its subscribers. In examples disclosed herein, such demographic impression data is also referred to as panel data or panel impression data because it corresponds to known subscribers of the database proprietor which form a database proprietor (e.g., DP) panel of audience members.

As used herein, a universe audience (e.g., a total audience, a unique audience, a deduplicated audience, a unique total audience, etc.) for media is a total number of persons that accessed the media in a particular geographic scope of interest and/or during a time of interest relating to media audience metrics. Determining if a larger unique audience is reached by certain media (e.g., an advertisement) can be used to identify if an AME client (e.g., an advertiser) is reaching a larger audience base. When an AME logs an impression for access to media by a user not associated with any demographic information, the logged impression counts as a census-level impression. As such, multiple census-level impressions can be logged for the same user since the user is not identified as a unique audience member. Estimation of census-level unique audience, impression counts (e.g., number of times a webpage has been viewed), and impression durations for individual demographics can increase the accuracy of usage statistics provided by monitoring entities such as AMEs.

In the context of audience measurements for Internet-based media providers such as YouTube®, an audience measurement entity may have census-level information reflecting the total impressions (e.g., page views, impression count values, impression requests, impression data etc.) and duration (e.g., duration values, duration data, impression duration values) of such impressions, but lack unique total audience (e.g., unique total audience size, unique total audience size values) and how the unique total audience, total impressions (e.g., pageviews) and durations are distributed across demographics. However, database proprietor data provides partial information on unique total audiences, total impressions, and duration based on the database of the database proprietor. Examples disclosed herein use such database proprietor information to estimate individual demographic level audience (e.g., unique audience size for a specific demographic), individual demographic level impressions (e.g., pageviews), and individual demographic level duration of such impressions on the census data.

In examples disclosed herein, any combination of aggregated total census constraints can be given to the AME. The aggregated total census constraints include a first constraint (e.g., the unique total audience size is to match the sum of the unique audience size for each demographic), a second constraint (e.g., the total impressions are to match the sum of the impressions for each demographic), and a third constraint (e.g., the total duration of such impressions is to match the sum of the impression duration for each demographic). This amounts to eight distinct combinations which may be helpful to the analyst. In some examples, the example AME solves, at most, only three unknown variables, independent of the number of demographics. In addition, the estimates are logically consistent with all constraints and the procedure is a good (e.g., optimal) solution with regards to Information Theory.

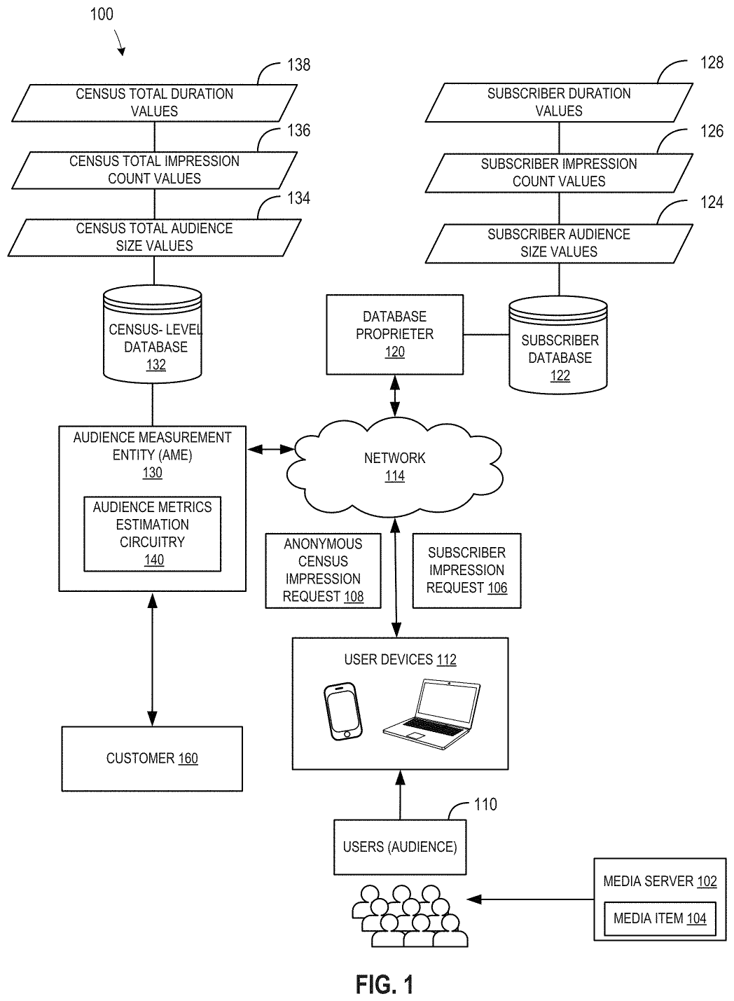

FIG. 1 is a block diagram illustrating an example environment 100 in which example audience metrics estimation circuitry 140 is implemented to determine census-level audience, impressions, and impression durations across demographics, wherein the census-level estimates are accurate for ones of the different demographics and are accurate across the different demographics. The example operating environment 100 of FIG. 1 includes an example media server 102, example users 110 (e.g., an audience), example user devices 112, an example network 114, an example database proprietor 120, an example audience measurement entity (AME) 130 and an example customer 160. The database proprietor 120 includes an example subscriber database 122. The subscriber database 122 includes example audience size data 124 (e.g., subscriber audience size data, subscriber unique total audience size values, subscriber unique audience size values for each demographic), example impression data 126 (e.g., subscriber impression count values, subscriber impression count data 126, subscriber total impression count values, subscriber impression count values for each demographic), and example subscriber duration data 128 (e.g., subscriber impression duration values, subscriber total impression duration, subscriber impression duration for each demographic). The AME 130 includes an example census-level database 132 and an example audience metrics estimation circuitry 140. The census-level databases 132 includes example census unique total audience size data 134 (e.g., census total audience size values), census total impression counts 136 (e.g., census total impressions, census total impression count values) and example census total impression duration 138 (e.g., census total duration, census total impression duration values). In the example of FIG. 1, the users 110 access the same media item 104 from the media server 102 on respective user devices 112. The impression requests are logged as either a subscriber impression request 106 (e.g., a request from a known user) or a census-level impression request 108 (e.g., anonymous census-level impression request 108).

In the illustrated example, the example media server 102 serves the media 104 (e.g., media item 104) to the user devices 112 (e.g., client devices). As used herein, “media” refers collectively and/or individually to content and/or advertisement(s). For example, the media server 102 may serve one or more of different types of media (e.g., movies, songs, advertisements, webpages, e-books, etc. in the form of any one or more of video, audio, images, text, etc.).

Users 110 include any individuals who access media on one or more user device(s) 112, such that the occurrence of access and/or exposure to media creates a media impression (e.g., viewing of an advertisement, a movie, a web page banner, a webpage, etc.). A subset of example users 110 are panelists that have provided their demographic information when registering with the example AME 130. When the example users 110 who are panelists utilize example user devices 112 to access media through the example network 114, the AME 130 (e.g., AME servers) stores panelist activity data associated with their demographic information. The users 110 also include individuals who are not panelists (e.g., not registered with the AME 130). The users 110 include individuals who are subscribers to services provided by the database proprietor 120 and utilize these services via their user device(s) 112.

User devices 112 (e.g., client devices 112) can be stationary or portable computers, handheld computing devices, smart phones, Internet appliances, and/or any other type of device that may be capable of accessing media over a network (e.g., the Internet, network 114). In the illustrated example of FIG. 1, the client device(s) 112 include a smartphone (e.g., an Apple® iPhone®, a Motorola® Moto X™, a Nexus 5, an Android™ platform device, etc.) and a laptop computer. However, any other type(s) of device(s) may additionally or alternatively be used such as, for example, a tablet (e.g., an Apple® iPad™, a Motorola® Xoom™, etc.), a desktop computer, a camera, an Internet compatible television, a smart TV, etc. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as a YouTube® website, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content. The user device(s) 112 of FIG. 1 are used to access (e.g., request, receive, render and/or present) online media provided, for example, by a web server. For example, users 110 can execute a web browser on the user device(s) 112 to request streaming media (e.g., via an HTTP request) from a media hosting server. The web server can be any web browser used to provide media content (e.g., a YouTube® website) that is accessed, through the example network 114, by the example users 110 on example user device(s) 112.

The example network 114 is a communications network that may be implemented using any suitable wired and/or wireless network(s) including, for example, one or more data buses, one or more Local Area Networks (LANs), one or more wireless LANs, wide area network, a cloud, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events. The example network 114 allows example impression requests from the example user devices 112 to be stored by the example database proprietor 120 and audience measurement entity 130. In some examples, the user devices 112 communicate with the example network 114 via the Internet.

In some examples, media (also referred to as a media item 104) is tagged or encoded to include monitoring or tag instructions. The monitoring instructions are computer executable instructions (e.g., Java or any other computer language or script) executed by web browsers accessing media content (e.g., via network 114). Execution of monitoring instructions causes the web browser to send an impression request (e.g., census impression request 108, a subscriber impression request 106, etc.) to the servers of the AME 130 and/or the database proprietor 120. Demographic impressions are logged by the database proprietor 120 when user devices 112 accessing media are identified as belonging to registered subscribers to database proprietor 120 services. The database proprietor 120 stores data generated for registered subscribers in the subscriber database 122. Likewise, the AME 130 logs census-level media impressions 108 (e.g., census-level impressions, anonymous impression requests) for user devices 112, regardless of whether demographic information is available for such logged impressions. The AME 130 stores census-level data information in the census-level data storage 132 (e.g., census-level database 132). Further examples of monitoring instructions and methods of collecting impression data are disclosed in U.S. Pat. No. 8,370,489 entitled “Methods and Apparatus to Determine Impressions using Distributed Demographic Information,” U.S. Pat. No. 8,930,701 entitled “Methods and Apparatus to Collect Distributed User Information for Media Impressions and Search Terms,” and U.S. Pat. No. 9,237,138 entitled “Methods and Apparatus to Collect Distributed User Information for Media Impressions and Search Terms,” all of which are hereby incorporated herein by reference in their entireties. In the example of FIG. 1, the users 110 access the same media item 104 from the media server 102 on respective user devices 112. The impression requests are logged as either a subscriber impression request 106 or a census-level impression request 108.

The AME 130 operates as an independent party to measure and/or verify audience measurement information relating to media accessed by users, for example, subscribers of the database proprietor 120. When media is accessed by user devices 112, the AME 130 stores census-level information in the census-level database 132, including census total impression counts 136 (e.g., number of webpage views), and census total impression durations 138 (e.g., length of time that a webpage was viewed). In some examples, the AME 130 stores census total audience size data 134 in addition to census total impression counts 136 and census total impression durations 138. The database proprietor 120 provides the AME 130 with aggregate subscriber data that obfuscates the person-specific data, such that reference aggregates among the individuals within a demographic are available (e.g., aggregate subscriber-based audience metrics). For example, the subscriber audience data 124, the subscriber impression counts data 126, and subscriber impression durations data 128 are provided at a demographic level (e.g., females 18-25, males 18-25, females 26-35, males 26-35, etc.). For example, the subscriber audience data 124 corresponds to unique audience size data in the aggregate per demographic category.

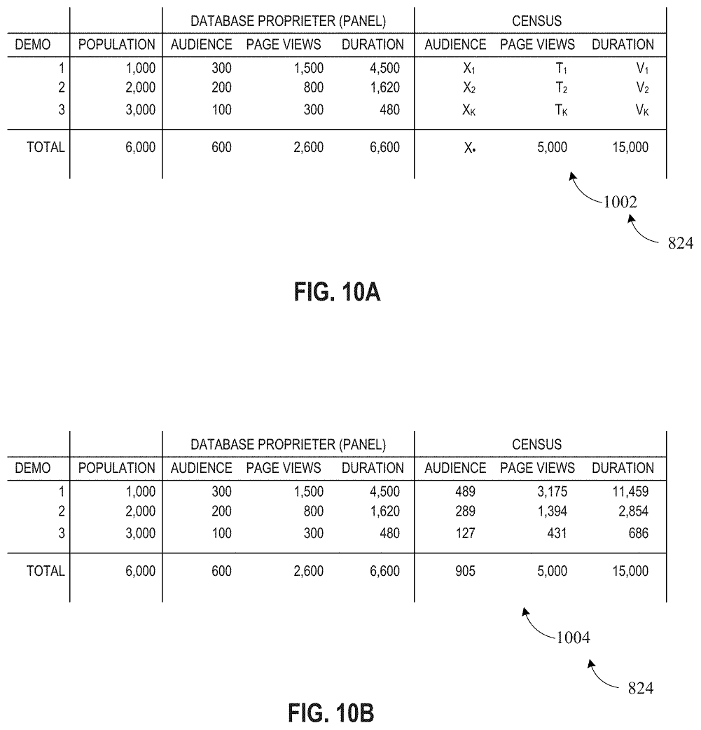

The audience metrics estimation circuitry 140 of the AME 130 receives aggregate subscriber-based audience metrics data (e.g., subscriber audience size data 124, subscriber impression counts data 126, and subscriber impression duration data 128). The audience metrics estimation circuitry 140 uses the aggregate data to estimate census-level audience size data, census-level impression counts data, and census-level impression duration data for individual demographics. In addition, the audience metrics estimation circuitry 140 uses the census-level data available to the AME 130 (e.g., census total audience size 134, census total impression counts 136 and census total impression durations 138) to generate the census-level audience, impressions, and duration estimates for the subscriber-based data for individual demographics. The AME 130 may output the census-level audience size data, census-level impression count data, and census-level impression duration data for individual demographics to an example customer 160. For example, the AME 130 may send the audience metrics to the example customer 160 as a table or a report. Examples of audience metrics tables that may be sent to the example customer 160 are further described in conjunction with FIGS. 10B, 11B, 12B, 13B, and 13C.

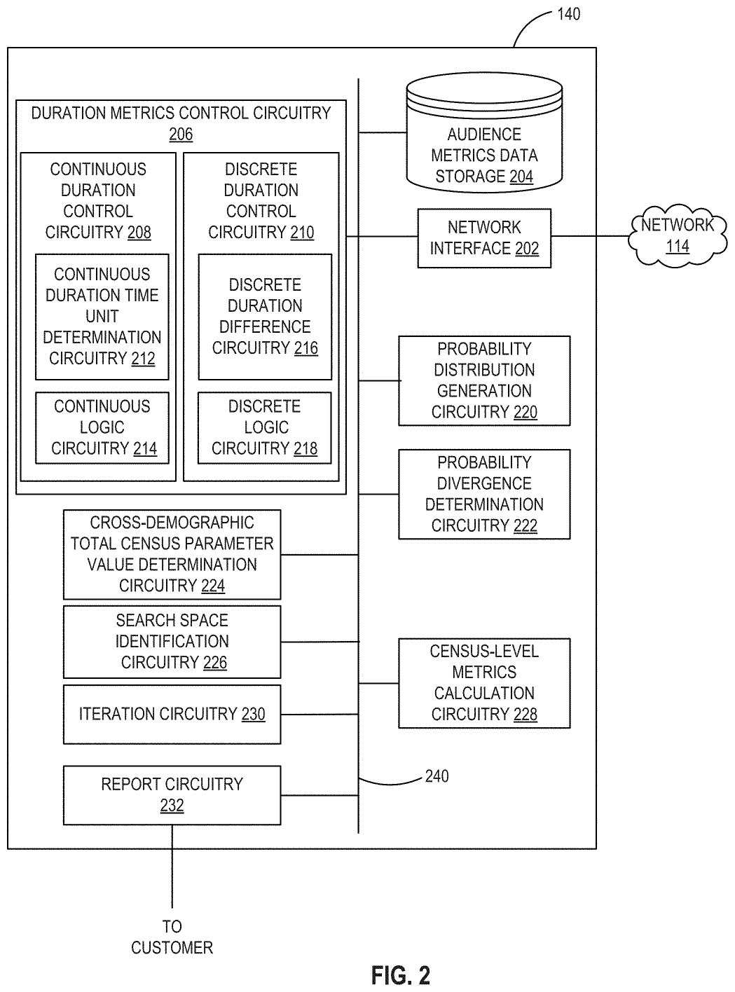

FIG. 2 is a block diagram of an example implementation of the audience metrics estimation circuitry 140 of FIG. 1. The example audience metrics estimation circuitry 140 includes an example network interface 202, an example data storage device 204, an example duration metrics control circuitry 206, example probability distribution generation circuitry 220, example probability divergence determination circuitry 222, example cross-demographic total census parameter value determination circuitry 224, example search space identification circuitry 226, example census-level metrics calculation circuitry 228, example iteration circuitry 230, and example report circuitry 232, all of which are in communication (e.g., by exchanging data via accessing, requesting, and/or loading) via an example bus 240. The example duration metrics control circuitry 206 includes a continuous duration control circuitry 208 and discrete duration control circuitry 210. The example continuous duration control circuitry 208 includes continuous duration time unit determination circuitry 212 and continuous logic circuitry 214. The example discrete duration control circuitry 210 includes discrete duration difference circuitry 216 and discrete logic circuitry 218.

The example audience metrics estimation circuitry 140 is provided with the example network interface 202 to communicate with the example network 114. In this manner, the example audience metrics estimation circuitry 140 can access audience metrics data from the database proprietor 120. In some examples, the example network interface 202 additionally or alternatively enables the audience metrics estimation circuitry 140 to communicate with the customer 160.

The example data storage 204 (e.g., audience metrics data store, audience metrics data storage) stores aggregate subscriber-based audience metrics data from the database proprietor 120. For example, data from the database proprietor 120 can include subscriber data (e.g., subscriber audience size data 124, subscriber impression count data 126, and subscriber impression duration data 128) of FIG. 1. The example data storage 204 can also store census-level data (e.g., census total audience size data 134, census total impression count data 136 and census total impression duration data 138). The audience metrics estimation circuitry 140 accesses the subscriber-based data and census-level data from the data storage 204 to perform census-level estimation calculations (e.g., determine census-level unique audience sizes, census-level unique impression counts, and census-level unique impression durations for given demographics). The data storage 204 may be implemented by any storage device and/or storage disc for storing data such as, for example, flash memory, magnetic media, optical media, etc. Furthermore, the data stored in the data storage 204 may be in any data format such as, for example, binary data, comma delimited data, tab delimited data, structured query language (SQL) structures, etc. While in the illustrated example the data storage 204 is illustrated as a single database, the data storage 204 can be implemented by any number and/or type(s) of databases.

The example duration metrics control circuitry 206 is to estimate the demographic-specific census-level audience metrics either the impression durations as continuous durations or discrete durations. As used herein, a “continuous duration” is a duration that is scale invariant, wherein if the continuous duration is represented as minutes, hours, or days, the associated impression count does not change. For example, if the continuous census-level duration values were three (3) hours and there were eighteen (18) total impressions, scaling (e.g., selecting a different time unit, applying a conversion ratio, changing the dimensions, applying a proportion, etc.) the continuous census-level duration values to one hundred and eighty (180) minutes before performing audience metrics calculations does not change the total number of impressions from eighteen (18) total impressions.

As used herein, in the context of continuous durations, “scaling” refers to changing the time units, while in the context of discrete durations, “scaling” refers to removing all impression counts with durations that are less than the fixed time unit, such that only impressions that include an impression duration above the fixed time unit remain.

As used herein, a “discrete duration” is a duration of at least a fixed (e.g., minimum) time unit. For example, the fixed time unit may be one (1) second. For example, a user 110 may access a media item 104 for only half-a-second (0.5 seconds) before closing the page. Under the continuous model, the half a second of duration time is applied (e.g., recorded, stored, saved) towards the census total impression duration data 138 or the subscriber duration data 128 and the impression count is saved in the census total impression count values 136 or the subscriber impression count data 126. Under the discrete model, the half a second of duration time is not applied to the census total impression duration values 138 or the subscriber duration values 128 and the impression count is not saved to either the census total impression count values 136 or the subscriber impression count data 126. The property that an impression count must be at least one second (or some other fixed time) also determines that discrete durations are no longer scale invariant. Receiving discrete durations in one time unit (e.g., seconds), and converting to minutes before performing the audience estimation calculations may lead to inaccurate estimates.

The example duration metrics control circuitry 206 estimates the demographic-specific census-level audience metrics using the impression durations as continuous durations or discrete durations. For example, the network interface may receive subscriber data that includes discrete durations and an indicator (e.g., a flag, a variable) that alerts the duration metrics control circuitry 206 to utilize the discrete duration control circuitry 210 with the received subscriber data. In some examples, the network interface may receive subscriber data that includes continuous durations and an indicator that alerts the duration metrics control circuitry 206 to utilize the continuous duration control circuitry 208 with the received subscriber data. In some examples, the duration metrics control circuitry 206 may be programmed to treat the audience metrics data from a specific database proprietor 120 is specifically discrete or continuous.

The example continuous duration control circuitry 208, the continuous duration time unit determination circuitry 212, the continuous logic circuitry 214, the example probability distribution generation circuitry 220, the example probability divergence determination circuitry 222, the example cross-demographic total census parameter value determination circuitry 224, the example search space identification circuitry 226, the example census-level metrics calculation circuitry 228, the example iteration circuitry 230, and the example report circuitry 232 operate in order to output the census-level metrics. The continuous duration time unit determination circuitry 212 selects the units for durations. The scaling (e.g., unit selection) may occur when the audience metrics estimation circuitry 140 accesses the duration data (128 and 138). In some examples, the scaling (e.g., unit selection) may occur before determining the example cross-demographic total census parameter values (e.g., intermediate values, c-values, etc.). In some examples, the scaling (e.g., unit selection) may occur before the report circuitry 232 reports the results to the example customer 160.

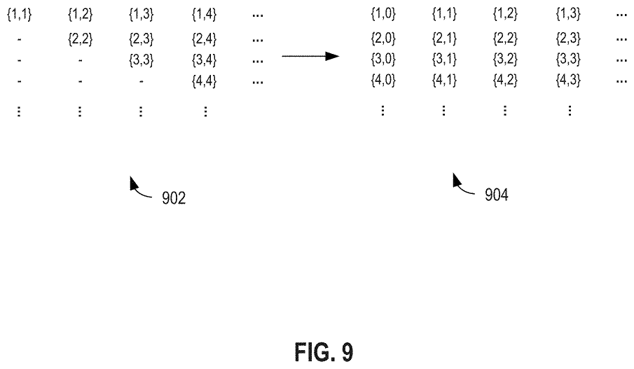

The example discrete duration control circuitry 210, the discrete duration difference circuitry 216, the example discrete logic circuitry 218, the example probability distribution generation circuitry 220, the example probability divergence determination circuitry 222, the cross-demographic total census parameter value determination circuitry 224, the search space identification circuitry 226, the example census-level metrics calculation circuitry 228, the example iteration circuitry 230, and the example report circuitry 232 operate in order to output the census-level metrics. The example discrete duration difference circuitry 216 re-formats (e.g., scales, subtracts, alters) the duration data, such that each impression count is at least the fixed time unit (e.g., one second). The example discrete duration difference circuitry 216 determines the difference between the duration values and the impression counts. Further details describing the example discrete duration difference circuitry 216 are explained in conjunction with FIG. 9. The example discrete logic circuitry 218 includes discrete formulas which may be executed to estimate census-level audience sizes.

The example probability distribution generation circuitry 220 generates a single estimate of the probability distribution for an individual within a given population, such that the distribution is subject to a probability of the individual being in the audience, having an average number of impressions (e.g., page views). For example, the probability distribution generation circuitry 220 may assign probability density functions, marginal probabilities, and/or person-specific probability distributions to subscriber-based audience individuals. In some examples, probability density functions are assigned to subscriber audience individuals using data for subscriber impression count data 126 and subscriber impression duration data 128, using a marginal probability of having a number of impressions (n) independent of the impression duration (d). In some examples, the probability distribution generation circuitry 220 assigns person-specific probability distributions for individuals within a demographic (k) based on the probability of the individual being in an audience, having an average impression count, and having an average impression duration.

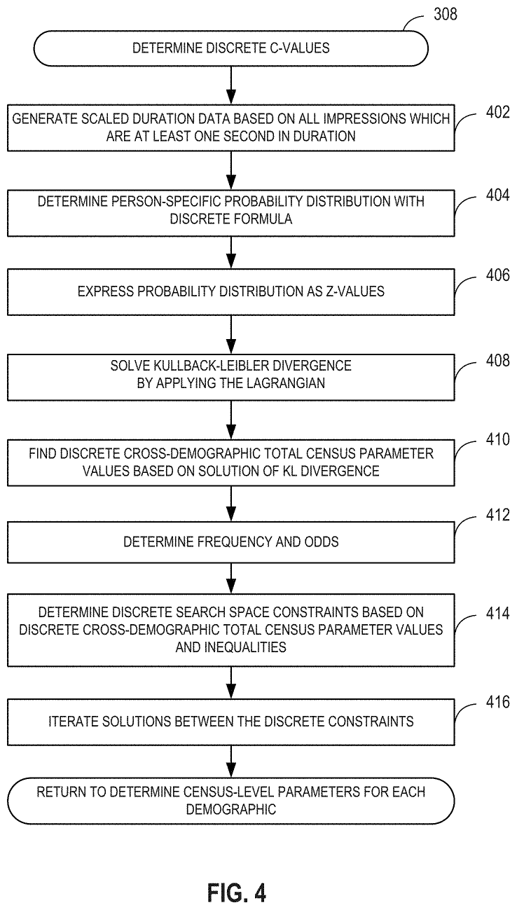

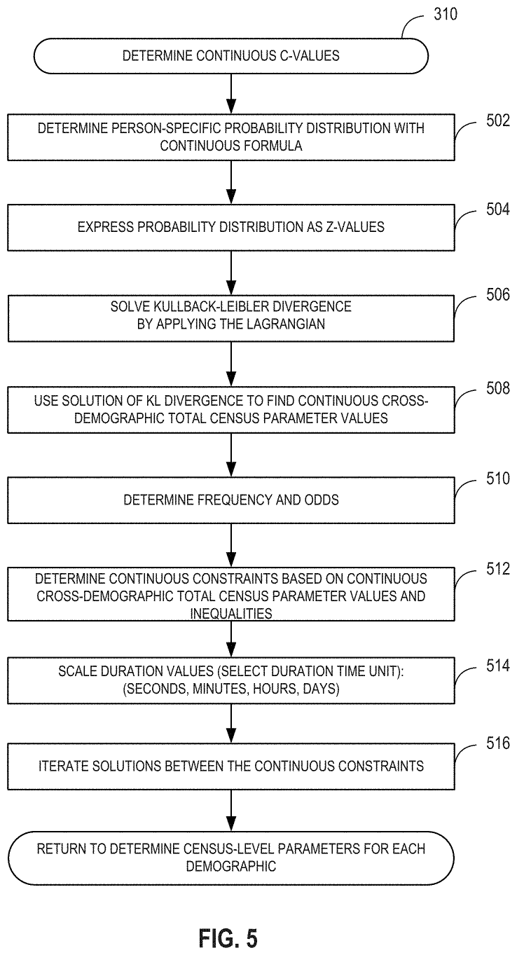

The example probability divergence determination circuitry 222 determines probability divergences between prior and posterior distributions in a given demographic using available subscriber data and census-level data of FIG. 1. For example, the probability divergence determination circuitry 222 can define subscriber data as a prior probability distribution in the k^{th} demographic and define the census-level data as a posterior probability distribution in the k^{th} demographic, as described in more detail below in association with FIGS. 4-5. In some examples, the probability divergence can be determined using a Kullback-Leibler (KL) divergence between the two distributions.

The example cross-demographic total census parameter value determination circuitry 224 uses solution of the probability divergence to generate cross-demographic total census parameter values (e.g., c-values, intermediate solution values) as described in more detail below in association with FIG. 4 and FIG. 5. The cross-demographic total census parameter values are used to find the census-level audience metrics across demographics. The example cross-demographic total census parameter value determination circuitry 224 may generate discrete cross-demographic total census parameter values (FIG. 4) and/or generate continuous cross-demographic total census parameter values (FIG. 5). The cross-demographic total census parameter values are bounded by a first threshold solution value (e.g., a minimum inequality bound) and a second threshold (e.g., maximum) solution value (e.g., a maximum inequality bound). The range between the first threshold solution value and second threshold solution value is called the search space.

The example search space identification circuitry 226 identifies the search space for the cross-demographic total census parameter values based on the first threshold solution value and the second threshold solution value. The example search space identification circuitry 226 uses discrete Equations 59-61 as further described in connection with FIG. 4 to identify the search space associated with the discrete duration values:

$$\begin{matrix}0 \leq {c}_{1} < ∞ & Equation 59 \\ 0 \leq {c}_{2} \leq min ( \frac{{R}_{k}}{{R}_{k} - {A}_{k}} ) & Equation 60 \\ 0 \leq {c}_{3} \leq 1 + min ( \frac{{A}_{k}}{Δ {R}_{k}} ) & Equation 61\end{matrix}$$

The example search space identification circuitry 226 uses discrete Equations 132-134 as further described in connection with FIG. 5 to identify the search space associated with the continuous duration values:

$$\begin{matrix}0 \leq {c}_{1} < ∞ & Equation 132 \\ 0 \leq {c}_{2} \leq min ( \frac{{R}_{k}}{{R}_{k} - {A}_{k}} ) & Equation 133 \\ - ∞ \leq {c}_{3} \leq min ( \frac{{A}_{k}}{{D}_{k}} ) & Equation 134\end{matrix}$$

The example iteration circuitry 230 iterates between cross-demographic total census parameter values that are within the example search space. For example, a first iteration may select a first cross-demographic total census parameter value (e.g., first intermediate solution value, c₁), a second cross-demographic total census parameter value (e.g., second intermediate solution value, c₂) and a third cross-demographic total census parameter value (e.g., third intermediate solution value, c₃). For example, the iteration circuitry 230 may iterate over the search space of possible cross-demographic total census parameter values to iteratively determine a census-level metrics.

The example census-level metrics calculation circuitry 228 determines census-level demographic results (e.g., census-level unique audience size {Xₖ}, census-level impression counts {Tₖ}, and census-level impression durations {Vₖ}) for the three cross-demographic total census parameter values of the first iteration. If the example census-level demographic results meet the constraints, the iteration achieved the unique solution and the example census-level metrics calculation circuitry 228 saves the census-level demographic results. If the example census-level demographic results do not meet the constraints, the example iteration circuitry 230 iterates another set of cross-demographic total census parameter values, and the census-level metrics calculation circuitry 228 determines if the cross-demographic total census parameter values of the second iteration (e.g., c₁, c₂, and c₃) satisfy the census-level demographic constraints. The example census-level metrics calculation circuitry 228 may determine the example census-level results meet the constraints in accordance with Equation 28:

$$\begin{matrix}{minimize}_{\{ {X}_{k} \} , \{ {T}_{k} \} , \{ {V}_{k} \}} & KL ( P : Q ) = {\sum }_{k = 1}^{K} {U}_{k} ( K L ( {P}_{k} : {Q}_{k} ) ) \\ subject to & {\sum }_{k = 1}^{K} {X}_{k} = X . \\ & {\sum }_{k = 1}^{K} {T}_{k} = T . \\ & {\sum }_{k = 1}^{K} {ΔT}_{k} = ΔT .\end{matrix} \qquad Equation 28$$

The example report circuitry 232 outputs the census-level demographic results. For example, the report circuitry 232 may send the census-level demographic results to a customer. Examples of audience metrics tables that may be sent to the example customer 160 are further described in conjunction with FIGS. 10B, 11B, 12B, 13B, and 13C.

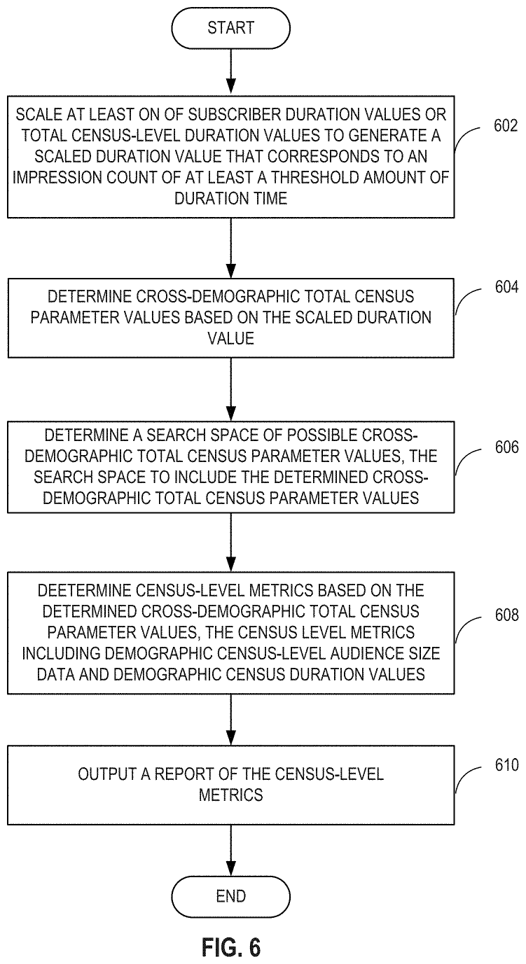

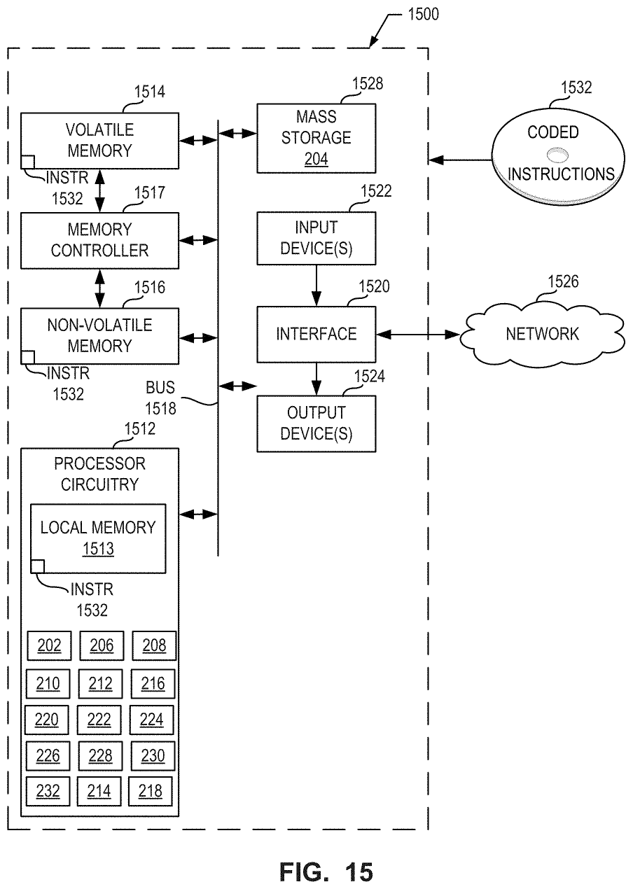

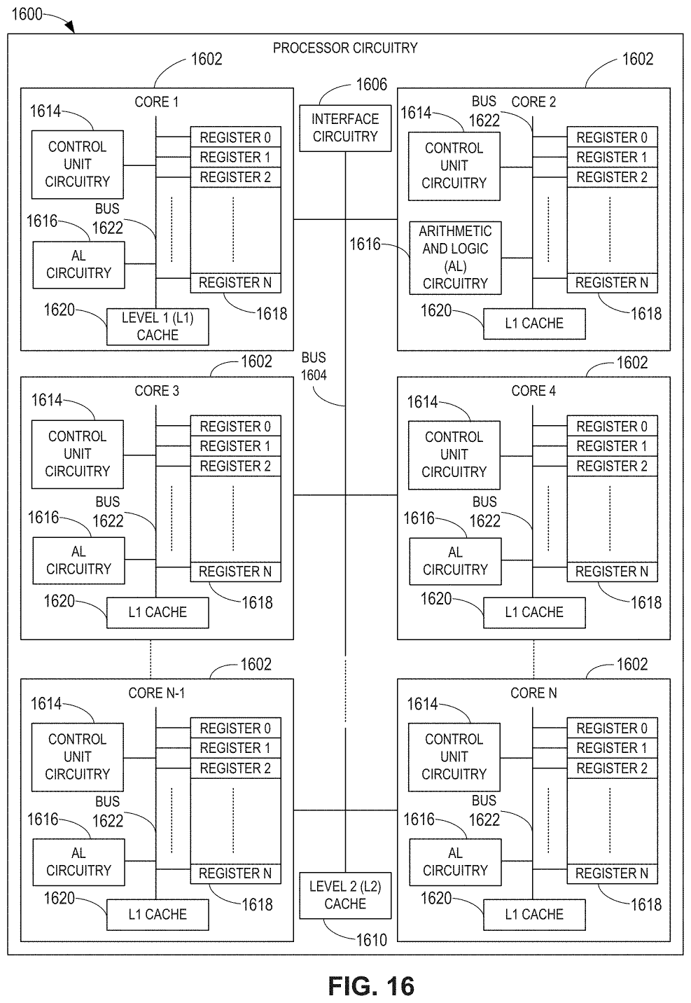

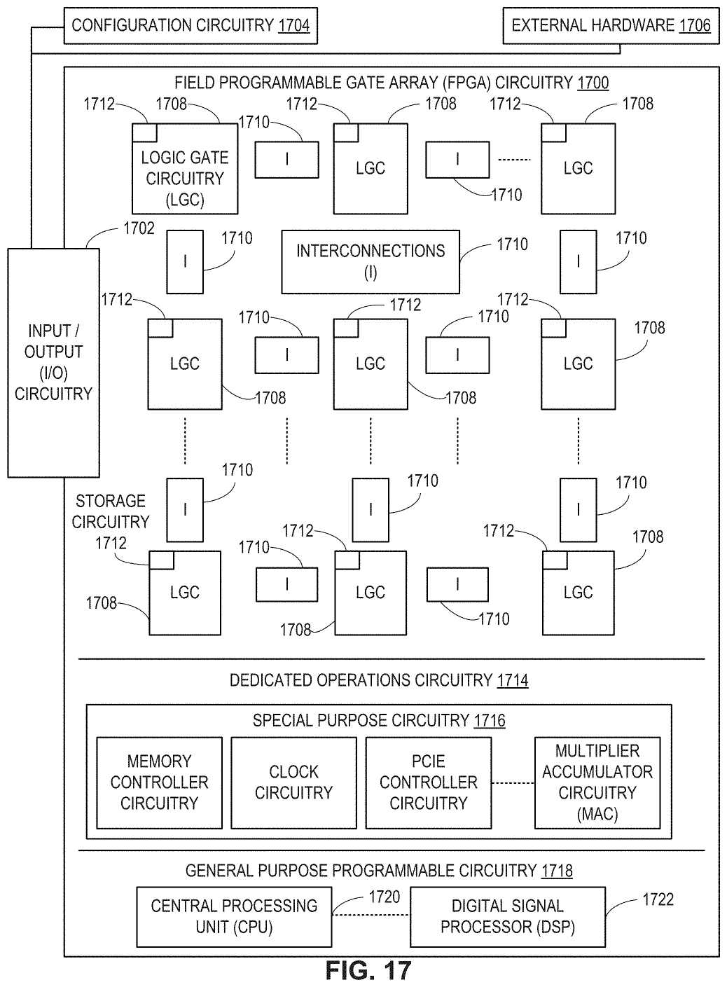

In some examples, the apparatus includes means for scaling at least one of subscriber duration values or total census duration values to generate a scaled duration value that corresponds to an impression count of at least a threshold amount of duration time. For example, the means for scaling at least one of subscriber duration values or total census duration values to generate a scaled duration value that corresponds to an impression count of at least a threshold amount of duration time may be implemented by discrete duration difference circuitry 216. In some examples, the discrete duration difference circuitry 216 may be implemented by machine executable instructions such as that implemented by at least blocks 402 of FIG. 4, and 602 of FIG. 6 executed by processor circuitry, which may be implemented by the example processor circuitry 1512 of FIG. 15, the example processor circuitry 1600 of FIG. 16, and/or the example Field Programmable Gate Array (FPGA) circuitry 1700 of FIG. 17. In other examples, the discrete duration difference circuitry 216 is implemented by other hardware logic circuitry, hardware implemented state machines, and/or any other combination of hardware, software, and/or firmware. For example, the discrete duration difference circuitry 216 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for determining cross-demographic total census parameter values based on the scaled duration value. For example, the means for determining cross-demographic total census parameter values based on the scaled duration value may be implemented by cross-demographic total census parameter value determination circuitry 224. In some examples, the cross-demographic total census parameter value determination circuitry 224 may be implemented by machine executable instructions such as that implemented by at least blocks 604 of FIG. 6 executed by processor circuitry, which may be implemented by the example processor circuitry 1512 of FIG. 15, the example processor circuitry 1600 of FIG. 16, and/or the example Field Programmable Gate Array (FPGA) circuitry 1700 of FIG. 17. In other examples, the cross-demographic total census parameter value determination circuitry 224 is implemented by other hardware logic circuitry, hardware implemented state machines, and/or any other combination of hardware, software, and/or firmware. For example, the cross-demographic total census parameter value determination circuitry 224 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for determining a search space of possible cross-demographic total census parameter values, the search space to include the determined cross-demographic total census parameter values. For example, the means for determining a search space of possible cross-demographic total census parameter values, the search space to include the determined cross-demographic total census parameter values may be implemented by search space identification circuitry 226. In some examples, the search space identification circuitry 226 may be implemented by machine executable instructions such as that implemented by at least blocks 606 of FIG. 6 executed by processor circuitry, which may be implemented by the example processor circuitry 1512 of FIG. 15, the example processor circuitry 1600 of FIG. 16, and/or the example Field Programmable Gate Array (FPGA) circuitry 1700 of FIG. 17. In other examples, the search space identification circuitry 226 is implemented by other hardware logic circuitry, hardware implemented state machines, and/or any other combination of hardware, software, and/or firmware. For example, the search space identification circuitry 226 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

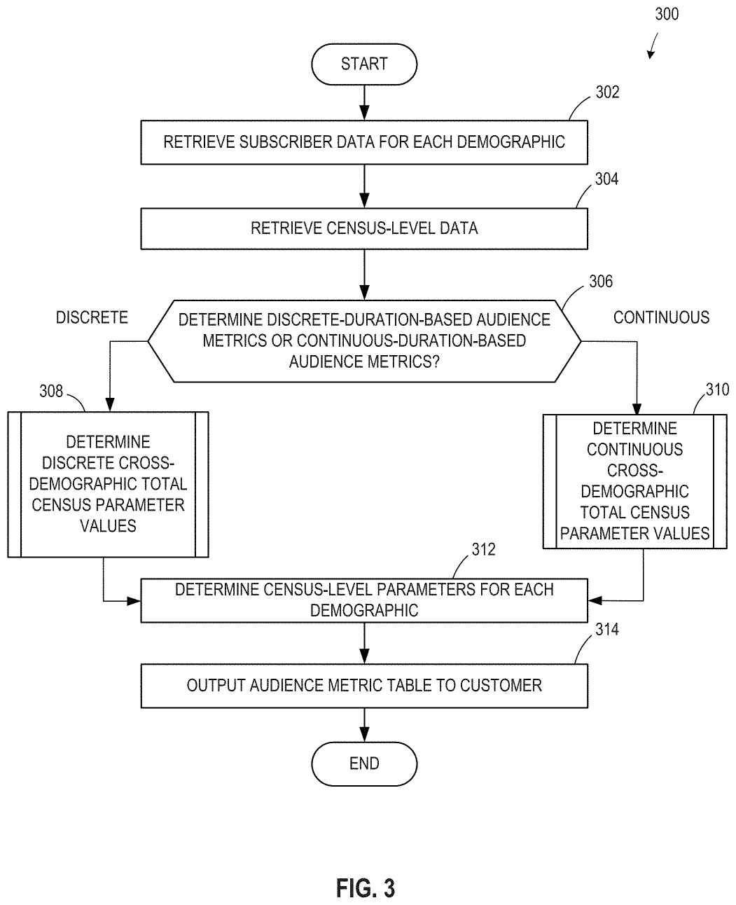

In some examples, the apparatus includes means for determining census-level metrics based on the determined cross-demographic total census parameter values, the census-level metrics including demographic census audience size data and demographic census duration values. For example, the means for determining census-level metrics based on the determined cross-demographic total census parameter values, the census-level metrics including demographic census audience size data and demographic census duration values may be implemented by census-level metrics calculation circuitry 228. In some examples, the census-level metrics calculation circuitry 228 may be implemented by machine executable instructions such as that implemented by at least blocks 312 of FIG. 3 and 608 of FIG. 6 executed by processor circuitry, which may be implemented by the example processor circuitry 1512 of FIG. 15, the example processor circuitry 1600 of FIG. 16, and/or the example Field Programmable Gate Array (FPGA) circuitry 1700 of FIG. 17. In other examples, the census-level metrics calculation circuitry 228 is implemented by other hardware logic circuitry, hardware implemented state machines, and/or any other combination of hardware, software, and/or firmware. For example, the census-level metrics calculation circuitry 228 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

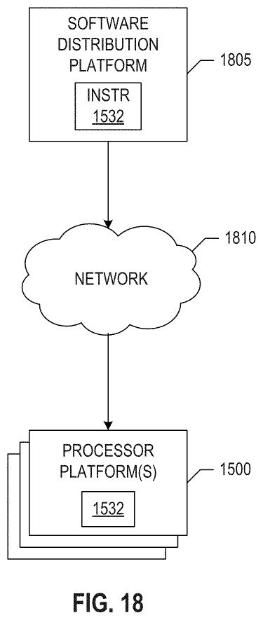

In some examples, the apparatus includes means for outputting a report of the census-level metrics. For example, the means for outputting a report of the census-level metrics may be implemented by report circuitry 232. In some examples, the report circuitry 232 may be implemented by machine executable instructions such as that implemented by at least blocks 314 of FIG. 3 and block 610 of FIG. 6 executed by processor circuitry, which may be implemented by the example processor circuitry 1612 of FIG. 16, the example processor circuitry 1700 of FIG. 17, and/or the example Field Programmable Gate Array (FPGA) circuitry 1800 of FIG. 18. In other examples, the report circuitry 232 is implemented by other hardware logic circuitry, hardware implemented state machines, and/or any other combination of hardware, software, and/or firmware. For example, the report circuitry 232 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the audience metrics estimation circuitry 140 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 202, the example data storage 204, the example duration metrics control circuitry 206, the example continuous duration control circuitry 208, the example discrete duration control circuitry 210, the example continuous duration time unit determination circuitry 212, the example continuous logic circuitry 214, the example discrete duration difference circuitry 216, the example discrete logic circuitry 218, the example probability distribution generation circuitry 220, the example probability divergence determination circuitry 222, the example cross-demographic total census parameter value determination circuitry 224, the example search space identification circuitry 226, the example census-level metrics calculation circuitry 228, the example iteration circuitry 230, the example report circuitry 232 and/or, more generally, the example audience metrics estimation circuitry 140 of FIG. 1, may be implemented by hardware, software, firmware, and/or any combination of hardware, software, and/or firmware. Thus, for example, any of the example network interface 202, the example data store 204, the example duration metrics control circuitry 206, the example continuous duration control circuitry 208, the example discrete duration control circuitry 210, the example continuous duration time unit determination circuitry 212, the example continuous logic circuitry 214, the example discrete duration difference circuitry 216, the example discrete logic circuitry 218, the example probability distribution generation circuitry 220, the example probability divergence determination circuitry 222, the example cross-demographic total census parameter value determination circuitry 224, the example search space identification circuitry 226, the example census-level metrics calculation circuitry 228, the example iteration circuitry 230, the example report circuitry 232, and/or, more generally, the example audience metrics estimation circuitry 140 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example network interface 202, the example duration metrics control circuitry 206, the example continuous duration control circuitry 208, the example discrete duration control circuitry 210, the example continuous duration time unit determination circuitry 212, the example continuous logic circuitry 214, the example discrete duration difference circuitry 216, the example discrete logic circuitry 218, the example probability distribution generation circuitry 220, the example probability divergence determination circuitry 222, the example cross-demographic total census parameter value determination circuitry 224, the example search space identification circuitry 226, the example census-level metrics calculation circuitry 228, the example iteration circuitry 230, and/or the example report circuitry 232 is/are hereby expressly defined to include a non-transitory computer readable storage device or storage disk such as a memory, a digital versatile disk (DVD), a compact disk (CD), a Blu-ray disk, etc., including the software and/or firmware. Further still, the example audience metrics estimation circuitry 140 of FIG. 1 may include one or more elements, processes, and/or devices in addition to, or instead of, those illustrated in FIG. 2, and/or may include more than one of any or all of the illustrated elements, processes and devices.

A flowchart representative of example hardware logic circuitry, machine readable instructions, hardware implemented state machines, and/or any combination thereof for implementing the audience metrics estimation circuitry 140 of FIGS. 1 and/or 2 is shown in FIGS. 3-6. The machine readable instructions may be one or more executable programs or portion(s) of an executable program for execution by processor circuitry, such as the processor circuitry 1512 shown in the example processor platform 1500 discussed below in connection with FIG. 15 and/or the example processor circuitry discussed below in connection with FIG. 16. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3-6, many other methods of implementing the example audience metrics estimation circuitry 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. An example of such circuitry is shown in FIG. 17. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to determine census-level parameters for each demographic. The machine readable instructions and/or operations 300 of FIG. 3 begin at block 302, at which the network interface 202 (FIG. 2) retrieves subscriber data from the subscriber database 122 (FIG. 1) for each demographic. The example network interface 202 retrieves subscriber data (e.g., available from the database proprietor 120 of FIG. 1) for each demographic (k) from the data storage 204 of FIG. 2 (block 302). The database proprietor 120 determines unique audience sizes, impression counts, and impression durations (e.g., subscriber audience size data 124, subscriber impression counts data 126, subscriber impression duration data 128 data of FIG. 1) for different demographic categories of subscribers based on subscriber data collected when a subscriber is exposed to media (e.g., a media item 104 of FIG. 1) on user devices 112. The database proprietor 120 may determine the subscriber data when the user devices 112 submit an example subscriber impression request 106 in response to the user device 112 accessing the example media item 104 of FIG. 1. For example, a logged impression 126 is associated with a specific subscriber (e.g., users 110), and a specific duration 128 of the logged impression 126. Based on this data, the audience metrics estimation circuitry 140 can retrieve inputs of subscriber-based audience size {Aₖ} data (e.g., subscriber audience size data 124, subscriber audience size values), subscriber impression counts {Rₖ} data (e.g., subscriber impression counts data 126, subscriber impression count values), and subscriber impression duration {Dₖ} data (e.g., subscriber impression duration data 128) for different aggregate demographic categories.

At block 304, the example network interface 202 retrieves census-level data from the census-level database 132 of the AME 130 (block 304). For example, the AME 130 can also access logged impressions that are made by users 110 when using devices 112, but the census-level data is not associated with specific demographics of the users when such users are not members of an AME panel. The AME 130 can determine the total logged impressions 136 (e.g., total number of census-level impressions by users 110) and corresponding total census-level impression durations 138, while not differentiating between individual users. As such, the census-level database 132 provides inputs to the audience metrics estimation circuitry 140 of total census-level impressions count {T_{⋅}} (e.g., census total impressions data 136) and total census-level duration {V_{⋅}} (e.g., census total duration data 138). In some examples, the network interface 202 may access the total census-level audience size {X_{⋅}} data, but not the census-level total audience size {Xₖ} (e.g., census total audience size data 134) for each demographic (k). The example census-level total audience size {Xₖ} (e.g., census total audience size data 134) for each demographic (k) is being estimated.

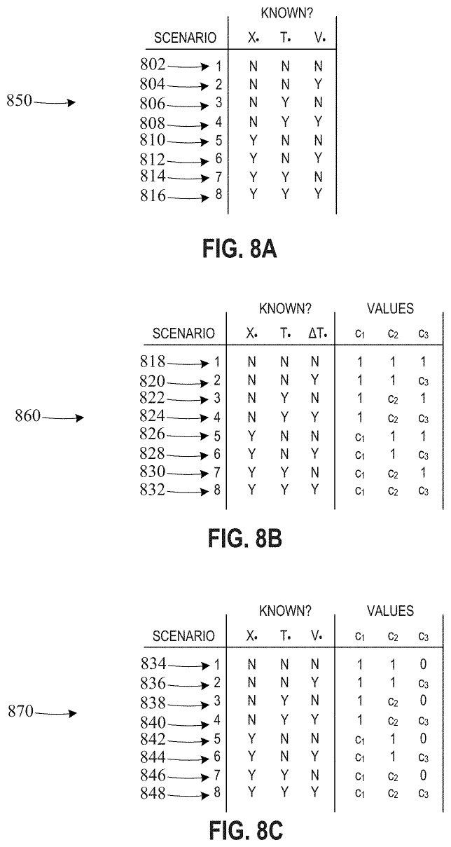

The example network interface 202 may retrieve at least one of the three inputs (e.g., the total census-level audience size {X_{⋅}}, the total census-level impressions count {T_{⋅}}, or the total census-level duration {V_{⋅}}). Retrieving “at least one of three” generates eight enumerated scenarios (e.g., cases) regarding the cross-demographic total census parameter values to be solved by the example census-level metrics calculation circuitry 228. FIG. 8A illustrates the eight enumerated cases, while FIG. 8B illustrates the preset discrete cross-demographic total census parameter values for the eight enumerated cases. FIG. 8C illustrates the preset continuous cross-demographic total census parameter values for the eight enumerated cases. For example, the network interface 202 may retrieve the total census-level audience size {X_{⋅}} and the total census-level impressions count {T_{⋅}} but be unable to retrieve the total census-level duration {V_{⋅}} (e.g., as the total census-level duration {V_{⋅}} may not be accessible according to rules determined by the database proprietor 120). For example, retrieving the total census-level audience size {X_{⋅}} and the total census-level impressions count {T_{⋅}} is enumerated as the seventh scenario 814 of FIG. 8A. The eight enumerated scenarios have different corresponding cross-demographic total census parameter values as set forth in FIG. 8B and FIG. 8C.

At block 306, the duration metrics control circuitry 206 decides to determine discrete-duration-based audience metrics or continuous-duration-based audience metrics. For example, in response to the duration metrics control circuitry 206 deciding to determine discrete-duration-based audience metrics (e.g., “DISCRETE”), control advances to block 308. Alternatively, in response to the duration metrics control circuitry 206 deciding to determine continuous-duration-based audience metrics (e.g., “CONTINUOUS”), control advances to block 310. The duration metrics control circuitry 206 may decide to determine discrete-duration-based audience metrics or continuous-duration-based audience metrics based on an indicator variable embedded in the duration data received by the network interface 202, an instruction from a specific database proprietor, or may default to use discrete-duration-based audience metrics.

At block 308, the discrete duration control circuitry 210 determines the discrete cross-demographic total census parameter values. For example, the discrete duration control circuitry 210 may determine the discrete cross-demographic total census parameter values by using the discrete logic circuitry 218, the probability distribution generation circuitry 220, the probability divergence determination circuitry 222, the example cross-demographic total census parameter value determination circuitry 224, the search space identification circuitry 226, and the iteration circuitry 230. Further details regarding the determination of the discrete cross-demographic total census parameter values are described in conjunction with FIG. 4. Control advances to block 312.

At block 310, the continuous duration control circuitry 208 determines the continuous cross-demographic total census parameter values. For example, the continuous duration control circuitry 208 may determine the continuous cross-demographic total census parameter values by using the continuous logic circuitry 214, the example probability distribution generation circuitry 220, the probability divergence determination circuitry 222, the example cross-demographic total census parameter value determination circuitry 224, the search space identification circuitry 226, and the iteration circuitry 230. Further details regarding the determination of the continuous cross-demographic total census parameter values are explained in conjunction with FIG. 5. Control advances to block 312.

At block 312, the example census-level metrics calculation circuitry 228 determines census-level parameters for each demographic. For example, the example census-level metrics calculation circuitry 228 may determine census-level parameters for each demographic (k) by using the determined cross-demographic total census parameter values to calculate the census-level unique audience size {Xₖ} for each demographic, the census-level impression counts {Tₖ} for each demographic, and the census-level duration {Vₖ} for each demographic. The census-level metrics calculation circuitry 228 may also determine that the constraints are satisfied. For example, a first constraint is that all the demographic specific audience sizes (e.g., for three (3) demographics, X₁, X₂, X₃) add up to the total census-level audience size {X_{⋅}}. If the sum of X₁, X₂, and X₃ is not the total census-level audience size {X_{⋅}} value, the example census-level metrics calculation circuitry 228 instructs the example iteration circuitry 230 to perform a second iteration of the cross-demographic total census parameter values. The census-level metrics calculation circuitry 228 then determines the census-level parameters for each demographic with the second set of determined c-values and determines if the constraints are satisfied.

At block 314, the example report circuitry 232 reports the example census-level metrics to a customer 160. For example, the example report circuitry 232 may report the example census-level metrics table to a customer 160 by outputting a metrics table such as the metrics table depicted in at least one of FIG. 10B, 11B, 12B, 13C, or 13C. The example instructions 300 end.

FIG. 4 is a flowchart representative of example machine readable instructions and/or example operations 308 that may be executed and/or instantiated by processor circuitry to determine discrete cross-demographic total census parameter values. The machine readable instructions and/or operations 308 of FIG. 4 begin at block 402, at which the discrete duration difference circuitry 216 generates scaled duration data based all impressions which are at least a minimum time unit in duration. For example, the discrete duration difference circuitry 216 may generate scaled duration data based on all impressions which are at least one second in duration.

Each person has a fixed, but unknown, number of impressions (i) and time of impression duration (d), both in the census-level and the subscriber database (e.g., “John Smith” had viewed a webpage 5 times, totaling 20 seconds, of which only 3 views and 10 seconds were registered in a database or none at all). However, aggregate information obfuscates the person-specific data and leaves a reference aggregate among the individuals within a demographic, wherein the uncertainty for each person can be expressed in the form of a probability distribution. The mathematical term p_{(i,d)} represents the probability that someone has i={1, . . . , ∞} impressions and d={i, . . . , ∞} durations, wherein the count of durations is at least as large as impressions. As used herein, “discrete duration” has at least a minimum time unit (e.g., one second). In order for a duration to be counted, the duration must have at least one impression, which results in the inequality d≥i. The discrete duration difference circuitry 216 uses the inequality d≥i to generate the triangular array 902 of valid {i, d} combinations as illustrated in FIG. 9. A scaled discrete duration r is equal to the subtraction of impressions i from the discrete durations d (e.g., r=d−i, where r≥0). The example discrete duration difference circuitry 216 uses the generated triangular array 902 to now define the probability distribution as p_{(i,r)} which is defined on the rectangular grid 904 of FIG. 9, wherein i={1, . . . , ∞} and r={0, . . . , ∞}. The difference between the triangular array 902 and rectangular grid 904 is the initial starting points. For example, an individual with i=5 and r=2 would have 5 impressions i and 7 time units of duration d (e.g., 5+2=7). As used herein, the discrete durations d is a different variable than (d₀), (d₁), (d₂) and (d₃) as described in conjunction with Equations 5-7, wherein Equation 5 is a constraint governing the probability of an individual being in the audience (e.g., having at least one impression) (d₁). Equation 6 is a constraint governing the average impression count (d₂) for an individual. Equation 7 is a constraint governing the average difference of durations to impression (d₃) for an individual. Average duration is then d₂+d₃.

At block 404, the probability distribution generation circuitry 220 determines a person-specific probability distribution with the discrete logic circuitry 218. For example, the probability distribution generation circuitry 220 may determine a person-specific probability distribution with the discrete logic circuitry 218 by using the discrete formulas stored in the discrete logic circuitry 218. For purposes of deriving the solution to individual probability distribution estimates using the example probability distribution generation circuitry 220, as assumption is made that there is a total of (U) individuals in the total population. The uncertainty with a collection of (U) probability distributions going across the possibility of each individual having any impression count (i) and any scaled duration (r), along with not having any impressions, can be expressed using the domain of i={1, . . . , ∞} and r={0, . . . , ∞} respectively, for each person, wherein, for example if U=5, persons 1-5 are assigned probabilities as follows: [p₀⁽¹⁾,p_{(i,r)}⁽¹⁾], [p₀⁽²⁾,p_{(i,r)}⁽²⁾], [p₀⁽³⁾,p_{(i,r)}⁽³⁾], [p₀⁽⁴⁾,p_{(i,r)}⁽⁴⁾], and [p₀⁽⁵⁾,p_{(i,r)}⁽⁵⁾]. The probability distribution generation circuitry 220 assigns p₀^{(j)} as the probability that the j^{th} person did not have any impression counts (e.g., point mass distribution), and assigns p_{(i,r)}^{(j)} as the probability mass function that represents the probabilities that the j^{th} person has i impression counts and i+r units of impression duration. Thus, the marginal probability of someone having i impressions, independent of duration of those views can be expressed in accordance with Equation 1 below:

Pr(i)=Σᵣ₌₀^{∞}P(i,r) Equation 1

The total probability for each individual can be further expressed in accordance with Equation 2 below, such that the combination of all probabilities associated with an individual is constrained to a total of 1:

ρ₀^{(j)}+Σᵢ₌₁^{∞}Σ_{Δi=0}^{∞}p_{(i,r)}^{(j)}=1 Equation 2

In examples in which no information on individual behavior is available, each individual within a given demographic is assigned the same probability distribution. For example, if 100 individuals have a total of 300 impression counts (e.g., page views), with a total duration of 600 seconds, each person has, on average, a total of 3 impression counts with a total duration of 6 seconds, with each impression count having an average duration of 2 seconds.

Given that the audience metrics estimation circuitry 140 has access to subscriber information (e.g., subscriber audience data 124, subscriber impression count data 126, and subscriber duration data 128), a person-specific distribution can be generated (e.g., by dividing the data amongst the individuals within a demographic) in accordance with Equations 3-7 below:

$$\begin{matrix}\begin{matrix}maximize \\ P\end{matrix} H = ( - {P}_{0} log ( {p}_{0} ) + {ρ}_{0}^{( j )} + {\sum }_{i = 1}^{∞} {\sum }_{Δ i = 0}^{∞} {p}_{( i , r )}^{( j )} = 1 & Equation 3 \\ subject to {ρ}_{0}^{( j )} + {\sum }_{i = 1}^{∞} {\sum }_{Δ i = 0}^{∞} {p}_{( i , r )}^{( j )} = {d}_{0} = 1 & Equation 4 \\ {p}_{0}^{( j )} + {\sum }_{i = 1}^{∞} {\sum }_{Δ i = 0}^{∞} {p}_{( i , r )}^{( j )} = {d}_{1} & Equation 5 \\ {p}_{0}^{( j )} + {\sum }_{i = 1}^{∞} {\sum }_{Δ i = 0}^{∞} {p}_{( i , r )}^{( j )} = {d}_{2} & Equation 6 \\ {p}_{0}^{( j )} + {\sum }_{i = 1}^{∞} {\sum }_{Δ i = 0}^{∞} {p}_{( i , r )}^{( j )} = {d}_{3} & Equation 7\end{matrix}$$

The probability distribution generation circuitry 220 assigns person-specific distribution (H) of Equation 3, which provides an estimate of the distribution for any individual within the population, subject to the constraints of Equations 4-7. Equation 4 represents the constraint that the estimated probability distribution for a given individual totals to 1 (explained in connection with Equations 1-2 above). Equation 5 is a constraint governing the probability of an individual being in the audience (e.g., having at least one impression) (d₁). Equation 6 is a constraint governing the average impression count (d₂) for an individual. Equation 7 is a constraint governing the average difference of durations to impression (d₃) for an individual. Average duration is then d₂+d₃. The probability distribution generation circuitry 220 thereby assigns and initializes values for a person-specific probability distribution (H) for individuals within a demographic based on the presented constraints of Equations 4-7.

At block 406, the probability distribution generation circuitry 220 expresses the probability distribution as z-values. For example, the probability distribution generation circuitry 220 may express the probability distribution as z-values by re-arranging the solution to the person-specific distribution problem of Equations 3-7 (e.g., express in terms of z notation) in accordance with Equations 9-12, subject to the final solution for the set of {zⱼ} expressed in accordance with Equation 8:

$$\begin{matrix}{p}_{t} = \{ \begin{matrix}{z}_{0} & k = 0 and t = 0 \\ {z}_{0} {z}_{1} {z}_{2}^{i} {z}_{3}^{r} & i \geq 1 and r \geq p\end{matrix} & Equation 8 \\ {p}_{0} + {\sum }_{i = 1}^{∞} {\sum }_{r = 0}^{∞} {p}_{( i , r )} = {z}_{0} + {\sum }_{i = 1}^{∞} {\sum }_{r = 0}^{∞} {z}_{0} {z}_{1} {z}_{2}^{i} {z}_{3}^{r} = {z}_{0} + \frac{{z}_{0} {z}_{1} {z}_{2}}{( 1 - {z}_{2} ) ( 1 - {z}_{3} )} = 1 & Equation 9 \\ {\sum }_{i = 1}^{∞} {\sum }_{r = 0}^{∞} {p}_{( i , r )} = {z}_{0} + {\sum }_{i = 1}^{∞} {\sum }_{r = 0}^{∞} {z}_{0} {z}_{1} {z}_{2}^{i} {z}_{3}^{r} = {z}_{0} + \frac{{z}_{0} {z}_{1} {z}_{2}}{( 1 - {z}_{2} ) ( 1 - {z}_{3} )} = {d}_{1} & Equation 10 \\ {\sum }_{i = 1}^{∞} {\sum }_{r = 0}^{∞} {ip}_{( i , r )} = {z}_{0} + {\sum }_{i = 1}^{∞} {\sum }_{r = 0}^{∞} {iz}_{0} {z}_{1} {z}_{2}^{i} {z}_{3}^{r} = {z}_{0} + \frac{{z}_{0} {z}_{1} {z}_{2} {z}_{3}}{( 1 - {z}_{2} ) ( 1 - {z}_{3} )} = {d}_{2} & Equation 11 \\ {\sum }_{i = 1}^{∞} {\sum }_{r = 0}^{∞} {rp}_{( i , r )} = {z}_{0} + {\sum }_{i = 1}^{∞} {\sum }_{r = 0}^{∞} {rz}_{0} {z}_{1} {z}_{2}^{i} {z}_{3}^{r} = {z}_{0} + \frac{{z}_{0} {z}_{1} {z}_{2} {z}_{3}}{( 1 - {z}_{2} ) {( 1 - {z}_{3} )}^{2}} = {d}_{3} & Equation 12\end{matrix}$$

The probability distribution generation circuitry 220 may solve for the variables z₀, z₁, z₂, and z₃, which may be called “distribution parameters” as each of the variables relates to the probability distribution. The probability distribution generation circuitry 220 may express z₂ⁱ and z₃^{r} together as based on the logical definitions, it is impossible to have impressions without a duration and durations without an impression.

The solution of the distribution parameters {z₀, z₁, z₂, z₃} may be solved in closed form according to discrete Equations 13-16:

$$\begin{matrix}{z}_{0} = 1 - {d}_{1} & Equation 13 \\ {z}_{1} = \frac{{d}_{1}^{3}}{( 1 - {d}_{1} ) ( {d}_{2} - {d}_{1} ) ( {d}_{1} + {d}_{3} )} & Equation 14 \\ {z}_{2} = 1 - \frac{{d}_{1}}{{d}_{2}} & Equation 15 \\ {z}_{3} = \frac{{d}_{3}}{{d}_{1} + {d}_{3}} & Equation 16\end{matrix}$$

Once a solution to the individual probability distribution estimate is available, an estimate of any probability can be calculated for each individual (e.g., audience member). For example, if among 100 individuals there is an audience of 50 people and 200 impression counts (e.g., page views) with 350 time units of duration, z₀, z₁, z₂, and z₃) can be solved for as shown below in Example 1, based on Equations 13-16:

$${d}_{0} = \frac{100}{100} {z}_{0} = 0.5 \\ {d}_{1} = \frac{50}{100} {z}_{1} = 0.0833 \\ {d}_{2} = \frac{200}{100} {z}_{2} = 0.7500 \\ {d}_{3} = \frac{150}{100} {z}_{3} = 0.7500 \qquad Example 1$$

In this example, the estimate of any probability can be calculated for each individual, such that if p₀=z₀=0.5, there is a 50% chance of the individual having no impression counts with no duration. To estimate the probability of the audience in this example having 3 impression counts (e.g., i=3), the audience metrics estimation circuitry 140 can apply Equation 1 to generate an estimate, as shown below in Example 2:

Pr(i=3)=Σᵣ₌₀^{∞}p_{(3,r)}≈0.0703125 Example 2

At block 408, the probability divergence determination circuitry 222 solves the Kullback-Leibler (KL) divergence by applying the Lagrangian. For example, the probability divergence determination circuitry 222 may solve the KL divergence by applying the Lagrangian to generated probability distributions. A probability divergence allows for a comparison between two probability distributions. In the examples disclosed herein, the probability divergence permits a comparison between the distribution of subscriber data and the distribution of census-level data. In the examples disclosed herein, a Kullback-Leibler probability divergence (KL divergence) is used to measure the difference between these two probability distributions (e.g., determine how well one probability distribution approximates another probability distribution). For example, the probability divergence determination circuitry 222 defines subscriber data as a prior distribution (Q) and census-level data as a posterior distribution (P). The audience size and impression durations are equally divided across the entire population of individuals in a k^{th} demographic {Uₖ}, such that U is representative of a population universe estimate. A universe estimate (e.g., a total audience) can be defined as, for example, the total number of persons that accessed the media in a particular geographic scope of interest and/or during a time of interest relating to media audience metrics. For example, the universe estimate can be based on census-level data obtained by the AME 130 during assessment of logged impressions by user devices 112. For example, the k^{th} demographic can represent a demographic category (e.g., females 35-40, males 35-40, etc.). The expected values of duration are consistent with Equations 17-20:

$$\begin{matrix}{d}_{0}^{Q} = 1 {d}_{0}^{P} = 1 & Equation 17 \\ {d}_{1}^{Q} = \frac{{A}_{k}}{{U}_{k}} {d}_{1}^{P} = \frac{{X}_{k}}{{U}_{k}} & Equation 18 \\ {d}_{2}^{Q} = \frac{{R}_{k}}{{U}_{k}} {d}_{2}^{P} = \frac{{T}_{k}}{{U}_{k}} & Equation 19 \\ {d}_{3}^{Q} = \frac{Δ {R}_{k}}{{U}_{k}} {d}_{3}^{P} = \frac{Δ {T}_{k}}{{U}_{k}} & Equation 20\end{matrix}$$

In Equations 17-20, the probability that a specific individual in the k^{th} demographic is a member of the aggregated subscriber audience total {Aₖ} is defined as {Aₖ/Uₖ}, the probability that a specific individual in the k^{th} demographic has impression counts in the aggregated subscriber impression count total {Rₖ} is defined as {Rₖ/Uₖ}, and the probability that a specific individual in the k^{th} demographic has an scaled impression duration in the aggregated impression duration total is {(ΔRₖ)/Uₖ} wherein (Dₖ=Rₖ ΔRₖ) and (Vₖ=Tₖ+ΔTₖ). As used herein, {Dₖ} is the durations for the k^{th} demographic for the aggregated subscriber database, and {Vₖ} is the durations for the k^{th} demographic for the census-level database. {ΔTₖ} is the difference of census-level impression counts and impression durations, and {ΔRₖ} is the difference of subscriber impression counts and impression durations {ΔRₖ}. The example probability divergence determination circuitry 222 uses theorems from Information Theory and the Maximum entropy solution to directly to answer the KL divergence of that individual from the database proprietor (subscriber) to census in accordance with discrete Equation 21:

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) \qquad Equation 21$$

where Pₖ is a posterior probability distribution defining census-level data and Qₖ is a prior probability distribution defining subscriber data) of an individual from subscriber data to census-level data. The example probability divergence determination circuitry 222 may express the KL divergence in terms of z notation, referring to the solutions to {z₀, z₁, z₂, and z₃} determined in Equations 13-16 as previously described, and reproduced below as Equations 22-25:

$$\begin{matrix}{z}_{0} = 1 - {d}_{1} & Equation 22 \\ {z}_{1} = \frac{{d}_{1}^{3}}{( 1 - {d}_{1} ) ( {d}_{2} - {d}_{1} ) ( {d}_{1} + {d}_{3} )} & Equation 23 \\ {z}_{2} = 1 - \frac{{d}_{1}}{{d}_{2}} & Equation 24 \\ {z}_{3} = \frac{{d}_{3}}{{d}_{1} + {d}_{3}} & Equation 25\end{matrix}$$

In some examples, the example probability divergence determination circuitry 222 expands discrete Equation 21 based on a principle of logarithms to yield a description of how any specific individual's distribution within the k^{th} demographic can change, in accordance with discrete Equation 26:

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) = {\sum }_{j = 0}^{m} {d}_{j}^{P} [ log ( {z}_{j}^{P} ) - log ( {z}_{j}^{Q} ) ] = ( {d}_{0}^{P} ) [ log ( {z}_{0}^{P} ) - log ( {z}_{0}^{Q} ) ] … + ( {d}_{1}^{P} ) [ log ( {z}_{1}^{P} ) - log ( {z}_{1}^{Q} ) ] … + ( {d}_{2}^{P} ) [ log ( {z}_{2}^{P} ) - log ( {z}_{2}^{Q} ) ] … + ( {d}_{3}^{P} ) [ log ( {z}_{3}^{P} ) - log ( {z}_{3}^{Q} ) ] \qquad Equation 26$$

Given that all individuals in a k^{th} demographic are assumed to have the same behavior, the probability divergence determination circuitry 222 multiplies the KL(Pₖ:Qₖ) by the number of individuals in the k^{th} demographic {Uₖ} to determine how the individuals within a demographic can change collectively (e.g., since the divergences are the same, multiplication is used instead of adding the KL-divergence of each individually together). To determine the total divergence across the population, the probability divergence determination circuitry 222 sums across all divergences and across all demographics, in accordance with discrete Equation 27:

KL(P:Q)=Σₖ₌₁^{K}Uₖ(KL(Pₖ:Qₖ)) Equation 27

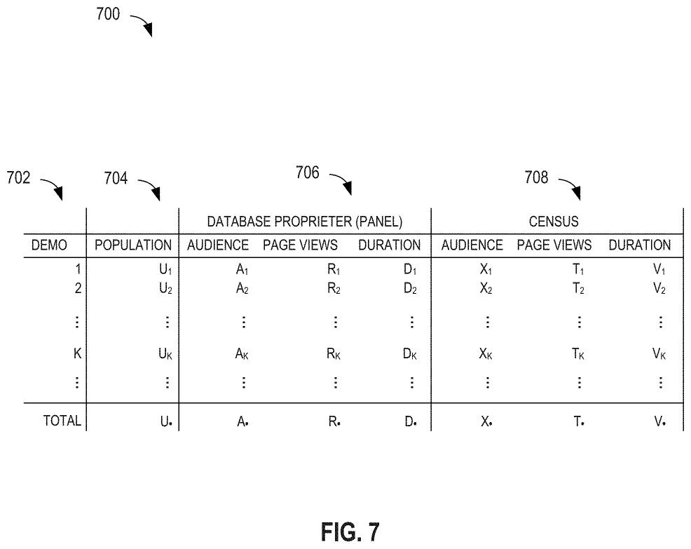

Discrete Equation 27 above, once all the variables within the table (e.g., the example table 700 of FIG. 7) have been substituted, fully describes the behavior of audiences for an individual demographic k (e.g., subscriber audience size Aₖ, census-level audience size {Xₖ}), impression counts (e.g., pageviews, subscriber impression counts {Rₖ}, census-level impression counts {Tₖ}), and durations (e.g., subscriber durations Dₖ, census-level durations {Vₖ}) once minimized. The probability divergence determination circuitry 222 is to access the unknown individual demographic audience sizes {Xₖ} impression counts {Tₖ}, and duration differences from impressions {ΔTₖ}, however the audience metric parameters are subject to the aggregate constraints of at least one of ΣXₖ=X_{⋅}, ΣTₖ=T_{⋅}, or ΣΔTₖ=ΔT_{⋅}. The example probability divergence determination circuitry 222 then minimizes Equation 27 in accordance with Equation 28:

$$\begin{matrix}{minimize}_{\{ {X}_{k} \} , \{ {T}_{k} \} , \{ {V}_{k} \}} & KL ( P : Q ) = {\sum }_{k = 1}^{K} {U}_{k} ( K L ( {P}_{k} : {Q}_{k} ) ) \\ subject to & {\sum }_{k = 1}^{K} {X}_{k} = X . \\ & {\sum }_{k = 1}^{K} {T}_{k} = T . \\ & {\sum }_{k = 1}^{K} {ΔT}_{k} = ΔT .\end{matrix} \qquad Equation 28$$

In Equation 28, {Xₖ}, {Tₖ}, and {Vₖ} represent census-level data pertaining to unique audience size, impression counts, and impression duration, respectively, all of which are unknown, wherein Vₖ=Tₖ+ΔTₖ and V_{⋅}=T_{⋅}+ΔT_{⋅}. The example probability divergence determination circuitry 222 solves the system by applying (e.g., taking) the Lagrangian ( [symbol] ) in accordance with Equations 29-32, where the solution is for all (∀) demographics k={1, 2, . . . , K}, in addition to setting the partial derivative with respect to the Lagrange multipliers (λ₁, λ₂, and λ₃) equal to 0 (e.g., Equation 33):

$$\begin{matrix}ℒ = KL ( P \text{:} Q ) - {λ}_{1} ( {\sum }_{k = 1}^{K} {X}_{k} - X . ) - {λ}_{2} ( {\sum }_{k = 1}^{K} {T}_{k} - T . ) - {λ}_{3} ( {\sum }_{k = 1}^{K} Δ {T}_{k} - Δ T . ) & Equation 29 \\ \frac{\partial ℒ}{\partial {X}_{k}} = 0 ∀ k = \{ 1 , 2 , … , K \} & Equation 30 \\ \frac{\partial ℒ}{\partial {T}_{k}} = 0 ∀ k = \{ 1 , 2 , … , K \} & Equation 31 \\ \frac{\partial ℒ}{\partial Δ {T}_{k}} = 0 ∀ k = \{ 1 , 2 , … , K \} & Equation 32 \\ \frac{\partial ℒ}{\partial {λ}_{1}} = 0 \frac{\partial ℒ}{\partial {λ}_{2}} = 0 \frac{\partial ℒ}{\partial {λ}_{3}} = 0 & Equation 33\end{matrix}$$

The probability divergence determination circuitry 222 solves the Lagrangian of Equation 29 using the Lagrange multipliers (λ₁, λ₂, and λ₃) to represent the census-level audience size constraint (λ₁), included within the reference census-level data for total audience sizes {X}, the census-level impression count constraint (λ₂), included within the reference census-level data for total impression counts {T}, and the difference of census-level impression counts and durations constraint (λ₃), included within the reference census-level data for the difference between impression counts and durations {ΔT}. Other than the constraints of total impression counts (λ₁), total impression counts (λ₂), and total difference of census-level impressions counts and impression durations (λ₃) across demographics (k), each demographic is mutually exclusive and does not impact the other demographics. Therefore, besides that addition of the constraints noted above, the Lagrangian-based ( [symbol] ) derivative of census-level unique audience size {Xₖ}, impression counts {Tₖ}, and difference of census-level impression counts and impression durations {ΔTₖ} involve terms of the same demographic k (e.g., females 35-40 years of age).

In some examples, in Equation 29, the example probability divergence determination circuitry 222 may set the maximum entropy parameters values to zero (e.g., λ₁=0, λ₂=0, λ₃=0) wherein the terms which contribute to the corresponding constraint disappear. An expression wherein the maximum entropy parameter value is set to zero is now unconstrained. The example probability divergence determination circuitry 222 may use the transformation c₁=e^{λ1} (e.g., c₁=exp(λ₁)), c₂=e^{λ}^{₂} (e.g., c₂=exp(λ₂)), and c₃=e^{λ}^{₃} (e.g., c₃=exp(λ₃)), which is equivalent to predefining the cross-demographic total census parameter values as c₁=1 or c₂=2, or c₃=1 if the corresponding aggregate constraint is not specified. The example census-level metrics calculation circuitry 228 may predefine the cross-demographic total census parameter values based on the data received by the example network interface 202. The cross-demographic total census parameter values that are not predefined are still solved by the example census-level metrics calculation circuitry 228 as shown in the example discrete logic table 860 of FIG. 8B.

At block 410, the example probability divergence determination circuitry 222 finds the discrete cross-demographic total census parameter values based on solution of the Kullback-Leibler (KL) divergence. For example, the example probability divergence determination circuitry 222 may find the cross-demographic total census parameter values by solving the KL divergence simultaneously in accordance with Equations 34-36 below:

$$\begin{matrix}\frac{\partial ℒ}{\partial {X}_{k}} = log ( \frac{{X}_{k}^{3}}{( {T}_{k} - {X}_{k} ) ( {U}_{k} - {X}_{k} ) ( {X}_{k} + Δ {T}_{k} )} ) - log ( \frac{{A}_{k}^{3}}{( {R}_{k} - {A}_{k} ) ( {U}_{k} - {A}_{k} ) ( {A}_{k} + Δ {R}_{k} )} ) - {λ}_{1} & Equation 34 \\ \frac{\partial ℒ}{\partial {T}_{k}} = log ( 1 - \frac{{X}_{k}}{{T}_{k}} ) - log ( 1 - \frac{{A}_{k}}{{R}_{k}} ) - {λ}_{2} & Equation 35 \\ \frac{\partial ℒ}{\partial Δ {T}_{k}} = log ( \frac{Δ {T}_{k}}{{X}_{k} + Δ {T}_{k}} ) - log ( \frac{Δ {R}_{k}}{{A}_{k} + Δ {R}_{k}} ) - {λ}_{3} & Equation 36\end{matrix}$$

In Equation 34-36 above, the census-level unique audience size {Xₖ} for an individual demographic k, census-level impression counts {Tₖ} for an individual demographic k, and the difference of census-level impression counts and impression durations {ΔTₖ} for an individual demographic k appear within each equation, so each Equation 34-36 is to be solved simultaneously when equaled to zero. The example probability divergence determination circuitry 222 substitutes c₁=e^{λ1} (e.g., c₁=exp(λ₁)), c₂=e^{λ}^{₂} (e.g., c₂=exp(λ₂)), and c₃=e^{λ}^{₃} (e.g., c₃=exp(λ₃)), wherein the cross-demographic total census parameter values (e.g., intermediate solution values, c-values, the cross-demographic constraint finder values, etc.) are used to find the frequency of impressions and the odds of an individual being in a demographic audience in proportion to the universal audience. The example probability divergence determination circuitry 222 defines new discrete Equations 37, 38, and 39, which will be used with the cross-demographic total census parameter values to determine the frequency of impressions and the odds of an individual being in a demographic audience in proportion to the universal audience. Discrete Equations 37-39 are listed below:

$$\begin{matrix}{s}_{k}^{( 1 )} = \frac{{A}_{k}^{3}}{( {R}_{k} - {A}_{k} ) ( {U}_{k} - {A}_{k} ) ( {A}_{k} + Δ {R}_{k} )} ≡ {z}_{1}^{Q} ( for demo k ) & Equation 37 \\ {s}_{k}^{( 2 )} = 1 - \frac{{A}_{k}}{{R}_{k}} ≡ {z}_{2}^{Q} ( for demo k ) & Equation 38 \\ {s}_{k}^{( 3 )} = \frac{Δ {R}_{k}}{{A}_{k} + Δ {R}_{k}} ≡ {z}_{3}^{Q} ( for demo k ) & Equation 39\end{matrix}$$

The equations 37-39 are identical to the previously solved prior variables. Therefore, the solution for the census-level unique audience size {Xₖ} for an individual demographic k, impression counts {Tₖ} for an individual demographic k, difference of census-level impression counts and impression durations {ΔTₖ} for an individual demographic k, and therefore the census-level impression duration {Vₖ} for an individual demographic k is based on cross-demographic total census parameter values, Equations 37-39 above, and the following Equations 43-49. In the Equations 37-39, the s-variables sₖ⁽¹⁾, sₖ⁽²⁾, and sₖ⁽³⁾ are equivalent to the z-variables (e.g., distribution parameters) for the Q distribution (e.g., the Census-level distribution).

In some examples, the census-level metrics calculation circuitry 228 may solve Equation 34 above for a single demographic. The example census-level metrics calculation circuitry 228 may uses Equation 40 as shown below:

$$\frac{{A}^{3}}{( R - A ) ( U - A ) ( A + D - R )} = \frac{{X}^{3}}{( T - X ) ( U - X ) ( X + V - T )} \qquad Equation 40$$

The example census-level metrics calculation circuitry 228 derives Equation 40 based on Equations 36-38, which is reproduced for convenience:

$$\begin{matrix}\frac{\partial ℒ}{\partial {X}_{k}} = log ( \frac{{X}_{k}^{3}}{( {T}_{k} - {X}_{k} ) ( {U}_{k} - {X}_{k} ) ( {X}_{k} + Δ {T}_{k} )} ) - log ( \frac{{A}_{k}^{3}}{( {R}_{k} - {A}_{k} ) ( {U}_{k} - {A}_{k} ) ( {A}_{k} + Δ {R}_{k} )} ) - {λ}_{1} & Equation 34 \\ \frac{\partial ℒ}{\partial {T}_{k}} = log ( 1 - \frac{{X}_{k}}{{T}_{k}} ) - log ( 1 - \frac{{A}_{k}}{{R}_{k}} ) - {λ}_{2} & Equation 35 \\ \frac{\partial ℒ}{\partial Δ {T}_{k}} = log ( \frac{Δ {T}_{k}}{{X}_{k} + Δ {T}_{k}} ) - log ( \frac{Δ {R}_{k}}{{A}_{k} + Δ {R}_{k}} ) - {λ}_{3} & Equation 36\end{matrix}$$

For the single-demographic version, the census-level metrics calculation circuitry 228 removes the subscript k to compute a single demographic as shown in Equation 41:

$$\frac{\partial ℒ}{\partial X} = log ( \frac{{X}^{3}}{( T - X ) ( U - X ) ( X + Δ T )} ) - log ( \frac{{A}^{3}}{( R - A ) ( U - A ) ( A + Δ R )} ) \qquad Equation 41$$

Wherein in Equation 41, after setting the partial derivative with respect to the audience size {Xₖ} to zero and re-arranging generates Equation 42:

$$log ( \frac{{X}^{3}}{( T - X ) ( U - X ) ( X + Δ T )} ) = log ( \frac{{A}^{3}}{( R - A ) ( U - A ) ( A + Δ R )} ) \qquad Equation 42$$

Wherein Equation 42 is identical to Equation 40 after the exponent is taken (e.g., the logarithm is removed) and the definitions {ΔT}={V}−{T} and {ΔR}={D}−{R}.

At block 412, the probability divergence determination circuitry 222 then solves for the odds and frequency. For example, the probability divergence determination circuitry 222 may solve for the odds and frequency by using the Equations 37-39 and the cross-demographic total census parameter values as described in Equations 43-49 shown below:

$$\begin{matrix}{f}_{k}^{( T )} = {( 1 - {c}_{2} {s}_{k}^{( 2 )} )}^{- 1} & Equation 43 \\ {f}_{k}^{( Δ T )} = \frac{( {c}_{3} {s}_{k}^{( 3 )} )}{1 - ( {c}_{3} {s}_{k}^{( 3 )} )} & Equation 44 \\ {f}_{k}^{( V )} = {f}_{k}^{( T )} + {f}_{k}^{( Δ T )} & Equation 45 \\ {o}_{k} = ( {c}_{1} {s}_{k}^{( 1 )} ) ( {f}_{k}^{( T )} - 1 ) ( {f}_{k}^{( Δ T )} + 1 ) & Equation 46 \\ {X}_{k} = ( \frac{{o}_{k}}{1 + {0}_{k}} ) {U}_{k} & Equation 47 \\ {T}_{k} = {f}_{k}^{( T )} {X}_{k} & Equation 48 \\ {V}_{k} = {f}_{k}^{( V )} {X}_{k} & Equation 49\end{matrix}$$

As shown above, in Equations 43-49, the example probability divergence determination circuitry 222 determines the frequency and odds for the census-level k^{th} demographic. In the above Equations 43-49, {fₖ^{(T)}} is the estimated frequency of impressions and {fₖ^{(V)}} is the estimated frequency of durations. The example probability divergence determination circuitry 222 uses {σₖ} which is the odds of the demographic audience {Xₖ} in proportion to the demographic Universe Estimate {Uₖ} to solve for the audience size estimate for each demographic {Xₖ}. The example probability divergence determination circuitry 222 determines census-level impressions count {Tₖ} and census-level impression duration {Vₖ} directly from {fₖ^{(T)}} and {fₖ^{(V)}} with the estimated audience size estimate for each demographic {Xₖ}.

In some examples, the subscriber audience size {Aₖ} is equal to the subscriber impression count {Rₖ} (e.g., Aₖ=Rₖ), the subscriber impression count is equal to the impression duration {Dₖ} (e.g., Rₖ=Dₖ), or the subscriber audience size, and the subscriber impression count, and the subscriber impression duration are all equal (e.g., Aₖ=Rₖ=Dₖ). In those (((examples, the s-variables {sₖ⁽¹⁾, sₖ⁽²⁾), sₖ⁽³⁾} in Equations 37-39 may diverge to infinity which yields undetermined values for Equations 43-49. The example probability divergence determination circuitry 222 may rephrase the Equations 43-49 as Equations 50-58, which avoid possible division by zero:

$$\begin{matrix}{W}_{k}^{( T )} = {R}_{k} - {c}_{2} ( {R}_{k} - {A}_{k} ) & Equation 50 \\ {W}_{k}^{( Δ T )} = {A}_{k} + ( 1 - {c}_{3} ) Δ {R}_{k} & Equation 51 \\ {f}_{k}^{( T )} = \frac{{R}_{k}}{{W}_{k}^{( T )}} & Equation 52 \\ {f}_{k}^{( Δ T )} = \frac{( {c}_{3} Δ {R}_{k} )}{{W}_{k}^{( Δ T )}} & Equation 53 \\ {f}_{k}^{( V )} = {f}_{k}^{( T )} + {f}_{k}^{( Δ T )} & Equation 54 \\ {o}_{k} = ( \frac{1}{{c}_{1} {c}_{2}} ) ( \frac{{U}_{k} - {A}_{k}}{{A}_{k}} ) ( \frac{{W}_{k}^{( T )}}{{A}_{k}} ) ( \frac{{W}_{k}^{( Δ t )}}{{A}_{k}} ) & Equation 55 \\ {X}_{k} = ( \frac{1}{1 + {o}_{k}} ) {U}_{k} & Equation 56 \\ {T}_{k} = {f}_{k}^{( T )} {X}_{k} & Equation 57 \\ {V}_{k} = {f}_{k}^{( V )} {X}_{k} & Equation 58\end{matrix}$$

Wherein in Equations 50-58, no term will diverge to infinity and there is no concern about division by zero in the edge cases where the subscriber audience size {Aₖ} is equal to the subscriber impression count {Rₖ} (e.g., Aₖ=Rₖ), the subscriber impression count is equal to the impression duration {Dₖ} (e.g., Rₖ=Dₖ), or the subscriber audience size, and the subscriber impression count, and the subscriber impression duration are all equal (e.g., Aₖ=Rₖ=Dₖ). In Equations 50-55, the script W is for notational simplicity and was in the denominator of Equation 52 and Equation 53. The algebraic manipulation of the Equations 43-49 allow the example probability divergence determination circuitry 222 to generate valid expressions across the full spectrum of possible valid inputs. Equations 50-58 is valid for both edge cases and non-edge cases and will be used in the examples described in FIGS. 10, 11, 12, 13.

At block 414, the example search space identification circuitry 226 determines the discrete search space for the cross-demographic total census parameter values based on the inequalities in accordance with Equations 59-61:

$$\begin{matrix}0 \leq {c}_{1} < ∞ & Equation 59 \\ 0 \leq {c}_{2} \leq min ( \frac{{R}_{k}}{{R}_{k} - {A}_{k}} ) & Equation 60 \\ 0 \leq {c}_{3} \leq 1 + min ( \frac{{A}_{k}}{Δ {R}_{k}} ) & Equation 61\end{matrix}$$

Wherein, in Equations 59-61 the lower bound (minimum value) is zero. In Equation 59, the upper bound (maximum value) is positive infinity. In some examples, the upper bound may be reduced, which reduces the search space, and improves the functioning of a computer as it reduces wasted resources. In Equation 60, the upper bound is the minimization of Impressions per demographic {Rₖ} divided by the difference of the unique audience size per demographic {Aₖ} from the impressions per demographic {Rₖ}. In Equation 61, the upper bound is the addition of the one (“1”) and the minimization of the unique subscriber audience size per demographic {Aₖ} and the difference in impressions {ΔRₖ}.

In some examples, the search space identification circuitry 226 is to define the search space by reducing the inequality bounds. The bounds for {c₁, c₂, c₃} are valid for the logical constraints but are the loosest bounds available when no information on the census-level constraints is received by the network interface 202. If the example network interface 202 receives certain census-level constraints which yield a particular unique solution, the bounds for the valid {c₁, c₂, c₃} are tightened by the example search space identification circuitry 226. Tightening the bounds improves the efficiency of a computer as the example iteration circuitry 230 wastes less resources searching for valid but incorrect solutions.

Receiving constraints on the total census-level impressions {T_{⋅}} and the total census-level impression duration {V_{⋅}} does not reduce the bounds for the second and third cross-demographic total census parameter values {c₂, c₃} from Equations 59-61. However, additional knowledge of the total census-level audience {X_{⋅}} reduces all three bounds for {c₁, c₂, c₃}. The example search space identification circuitry 226 generates Equation 62 which is a statement on sequences:

$$\begin{matrix}min \\ i\end{matrix} ( \frac{{a}_{i}}{{b}_{i}} ) \leq \frac{{\sum }_{i = 1}^{n} {a}_{i}}{{\sum }_{i = 1}^{n} {b}_{i}} \leq \begin{matrix}max \\ i\end{matrix} ( \frac{{a}_{i}}{{b}_{i}} ) \qquad Equation 62$$

Example Equation 62 includes a first sequence of positive numbers {a₁, . . . , aₙ} and a second sequence of positive numbers {b₁, . . . , bₙ}. The example search space identification circuitry 226 applies Equation 62 to the sequence {Tₖ, Xₖ} and sums across demographics k to generate Equation 63:

$$\begin{matrix}min \\ k\end{matrix} ( \frac{{T}_{k}}{{X}_{k}} ) \leq \frac{T .}{X .} \leq \begin{matrix}max \\ k\end{matrix} ( \frac{{T}_{k}}{{X}_{k}} ) \qquad Equation 63$$

Example Equation 63 is one of six different inequalities which hold true. The census-level totals are known (e.g., {X_{⋅}}, {T_{⋅}}, and {V_{⋅}}) along with the universal estimate {U}. The search space identification circuitry 226 selects two of the four totals (e.g., {X_{⋅}}, {T_{⋅}}, {V_{⋅}}, and {U_{⋅}}) to use in the application of Equation 63. The order does not matter within the two totals chosen out of the four totals, which yields six possible combinations. Another combination the example search space identification circuitry 226 is to select is listed in Equation 64:

$$\begin{matrix}min \\ k\end{matrix} ( \frac{{X}_{k}}{{U}_{k}} ) \leq \frac{X .}{U .} \leq \begin{matrix}max \\ k\end{matrix} ( \frac{{X}_{k}}{{U}_{k}} ) \qquad Equation 64$$

The example search space identification circuitry 226 is to reduce the Equations 37-39 and 59-61 as listed below in Equations 65-73:

$$\begin{matrix}{s}^{( 1 )} = ∞ & Equation 65 \\ {s}^{( 2 )} = min ( \frac{{R}_{k}}{{R}_{k} - {A}_{k}} ) & Equation 66 \\ {s}^{( 3 )} = 1 + min ( \frac{{A}_{k}}{Δ {R}_{k}} ) & Equation 67 \\ {t}_{k}^{( 2 )} = ( 1 - \frac{X .}{T .} ) {( 1 - \frac{{A}_{k}}{{R}_{k}} )}^{- 1} & Equation 68 \\ {t}_{k}^{( 3 )} = ( \frac{Δ T .}{\{ X . + Δ T .} ) {( \frac{Δ {R}_{k}}{{A}_{k} + Δ {R}_{k}} )}^{- 1} & Equation 69 \\ {c}_{2}^{( min )} = max \{ 0 , \begin{matrix}min \\ k\end{matrix} ( {t}_{k}^{( 2 )} ) \} & Equation 70 \\ {c}_{2}^{( max )} = min \{ {s}^{( 2 )} , \begin{matrix}max \\ k\end{matrix} ( {t}_{k}^{( 2 )} ) \} & Equation 71 \\ {c}_{3}^{( min )} = max \{ 0 , \begin{matrix}min \\ k\end{matrix} ( {t}_{k}^{( 3 )} ) \} & Equation 72 \\ {c}_{3}^{( min )} = min \{ {s}^{( 3 )} , \begin{matrix}max \\ k\end{matrix} ( {t}_{k}^{( 3 )} ) \} & Equation 73\end{matrix}$$

In example Equations 65-67, s is the census-level parameter, which is similar to the z for the subscriber parameter. In Equations 68-69, t is a simplification parameter which is used in Equations 70-73. In Equations 70-71, there are a new minimum and a new maximum for the second cross-demographic total census parameter value. In Equations 72-73, there is a new minimum and a new maximum for the third cross-demographic total census parameter value. The value for the minimum of the first cross-demographic total census parameter value is still zero. The value for the maximum of the first cross-demographic total census parameter value is reduced from the unbounded value of positive infinity (∞) as depicted in Equation 58 to the finite value as shown in Equation 74:

$${c}_{1}^{( max )} = \begin{matrix}max \\ k\end{matrix} ( \frac{\begin{matrix}( {A}_{k} + ( 1 - {c}_{3}^{( min )} ) Δ {R}_{k} ) \\ ( {R}_{k} - ( {R}_{k} - {A}_{k} ) {c}_{2}^{( min )} ( {U}_{k} - {A}_{k} ) X .\end{matrix}}{{A}_{k}^{3} {c}_{2}^{( min )} ( U . - X . )} ) \qquad Equation 74$$

The example search space identification circuitry 226 in response to the above Equations 70-73 is to bound the valid solution from the Equations 59-61 to the below Equations 75-77:

c₁^{(min)≤c}₁≤c₁^{(max)} Equation 75

c₂^{(min)}≤c₂≤c₂^{(max)} Equation 76

c₃^{(min)}≤c₃≤c₃^{(max)} Equation 77

Example Equations 75-77 result in a smaller search space for the example iteration circuitry 230 to iterate through.

At block 416, the example iteration circuitry 230 iterates between the cross-demographic total census parameter values. For example, the example iteration circuitry 230 may iterate between the cross-demographic total census parameter values by selecting a first value. For each iteration, the example census-level metrics calculation circuitry 228 determines the census-level metrics. For example, the example census-level metrics calculation circuitry 228 may notice that as the second cross-demographic total census parameter value (e.g., c₂) and the third cross-demographic total census parameter value (e.g., c₃) increase, the estimate of the census-level unique audience size {Xₖ} for an individual demographic k also increases. Eventually, as the iterations continue, the estimate of the census-level unique audience size {Xₖ} for an individual demographic k reaches a maximum limit which is the universal audience size {Uₖ}. The second and third cross-demographic total census parameter value is to be below the upper limit (e.g., the minimization as described in Equations 60-61 across all demographics). Control returns to block 312.

FIG. 5 is a flowchart representative of example machine readable instructions and/or example operations 310 that may be executed and/or instantiated by processor circuitry to determine continuous cross-demographic total census parameter values. The machine readable instructions and/or operations 310 of FIG. 5 begin at block 502, at which the probability distribution generation circuitry 220 determines a person-specific probability distribution with the continuous logic circuitry 214. For example, the probability distribution generation circuitry 220 may determine a person-specific probability distribution with the continuous logic circuitry 214 by using the continuous formulas stored in the continuous logic circuitry 214.

For purposes of deriving the solution, the example probability distribution generation circuitry 220 may assign each person has a fixed, but unknown, number of impressions (i) and time of impression duration (d), both in the census-level and the subscriber database (e.g., “John Smith” had viewed a webpage 5 times, totaling 20 minutes, of which only 3 views and 10 minutes were registered in a database or none at all). However, aggregate information obfuscates the person-specific data and leaves a reference aggregate among the individuals within a demographic, wherein the uncertainty for each person can be expressed in the form of a probability distribution. The probability distribution is a mixture of a point mass and a bivariate distribution which is continuous in one dimension and discrete in a second dimension. The point mass is at k=0, which represents an individual did not view any pages and therefore has no duration. The bivariate part is the mathematical term p_{(k,t)} which is discrete along k={1, . . . , ∞} impressions and continuous along the open interval tϵ={0, . . . , ∞} durations. FIG. 15 illustrates the point mass and bivariate distribution as a mixed discrete and continuous distribution. In some examples, the distribution is represented as parallel sheets of continuous curves, each curve spaced at each value of k. As used herein, “continuous duration” is scale invariant, wherein the calculations may be performed with the unit selected as hours or minutes and the audience estimation metrics such as audience size and impressions will not change, while the duration will be scaled accordingly.

For purposes of deriving the solution to individual probability distribution estimates using the example probability distribution generation circuitry 220, as assumption is made that there is a total of U individuals in the total population. The uncertainty with a collection of U probability distributions going across the possibility of each individual having any impression count (i) and any scaled duration (r), along with not having any impressions, can be expressed using the domain of k={1, . . . , ∞} and tϵ={0, . . . , ∞} respectively, for each person, wherein, for example if U=5, persons 1-5 are assigned probabilities as follows: [p₀⁽¹⁾,p_{(i,r)}⁽¹⁾], [p₀⁽²⁾,p_{(i,r)}⁽²⁾], [p₀⁽³⁾,p_{(i,r)}⁽³⁾], [p₀⁽⁴⁾,p_{(i,r)}⁽⁴⁾], and [p₀⁽⁵⁾,p_{(i,r)}⁽⁵⁾]. The probability distribution generation circuitry 220 assigns p₀^{(j)} as the probability that the i^{th} person did not have any impression counts (e.g., point mass distribution), and assigns p_{(k,t)}⁽ⁱ⁾ as the probability density function that represents the probabilities that the i^{th} person has t impression counts with an k impression durations. Thus, the marginal probability of someone having k impressions, independent of duration of those views can be expressed in accordance with Equation 78 below:

Pr(k)=∫₀^{∞}P_{k,t}⁽ⁱ⁾dt Equation 78

The total probability for each individual can be further expressed in accordance with Equation 79 below, such that the combination of all probabilities associated with an individual is constrained to a total of 1:

$${p}_{0}^{( i )} + {\sum }_{k = 1}^{∞} {\int }_{0}^{∞} {p}_{k , t}^{( i )} dt = 1 \qquad Equation 79$$

In Equation 79, the individual either had zero page views and zero duration or any combination of views and durations. In examples in which no information on individual behavior is available, each individual within a given demographic is assigned the same probability distribution. For example, if 100 individuals have a total of 300 impression counts (e.g., page views), with a total duration of 600 minutes, each person has, on average, a total of 3 impression counts with a total duration of 6 minutes, with each impression count having an average duration of 2 minutes.

Given that the audience metrics estimation circuitry 140 has access to subscriber information (e.g., subscriber audience data 124, subscriber impression count data 126, and subscriber impression duration data 128), a person-specific distribution can be generated (e.g., by dividing the data amongst the individuals within a demographic) in accordance with Equations 80-84 below:

$$\begin{matrix}\begin{matrix}{maximize}_{P} & H = ( - {P}_{0} log ( {p}_{0} ) ) + {\sum }_{k = 1}^{∞} ( - {\int }_{0}^{∞} {p}_{k , t} log ( {p}_{k , t} ) dt )\end{matrix} & Equation 80 \\ \begin{matrix}subject to \text{:} & {p}_{0} + {\sum }_{k = 1}^{∞} {\int }_{0}^{∞} {p}_{k , t} dt = 1\end{matrix} & Equation 81 \\ {\sum }_{k = 1}^{∞} {\int }_{0}^{∞} {p}_{k , t} dt = {d}_{1} & Equation 82 \\ {\sum }_{k = 1}^{∞} k {\int }_{0}^{∞} {p}_{k , t} dt = {d}_{2} & Equation 83 \\ {\sum }_{k = 1}^{∞} k {\int }_{0}^{∞} {tp}_{k , t} dt = {d}_{3} & Equation 84\end{matrix}$$

The probability distribution generation circuitry 220 assigns person-specific distribution (H) of Equation 80, which provides an estimate of the distribution for any individual within the population, subject to the constraints of Equations 81-84. Equation 81 represents the constraint that the estimated probability distribution for a given individual totals to 1 (explained in connection with Equations 78-79 above). Equation 82 is a constraint governing the probability of an individual being in the audience (d₁). Equation 83 is a constraint governing the average impression count (d₂) for an individual. Equation 84 is a constraint governing the average impression duration (d₃) for an individual. The probability distribution generation circuitry 220 thereby assigns and initializes values for a person-specific probability distribution (H) for individuals within a demographic based on the presented constraints of Equations 81-84.

At block 504, the probability distribution generation circuitry 220 expresses the probability distribution as z-values. For example, the probability distribution generation circuitry 220 may express the probability distribution as z-values by re-arranging the solution to the person-specific distribution problem of Equations 80-84 (e.g., express in terms of z notation) in accordance with Equations 86-89, subject to the final solution for the set of {zⱼ} expressed in accordance with Equation 85:

$$\begin{matrix}{p}_{t} = \{ \begin{matrix}{z}_{0} & k = 0 and t = 0 \\ {z}_{0} {z}_{1} {z}_{2}^{i} {z}_{3}^{r} & k \geq 1 and t \geq 0\end{matrix} & Equation 85 \\ {ρ}_{0} + {\sum }_{k = 1}^{∞} {\int }_{0}^{∞} {p}_{k , t} dt = {z}_{0} + {\sum }_{k = 1}^{∞} {\int }_{0}^{∞} {z}_{0} {z}_{1} {z}_{2}^{k} {z}_{3}^{t} dt = {z}_{0} + \frac{- {z}_{0} {z}_{1} {z}_{2}}{( 1 - {z}_{2} ) log ( {z}_{3} )} = 1 & Equation 86 \\ {\sum }_{k = 1}^{∞} {\int }_{0}^{∞} {p}_{k , t} dt = {\sum }_{k = 1}^{∞} {\int }_{0}^{∞} {z}_{0} {z}_{1} {z}_{2}^{k} {z}_{3}^{t} dt = \frac{- {z}_{0} {z}_{1} {z}_{2}}{( 1 - {z}_{2} ) log ( {z}_{3} )} = {d}_{1} & Equation 87 \\ {\sum }_{k = 1}^{∞} k {\int }_{0}^{∞} {p}_{k , t} dt = {\sum }_{k = 1}^{∞} k {\int }_{0}^{∞} {z}_{0} {z}_{1} {z}_{2}^{k} {z}_{3}^{t} dt = \frac{- {z}_{0} {z}_{1} {z}_{2}}{{( 1 - {z}_{2} )}^{2} log ( {z}_{3} )} = {d}_{2} & Equation 88 \\ {\sum }_{i = 1}^{∞} {\int }_{0}^{∞} {tp}_{k , t} dt = {z}_{0} + {\sum }_{i = 1}^{∞} {\int }_{0}^{∞} {tz}_{0} {z}_{1} {z}_{2}^{k} {z}_{3}^{t} dt = \frac{+ {z}_{0} {z}_{1} {z}_{2}}{( 1 - {z}_{2} ) {( log ( {z}_{3} ) )}^{2}} = {d}_{3} & Equation 89\end{matrix}$$

The probability distribution generation circuitry 220 may solve for the variables z₀, z₁, z₂, and z₃, which may be called “distribution parameters” as each of the variables relates to the probability distribution. The probability distribution generation circuitry 220 may express z₂^{k} and z₃^{t} together as based on the logical definitions, it is impossible to have impressions without a duration and durations without an impression.

The solution of the distribution parameters {z₀, z₁, z₂, z₃} may be solved in closed form according to continuous Equations 90-93. (The continuous Equations 90-92 are equivalent to discrete Equations 13-15, but the continuous Equation 93 is different than the discrete Equation 16):

$$\begin{matrix}{z}_{0} = 1 - {d}_{1} & Equation 90 \\ {z}_{1} = \frac{{d}_{1}^{3}}{( 1 - {d}_{1} ) ( {d}_{2} - {d}_{1} ) ( {d}_{3} )} & Equation 91 \\ {z}_{2} = 1 - \frac{{d}_{1}}{{d}_{2}} & Equation 92 \\ {z}_{3} = {e}^{- \frac{{d}_{1}}{{d}_{3}}} & Equation 93\end{matrix}$$

Once a solution to the individual probability distribution estimate is available, an estimate of any probability can be calculated for each individual (e.g., audience member). For example, if among one hundred (100) individuals there is an audience of fifty (50) people and two hundred (200) impression counts (e.g., page views) with four hundred (400) time units of duration, z₀, z₁, z₂, and z₃) can be solved for as shown below in Example 3, based on Equations 90-93:

$$\begin{matrix}{d}_{0} = \frac{100}{100} {z}_{0} = 0.5 & Example 3 \\ {d}_{1} = \frac{50}{100} {z}_{1} = 0.041667 & \\ {d}_{2} = \frac{200}{100} {z}_{2} = 0.7500 & \\ {d}_{3} = \frac{400}{100} {z}_{3} = 0.882497 & \end{matrix}$$

In this example, the estimate of any probability can be calculated for each individual, such that if p₀=z₀=0.5, there is a 50% chance of the individual having no impression counts with no duration. To estimate the probability of the audience in this example having three 3 impression counts (e.g., i=3), the audience metrics estimation circuitry 140 can apply Equation 78 to generate an estimate, as shown below in Equation 94:

Pr(k=3)=∫₀^{∞}p_{3,t}dt≈0.0703125 Equation 94

The continuous duration time unit determination circuitry 212 can scale the durations because the durations are independent of the impressions k as shown in Equation 95:

$$\frac{{\int }_{0}^{∞} {tp}_{k , t} dt}{{\int }_{0}^{∞} {p}_{k , t} dt} = \frac{{d}_{3}}{{d}_{1}} = 8 \qquad Equation 95$$

Equation 95 equals a value of eight (8) which is four hundred (400) units of duration among fifty (50) individuals, which yields an average of eight (8) time units. The solution of Equation 95 is independent of the unknown number of impressions (e.g., pageviews) that an individual has, as the audience metrics estimation circuitry 140 is not provided information to the contrary with the aggregated data provided.

At block 506, the probability divergence determination circuitry 222 solves the Kullback-Leibler (KL) divergence by applying the Lagrangian. For example, the probability divergence determination circuitry 222 may solve the KL divergence by applying the Lagrangian to generated probability distributions. A probability divergence allows for a comparison between two probability distributions. In the examples disclosed herein, the probability divergence permits a comparison between the distribution of subscriber data and the distribution of census-level data. In the examples disclosed herein, a Kullback-Leibler probability divergence (KL divergence) is used to measure the difference between these two probability distributions (e.g., determine how well one probability distribution approximates another probability distribution). For example, the probability divergence determination circuitry 222 defines subscriber data as a prior distribution (Q) and census-level data as a posterior distribution (P). The audience size and impression durations are equally divided across the entire population of individuals in a k^{th} demographic {Uₖ}, such that U is representative of a population universe estimate. A universe estimate (e.g., a total audience) can be defined as, for example, the total number of persons that accessed the media in a particular geographic scope of interest and/or during a time of interest relating to media audience metrics. For example, the universe estimate can be based on census-level data obtained by the AME 130 during assessment of logged impressions by user devices 112. For example, the k^{th} demographic can represent a demographic category (e.g., females 35-40, males 35-40, etc.). The expected values of duration are consistent with Equations 96-99. (Continuous Equations 96-98 are the same as discrete Equations 17-19):

$$\begin{matrix}{d}_{0}^{Q} = 1 {d}_{0}^{P} = 1 & Equation 96 \\ {d}_{1}^{Q} = \frac{{A}_{k}}{{U}_{k}} {d}_{1}^{P} = \frac{{X}_{k}}{{U}_{k}} & Equation 97 \\ {d}_{2}^{Q} = \frac{{R}_{k}}{{U}_{k}} {d}_{2}^{P} = \frac{{T}_{k}}{{U}_{k}} & Equation 98 \\ {d}_{3}^{Q} = \frac{{D}_{k}}{{U}_{k}} {d}_{3}^{P} = \frac{{V}_{k}}{{U}_{k}} & Equation 99\end{matrix}$$

In Equations 96-99, the probability that a specific individual in the k^{th} demographic is a member of the aggregated subscriber audience total {Aₖ} is defined as {Aₖ/Uₖ}, the probability that a specific individual in the k^{th} demographic has impression counts in the aggregated subscriber impression count total {Rₖ} is defined as {Rₖ/Uₖ}, and the probability that a specific individual in the k^{th} demographic has an impression duration in the aggregated impression duration total is {Dₖ}. As used herein, {Dₖ} is the durations for the k^{th} demographic for the aggregated subscriber database, and {Vₖ} is the durations for the k^{th} demographic for the census-level database. The example probability divergence determination circuitry 222 uses theorems from Information Theory and the Maximum entropy solution to directly to answer the KL divergence of that individual from the database proprietor (subscriber) to census in accordance with Equation 100 (continuous Equation 100 is identical to discrete Equation 21):

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) \qquad Equation 100$$

where Pₖ is a posterior probability distribution defining census-level data and Qₖ is a prior probability distribution defining subscriber data) of an individual from subscriber data to census-level data. The example probability divergence determination circuitry 222 may express the KL divergence in terms of z notation, referring to the solutions to {z₀, z₁, z₂, and z₃} determined in Equations 96-99 as previously described, and reproduced below as Equations 101-104:

$$\begin{matrix}{z}_{0} = 1 - {d}_{1} & Equation 101 \\ {z}_{1} = \frac{{d}_{1}^{3}}{( 1 - {d}_{1} ) ( {d}_{2} - {d}_{1} ) ( {d}_{3} )} & Equation 102 \\ {z}_{2} = 1 - \frac{{d}_{1}}{{d}_{2}} & Equation 103 \\ {z}_{3} = {e}^{- \frac{{d}_{1}}{{d}_{3}}} & Equation 104\end{matrix}$$

In some examples, the example probability divergence determination circuitry 222 expands Equation 100 based on a principle of logarithms to yield a description of how any specific individual's distribution within the k^{th} demographic can change, in accordance with Equation 105 (continuous Equation 105 is identical to discrete Equation 26):

$$KL ( {P}_{k} \text{:} {Q}_{k} ) = {\sum }_{j = 0}^{m} {d}_{j}^{P} log ( \frac{{z}_{j}^{P}}{{z}_{j}^{Q}} ) = {\sum }_{j = 0}^{m} {d}_{j}^{P} [ log ( {z}_{j}^{P} ) - log ( {z}_{j}^{Q} ) ] = ( {d}_{0}^{P} ) [ log ( {z}_{0}^{P} ) - log ( {z}_{0}^{Q} ) ] … + ( {d}_{1}^{P} ) [ log ( {z}_{1}^{P} ) - log ( {z}_{1}^{Q} ) ] … + ( {d}_{2}^{P} ) [ log ( {z}_{2}^{P} ) - log ( {z}_{2}^{Q} ) ] … + ( {d}_{3}^{P} ) [ log ( {z}_{3}^{P} ) - log ( {z}_{3}^{Q} ) ] \qquad Equation 105$$

Given that all individuals in a k^{th} demographic are assumed to have the same behavior, the probability divergence determination circuitry 222 multiplies the KL(Pₖ:Qₖ) by the number of individuals in the k^{th} demographic {Uₖ} to determine how the individuals within a demographic can change collectively (e.g., since the divergences are the same, multiplication is used instead of adding the KL-divergence of each individually together). To determine the total divergence across the population, the probability divergence determination circuitry 222 sums across all divergences and across all demographics, in accordance with Equation 106 (continuous Equation 106 is equivalent to the discrete Equation 27)

(P:Q)=Σₖ₌₁^{K}Uₖ(KL(Pₖ:Qₖ)) Equation 106

Equation 106 above, once all the variables within the table (e.g., the example table 800 of FIG. 8) have been substituted, fully describes the behavior of audiences for an individual demographic k (e.g., subscriber audience size Aₖ, census-level audience size {Xₖ}), impression counts (e.g., pageviews, subscriber impression counts {Rₖ}, census-level impression counts {Tₖ}), and durations (e.g., subscriber durations Dₖ, census-level durations {Vₖ}) once minimized. The probability divergence determination circuitry 222 is to access the unknown individual demographic audience sizes {Xₖ} impression counts {Tₖ}, and duration differences from impressions {ΔTₖ}, however the audience metric parameters are subject to the aggregate constraints of at least one of ΣXₖ=X_{⋅}, Tₖ=T_{⋅}, or ΣΔTₖ=ΔT_{⋅}. The example probability divergence determination circuitry 222 then minimizes Equation 106 in accordance with Equation 107:

$$\begin{matrix}{minimize}_{\{ {X}_{k} \} , \{ {T}_{k} \} , \{ {V}_{k} \}} & K L ( P : Q ) = {\sum }_{k = 1}^{K} {U}_{k} ( K L ( {P}_{k} : {Q}_{k} ) ) \\ subject to & {\sum }_{k = 1}^{K} {X}_{k} = X . \\ & {\sum }_{k = 1}^{K} {T}_{k} = T . \\ & {\sum }_{k = 1}^{K} {V}_{k} = V .\end{matrix} \qquad Equation 107$$

In Equation 107, {Xₖ}, {Tₖ}, and {Vₖ} represent census-level data pertaining to unique audience size, impression counts, and impression duration, respectively, all of which are unknown. The example probability divergence determination circuitry 222 solves the system by applying (e.g., taking) the Lagrangian ( [symbol] ) in accordance with Equations 108-112, where the solution is for all (∀) demographics k={1, 2, . . . , K}, in addition to setting the partial derivative with respect to the Lagrange multipliers (λ₁, λ₂, and λ₃) equal to 0 (e.g., Equation 112):

$$\begin{matrix}ℒ = KL ( P : Q ) - {λ}_{1} ( {\sum }_{k = 1}^{K} {X}_{k} - X . ) - {λ}_{2} ( {\sum }_{k = 1}^{K} {T}_{k} - T . ) - {λ}_{3} ( {\sum }_{k = 1}^{K} {V}_{k} - V . ) & Equation 108 \\ \frac{\partial ℒ}{\partial {X}_{k}} = 0 ∀ k = \{ 1 , 2 , … , K \} & Equation 109 \\ \frac{\partial ℒ}{\partial {T}_{k}} = 0 ∀ k = \{ 1 , 2 , … , K \} & Equation 110 \\ \frac{\partial ℒ}{\partial {V}_{k}} = 0 ∀ k = \{ 1 , 2 , … , K \} & Equation 111 \\ \frac{\partial ℒ}{\partial {λ}_{1}} = 0 \frac{\partial ℒ}{\partial {λ}_{2}} = 0 \frac{\partial ℒ}{\partial {λ}_{3}} = 0 & Equation 112\end{matrix}$$

The probability divergence determination circuitry 222 solves the Lagrangian of Equation 108 using the Lagrange multipliers (λ₁, λ₂, and λ₃) to represent the census-level audience size constraint (λ₁), included within the reference census-level data for total audience sizes {X}, the census-level impression count constraint (λ2), included within the reference census-level data for total impression counts {T}, and the difference of census-level impression counts and durations constraint (λ₃), included within the reference census-level data impression durations {Dₖ}. Other than the constraints of total impression counts (λ₁), total impression counts (λ₂), and total census-level impression durations (λ₃) across demographics (k), each demographic is mutually exclusive and does not impact the other demographics. Therefore, besides that addition of the constraints noted above, the Lagrangian-based ( [symbol] ) derivative of census-level unique audience size {Xₖ}, impression counts {Tₖ}, and census-level impression durations {Dₖ} involve terms of the same demographic (e.g., females 35-40 years of age).

In some examples, in Equation 112, the example probability divergence determination circuitry 222 may set the maximum entropy parameters values to zero (e.g., λ₁=0, λ₂=0, λ₃=0) wherein the terms which contribute to the corresponding constraint disappear. An expression wherein the maximum entropy parameter value is set to zero is now unconstrained. The example probability divergence determination circuitry 222 may use the transformation c₁=e^{λ}^{₁} (e.g., c₁=exp(λ₁)), c₂=e^{λ}^{₂} (e.g., c₂=exp(λ₂)), and c₃=λ₃, which is equivalent to predefining the cross-demographic total census parameter values as c₁=1 or c₂=1, or c₃=0 if the corresponding aggregate constraint is not specified. The example census-level metrics calculation circuitry 228 may predefine the cross-demographic total census parameter values based on the data received by the example network interface 202. The cross-demographic total census parameter values that are not predefined are still solved by the example census-level metrics calculation circuitry 228 as shown in the example continuous logic table 870 of FIG. 8C.

At block 508, the example probability divergence determination circuitry 222 finds the continuous cross-demographic total census parameter values based on solution of the KL divergence. For example, the example probability divergence determination circuitry 222 may find the cross-demographic total census parameter values by solving the KL divergence simultaneously in accordance with Equations 113-115 below:

$$\begin{matrix}\frac{\partial ℒ}{\partial {X}_{k}} = log ( \frac{{X}_{k}^{3}}{( {T}_{k} - {X}_{k} ) ( {U}_{k} - {X}_{k} ) ( {V}_{k} )} ) - log ( \frac{{A}_{k}^{3}}{( {R}_{k} - {A}_{k} ) ( {U}_{k} - {A}_{k} ) ( {D}_{k} )} ) - {λ}_{1} & Equation 113 \\ \frac{\partial ℒ}{\partial {T}_{k}} = log ( 1 - \frac{{X}_{k}}{{T}_{k}} ) - log ( 1 - \frac{{A}_{k}}{{R}_{k}} ) - {λ}_{2} & Equation 114 \\ \frac{\partial ℒ}{\partial Δ {T}_{k}} = log ( {e}^{- \frac{{X}_{k}}{{V}_{k}}} ) - log ( {e}^{- \frac{{A}_{k}}{{D}_{k}}} ) - {λ}_{3} & Equation 115\end{matrix}$$

In Equation 113-115 above, the census-level unique audience size {Xₖ} for an individual demographic k, impression counts {Tₖ} for an individual demographic k, and census-level impression durations {Dₖ} for an individual demographic k appear within each equation, so each Equation 113-115 is to be solved simultaneously when equaled to zero. The example probability divergence determination circuitry 222 substitutes c₁=e^{λ}^{₁} (e.g., c₁=exp(λ₁)), c₂=e^{λ}^{₂} (e.g., c₂=exp(λ₂)), and c₃=λ₃), wherein the cross-demographic total census parameter values (e.g., intermediate solution values, c-values, the cross-demographic constraint finder values, etc.) are used to find the frequency of impressions and the odds of an individual being in a demographic audience in proportion to the universal audience.

In some examples, the example probability divergence determination circuitry 222 simplifies Equation 115 as illustrated as Equation 116:

$$\frac{\partial ℒ}{\partial {X}_{k}} = ( - \frac{{X}_{k}}{{V}_{k}} ) - ( - \frac{{A}_{k}}{{D}_{k}} ) - {λ}_{3} \qquad Equation 116$$

The example probability divergence determination circuitry 222 defines new continuous Equations 117-119, which will be used with the cross-demographic total census parameter values to determine the frequency of impressions and the odds of an individual being in a demographic audience in proportion to the universal audience. Equations 117-119 are listed below:

$$\begin{matrix}{s}_{k}^{( 1 )} = \frac{{A}_{k}^{3}}{( {R}_{k} - {A}_{k} ) ( {U}_{k} - {A}_{k} ) ( {D}_{k} )} ≡ {z}_{1}^{Q} & ( for demo k ) & Equation 117 \\ {s}_{k}^{( 2 )} = 1 - \frac{{A}_{k}}{{R}_{k}} ≡ {z}_{2}^{Q} & ( for demo k ) & Equation 118 \\ {s}_{k}^{( 3 )} = {e}^{- \frac{{A}_{k}}{{D}_{k}}} ≡ {z}_{3}^{Q} & ( for demo k ) & Equation 119\end{matrix}$$

The s-variables sₖ⁽¹⁾, sₖ⁽²⁾, and sₖ⁽³⁾ in Equations 117-119 are identical to the previously solved prior variables. Therefore, the solution for the demographic k census-level unique audience size {Xₖ}, impression counts {Tₖ}, and therefore the census-level impressions {Vₖ} is based on cross-demographic total census parameter values, Equations 117-119 above, and the following Equations 126-131.

In some examples, the census-level metrics calculation circuitry 228 may solve Equation 113 above for a single demographic. The example census-level metrics calculation circuitry 228 may uses Equation 120 as shown below:

$$\frac{{A}^{3}}{( R - A ) ( U - A ) ( D )} = \frac{{X}^{3}}{( T - X ) ( U - X ) ( V )} \qquad Equation 120$$

The example census-level metrics calculation circuitry 228 derives Equation 120 based on Equations 121-123, which is reproduced for convenience:

$$\begin{matrix}\frac{\partial ℒ}{\partial {X}_{k}} = log ( \frac{{X}_{k}^{3}}{( {T}_{k} - {X}_{k} ) ( {U}_{k} - {X}_{k} ) ( {V}_{k} )} ) - log ( \frac{{A}_{k}^{3}}{( {R}_{k} - {A}_{k} ) ( {U}_{k} - {A}_{k} ) ( {D}_{k} )} ) - {λ}_{1} & Equation 121 \\ \frac{\partial ℒ}{\partial {T}_{k}} = log ( 1 - \frac{{X}_{k}}{{T}_{k}} ) - log ( 1 - \frac{{A}_{k}}{{R}_{k}} ) - {λ}_{2} & Equation 122 \\ \frac{\partial ℒ}{\partial Δ {T}_{k}} = log ( {e}^{- \frac{{X}_{k}}{{V}_{k}}} ) - log ( {e}^{- \frac{{A}_{k}}{{D}_{k}}} ) - {λ}_{3} & Equation 123\end{matrix}$$

For the single-demographic version, the census-level metrics calculation circuitry 228 removes the subscript k to compute a single demographic as shown in Equation 124:

$$\frac{\partial ℒ}{\partial X} = log ( \frac{{X}^{3}}{( T - X ) ( U - X ) ( V )} ) - log ( \frac{{A}^{3}}{( R - A ) ( U - A ) ( D )} ) \qquad Equation 124$$

Wherein in Equation 124, after setting the partial derivative with respect to the audience size {Xₖ} to zero and re-arranging generates Equation 125:

$$log ( \frac{{X}^{3}}{( T - X ) ( U - X ) ( V )} ) = log ( \frac{{A}^{3}}{( R - A ) ( U - A ) ( D )} ) \qquad Equation 125$$

Wherein Equation 125 is identical to Equation 120 after the exponent is taken (e.g., the logarithm is removed).

At block 510, the probability divergence determination circuitry 222 then solves for the odds and frequency. For example, the probability divergence determination circuitry 222 may solve for the odds and frequency by using the Equations 117-119 and the cross-demographic total census parameter values as described in Equations 126-131 shown below:

$$\begin{matrix}{f}_{k}^{( T )} = {( 1 - {c}_{2} {s}_{k}^{( 2 )} )}^{- 1} = {( 1 - {c}_{2} ( 1 - \frac{{A}_{k}}{{R}_{k}} ) )}^{- 1} & Equation 126 \\ {f}_{k}^{( V )} = - {( {c}_{3} + log ( {s}_{k}^{3} ) )}^{- 1} = {( \frac{{A}_{k}}{{D}_{k}} - {c}_{3} )}^{- 1} & Equation 127 \\ {o}_{k} = ( {c}_{1} {s}_{k}^{( 1 )} ) ( {f}_{k}^{( T )} - 1 ) {f}_{k}^{( V )} & Equation 128 \\ {X}_{k} = {U}_{k} ( \frac{{o}_{k}}{1 + {0}_{k}} ) & Equation 129 \\ {T}_{k} = {f}_{k}^{( T )} {X}_{k} & Equation 130 \\ {V}_{k} = {f}_{k}^{( V )} {X}_{k} & Equation 131\end{matrix}$$

As shown above, in Equations 126-131, the example probability divergence determination circuitry 222 determines the frequency and odds for the census-level k^{th} demographic. In the above Equations 126-131, {fₖ^{(T)}} is the estimated frequency of impressions and {fₖ^{(V)}} is the estimated frequency of durations. The example probability divergence determination circuitry 222 uses {oₖ} which is the odds of the demographic audience {Xₖ} in proportion to the demographic Universe Estimate {Uₖ} to solve for the audience size estimate for each demographic {Xₖ}. The example probability divergence determination circuitry 222 determines census-level impressions count {Tₖ} and census-level impression duration {Vₖ} directly from {fₖ^{(T)}} and {fₖ^{(V)}} with the estimated audience size estimate for each demographic {Xₖ}.

At block 512, the example search space identification circuitry 226 determines the continuous search space for the cross-demographic total census parameter values based on the inequalities in accordance with Equations 132-134:

$$\begin{matrix}0 \leq {c}_{1} < ∞ & Equation 132 \\ 0 \leq {c}_{2} \leq min ( \frac{{R}_{k}}{{R}_{k} - {A}_{k}} ) & Equation 133 \\ - ∞ \leq {c}_{3} \leq min ( \frac{{A}_{k}}{{D}_{k}} ) & Equation 134\end{matrix}$$

Wherein, in Equations 132-134 the lower bound (minimum value) is zero. In Equation 132, the upper bound (maximum value) is positive infinity. In some examples, the upper bound may be reduced, which reduces the search space, and improves the functioning of a computer as it reduces wasted resources. In Equation 133, the upper bound is the minimization of Impressions per demographic {Rₖ} divided by the difference of the unique audience size per demographic {Aₖ} from the impressions per demographic {Rₖ}. In Equation 134, the upper bound is the minimization of the unique subscriber audience size per demographic {Aₖ} and the census-level impression durations {Dₖ}.

In some examples, the search space identification circuitry 226 is to define the search space by reducing the inequality bounds for the continuous case. The bounds for {c₁, c₂, c₃} are valid for the logical constraints but are the loosest bounds available when no information on the census-level constraints is received by the network interface 202. If the example network interface 202 receives certain census-level constraints which yield a particular unique solution, the bounds for the valid {c₁, c₂, c₃} are tightened by the example search space identification circuitry 226. Tightening the bounds improves the efficiency of a computer as the example iteration circuitry 230 wastes less resources searching for valid but incorrect solutions.

Receiving constraints on the total census-level impressions {T_{⋅}} and the total census-level impression duration {V_{⋅}} does not reduce the bounds for the second and third cross-demographic total census parameter values {c₂, c₃} from Equations 132-134. However, additional knowledge of the total census-level audience {X_{⋅}} reduces all three bounds for {c₁, c₂, c₃}. The example search space identification circuitry 226 generates Equation 135 which is a statement on sequences:

$$\begin{matrix}min \\ i\end{matrix} ( \frac{{a}_{i}}{{b}_{i}} ) \leq \frac{{Σ}_{i = 1}^{n} {a}_{i}}{{Σ}_{i = 1}^{n} {b}_{i}} \leq \begin{matrix}max \\ i\end{matrix} ( \frac{{a}_{i}}{{b}_{i}} ) \qquad Equation 135$$

Example Equation 135 includes a first sequence of positive numbers {a₁, . . . , aₙ} and a second sequence of positive numbers {b₁, . . . , bₙ}. The example search space identification circuitry 226 applies Equation 135 to the sequence {Tₖ, Xₖ} and sums across demographics k to generate Equation 136:

$$\begin{matrix}min \\ k\end{matrix} ( \frac{{T}_{k}}{{X}_{k}} ) \leq \frac{{T}_{•}}{{X}_{•}} \leq \begin{matrix}max \\ k\end{matrix} ( \frac{{T}_{k}}{{X}_{k}} ) \qquad Equation 136$$

Example Equation 136 is one of six different inequalities which hold true. The census-level totals are known (e.g., {X_{⋅}}, {T_{⋅}}, and {V_{⋅}}) along with the universal estimate {U_{⋅}}. The search space identification circuitry 226 selects two of the four totals (e.g., {X_{⋅}}, {T_{⋅}}, {V_{⋅}}, and {U_{⋅}}) to use in the application of Equation 135. The order does not matter within the two totals chosen out of the four totals, which yields six possible combinations. Another combination the example search space identification circuitry 226 is to select is listed in Equation 137:

$$\begin{matrix}min \\ k\end{matrix} ( \frac{{X}_{k}}{{U}_{k}} ) \leq \frac{{X}_{•}}{{U}_{•}} \leq \begin{matrix}max \\ k\end{matrix} ( \frac{{X}_{k}}{{U}_{k}} ) \qquad Equation 137$$

The example search space identification circuitry 226 is to reduce the Equations 117-119 and 132-134 as listed below in Equations 138-146:

$$\begin{matrix}{s}^{( 1 )} = ∞ & Equation 138 \\ {s}^{( 2 )} = min ( \frac{{R}_{k}}{{R}_{k} - {A}_{k}} ) & Equation 139 \\ {s}^{( 3 )} = min ( \frac{{A}_{k}}{{D}_{k}} ) & Equation 140 \\ {t}_{k}^{( 2 )} = ( 1 - \frac{{X}_{•}}{{T}_{•}} ) {( 1 - \frac{{A}_{k}}{{R}_{k}} )}^{- 1} & Equation 141 \\ {t}_{k}^{( 3 )} = ( \frac{{A}_{k}}{{D}_{k}} ) - ( \frac{{X}_{•}}{{V}_{•}} ) & Equation 142 \\ {c}_{2}^{( min )} = max \{ 0 , \begin{matrix}min \\ k\end{matrix} ( {t}_{k}^{( 2 )} ) \} & Equation 143 \\ {c}_{2}^{( max )} = min \{ {s}^{( 2 )} , \begin{matrix}max \\ k\end{matrix} ( {t}_{k}^{( 2 )} ) \} & Equation 144 \\ {c}_{3}^{( min )} = max \{ - ∞ , \begin{matrix}min \\ k\end{matrix} ( {t}_{k}^{( 3 )} ) \} & Equation 145 \\ {c}_{3}^{( min )} = min \{ {s}^{( 3 )} , \begin{matrix}max \\ k\end{matrix} ( {t}_{k}^{( 3 )} ) \} & Equation 146\end{matrix}$$

In example Equation 138-146, s is the census-level parameter, which is similar to the z for the subscriber parameter. In Equations 141-142, t is a simplification parameter which is used in Equations 143-146. In Equations 143-144, there is a new minimum and a new maximum for the second cross-demographic total census parameter value. In Equations 145-146, there are a new minimum and a new maximum for the third cross-demographic total census parameter value. The value for the minimum of the first cross-demographic total census parameter value is still zero. The value for the maximum of the first cross-demographic total census parameter value is reduced from the unbounded value of positive infinity (∞) as depicted in Equation 138 to the finite value as shown in Equation 147:

$${c}_{1}^{( max )} = \begin{matrix}max \\ k\end{matrix} ( \frac{( {A}_{k} + {c}_{3}^{( min )} {D}_{k} ) ( {R}_{k} - ( {R}_{k} - {A}_{k} ) {c}_{2}^{( min )} ) ( {U}_{k} - {A}_{k} ) {X}_{•}}{{A}_{k}^{3} {c}_{2}^{( min )} ( {U}_{•} - {X}_{•} )} ) \qquad Equation 147$$

The example search space identification circuitry 226 in response to the above Equations 143-146 is to bound the valid solution from the Equations 59-61 to the below Equations 148-150:

c₁^{(min)≤c}₁≤c₁^{(max)} Equation 148

c₂^{(min)}≤c₂≤c₂^{(max)} Equation 149

c₃^{(min)}≤c₃≤c₃^{(max)} Equation 150

Example Equations 148-150 result in a smaller search space for the example iteration circuitry 230 to iterate through.

In some examples, the example search space identification circuitry 226 uses Equations 151 and Equations 152 for determining the bounds for the second and third cross-demographic total census parameter values:

$$\begin{matrix}0 \leq {c}_{2} \leq ( \frac{{f}^{*}}{{f}^{*} - 1} ) & Equation 151 \\ - ∞ \leq {c}_{3} \leq min ( \frac{1}{{m}^{*}} ) & Equation 152\end{matrix}$$

Wherein f* is the highest frequency of impressions (e.g., pageviews) per audience among the subscriber (e.g., panel) and m* is the highest frequency of impression durations.

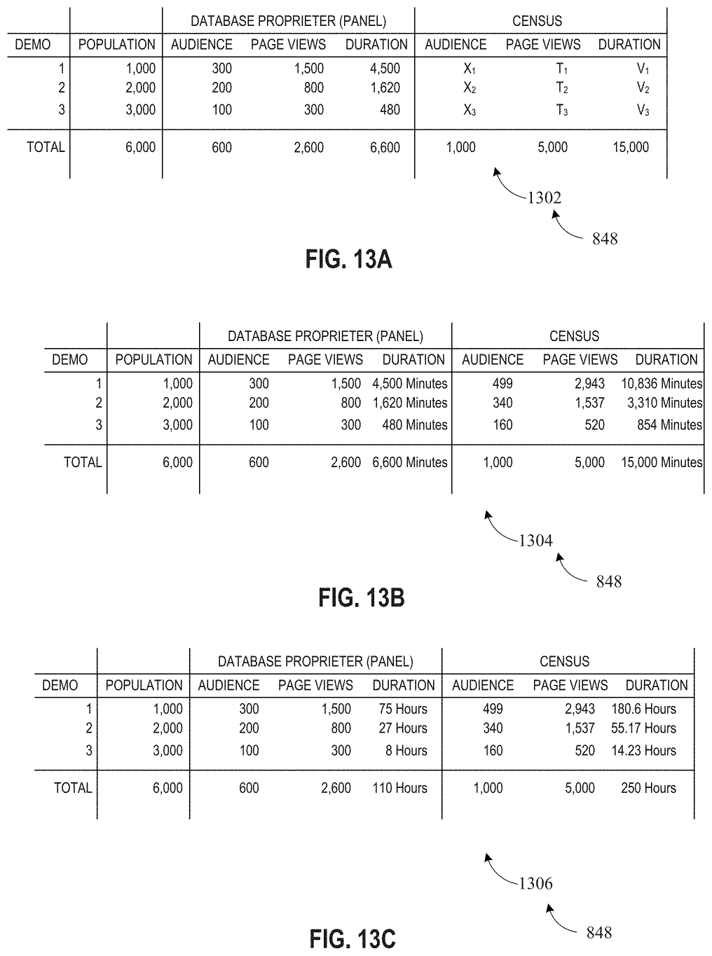

At block 514 the continuous duration time unit determination circuitry 212 scales the continuous duration values. For example, the continuous duration time unit determination circuitry 212 may scale the continuous duration values by selecting a duration time unit (e.g., seconds, minutes, hours, days, etc.). The operation of block 514 may occur before the operation of block 502. In some examples, the network interface 202 may access the continuous duration values (from the subscriber database 122) in a first time unit (e.g., minutes) and access the continuous duration values (from the census-level database 132) in a second time unit (e.g., seconds). The example continuous duration time unit determination circuitry 212 may select a consistent time unit for the subscriber duration values. The calculations performed by the audience metrics estimation circuitry 140 use different Equations depending on if the durations are continuous or if the durations are discrete. If the discrete durations are scaled with the continuous duration time unit determination circuitry 212 before the calculations, the estimate of the audience size and the impression count will be inaccurate. As described in conjunction with FIGS. 13B and 13C, the continuous duration time unit determination circuitry 212 scales the duration values.

At block 516, the example iteration circuitry 230 iterates between the cross-demographic total census parameter values. For example, the example iteration circuitry 230 may iterate between the cross-demographic total census parameter values by selecting a first value. For each iteration, the example census-level metrics calculation circuitry 228 determines the census-level metrics. For example, the example census-level metrics calculation circuitry 228 may notice that as the second cross-demographic total census parameter value (e.g., c₂) and the third cross-demographic total census parameter value (e.g., c₃) increase, the estimate of the census-level unique audience size {Xₖ} for an individual demographic k also increases. Eventually, as the iterations continue, the estimate of the census-level unique audience size {Xₖ} for an individual demographic k reaches a maximum limit which is the universal audience size {Uₖ}. The second and third cross-demographic total census parameter value is to be below the upper limit (e.g., the minimization as described in Equations 133-134 across all demographics). Control returns to block 312.

FIG. 6 is a flowchart representative of example machine readable instructions and/or example operations 600 that may be executed and/or instantiated by processor circuitry to determine continuous cross-demographic total census parameter values. The machine readable instructions and/or operations 600 of FIG. 6 begin at block 602, at which the discrete duration difference circuitry 216 is to scale at least one of subscriber duration values or total census-level duration values to generate a scaled duration value that corresponds to an impression count of at least a threshold amount of duration time. For example, the example discrete duration difference circuitry 216 may scale at least one of the subscriber duration values or total census-level duration values to generate a scaled duration value that corresponds to an impression count of at least threshold amount of duration time by scaling at least one of the subscriber duration values or total duration values to be at least one second in duration.

At block 604, the cross-demographic total census parameter value determination circuitry 224 is to determine cross-demographic total census parameter values based on the scaled duration value. For example, the cross-demographic total census parameter value determination circuitry 224 may determine the cross-demographic total census parameter values based on the scaled duration value by using the solution of the KL divergence.

At block 606, the search space identification circuitry 226 to determine a search space of possible cross-demographic total census parameter values, the search space to include the determined cross-demographic total census parameter values. For example, the search space identification circuitry 226 may determine a search space of possible cross-demographic total census parameter values, the search space to include the determined cross-demographic total census parameter values by selecting a first threshold solution value and a second threshold solution value.

At block 608, the census-level metrics calculation circuitry 228 to determine census-level metrics based on the determined cross-demographic total census parameter values, the census-level metrics including demographic census-level audience size data and demographic census duration values. For example, the census-level metrics calculation circuitry 228 may determine census-level metrics based on the determined cross-demographic total census parameter values, the census-level metrics including demographic census-level audience size data and demographic census duration values by determining the using demographic results match the constraints. The aggregated total census constraints include a first constraint (e.g., the unique total audience size is to match the sum of the unique audience size for each demographic), a second constraint (e.g., the total impressions are to match the sum of the impressions for each demographic), and a third constraint (e.g., the total duration of such impressions is to match the sum of the impression duration for each demographic).

At block 610, report circuitry 232 to output a report of the census-level metrics. For example, the report circuitry 232 may output a report of the census-level metrics by generating an audience metrics table. The example instructions 600 end.

FIG. 7 is an example table 700 used to express subscriber (panel, database proprietor, etc.) data and census-level data. The example table 700 includes four columns: a first column 702, a second column 704, a third column 706, and a fourth column 708. The example first column 702 represents the plurality of demographics k (e.g., for example, demographic 1 refers to females aged 35-40, demographic 2 refers to males aged 35-40, etc.). The example second column 704 represents the population (e.g., universe audience U for each demographic {Uₖ}. The example third column 807 represents subscriber data, including subscriber data for audience size {Aₖ}, impression count {Rₖ}, and impression duration {Dₖ}. The example fourth column 708 represents census-level data, including census-level unique audience {Xₖ}, census-level impression count {Tₖ}, and census-level impression duration {Vₖ}. The bottom row of table 700 includes a total Universe estimate {U_{⋅}}, a total subscriber audience size {A_{⋅}}, a total subscriber impressions count {R_{⋅}}, a total subscriber duration {D_{⋅}}, a total census-level audience size {X_{⋅}}, a total census-level impressions count {T_{⋅}}, and a total census-level duration {V_{⋅}}. After the audience metrics estimation circuitry 140 estimates the audience metrics, the example table 700 may be sent to an example customer 160.

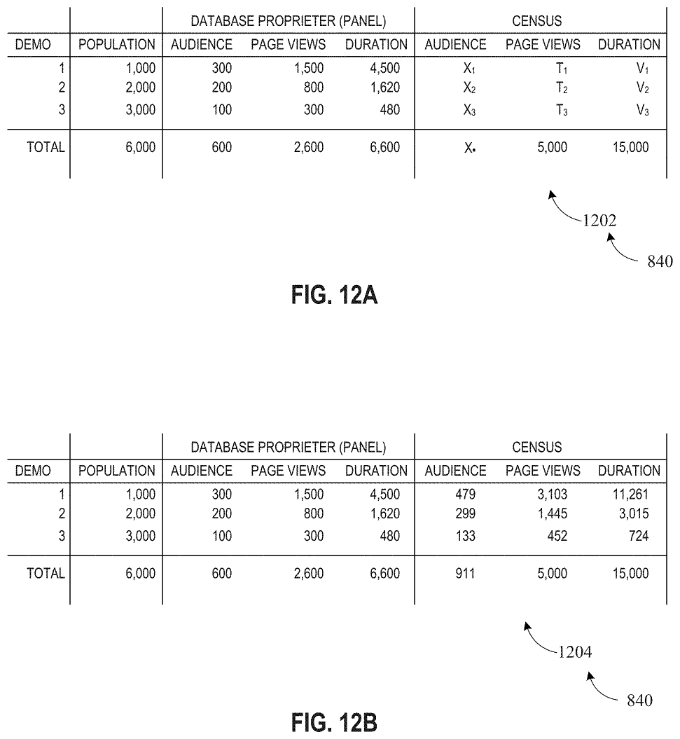

FIG. 8A is an example logic table 850 which illustrates the enumerated list for the eight scenarios based on the audience metrics accessed by the example network interface 202. For example, the first scenario 802 (e.g., first case 902) is defined when the total census-level audience size {X_{⋅}}, the total census-level impressions count {T_{⋅}}, and the total census-level duration {V_{⋅}} are not known. For example, the second scenario 804 is defined when the total census-level audience size {X_{⋅}} and the total census-level impressions count {T_{⋅}} are not known, but the total census-level duration {V_{⋅}} is known. For example, the example network interface 202 may access the total census-level duration {V_{⋅}} but be unable to access the total census-level audience size {X_{⋅}} and the total census-level impressions count {T_{⋅}}. For example, the third scenario 806 is defined when the total census-level audience size {X_{⋅}} and the total census-level duration {V_{⋅}} are not known, but the total census-level impressions count {T_{⋅}} is known. For example, the fourth scenario 808 is defined when the total census-level audience size {X_{⋅}} is not known, but the total census-level impressions count {T_{⋅}} and the total census-level duration {V_{⋅}} are known. The fourth scenario 808 is explored for the discrete case (e.g., the fourth discrete scenario 824 of FIG. 98) as an extended example of the processes taken by the audience metrics estimation circuitry 140 in FIGS. 10A-B. The fourth scenario 808 is also explored for the continuous case (e.g., the fourth continuous scenario 840 of FIG. 8C) as an extended example of the processes taken by the audience metrics estimation circuitry 140 in FIGS. 12A-B.

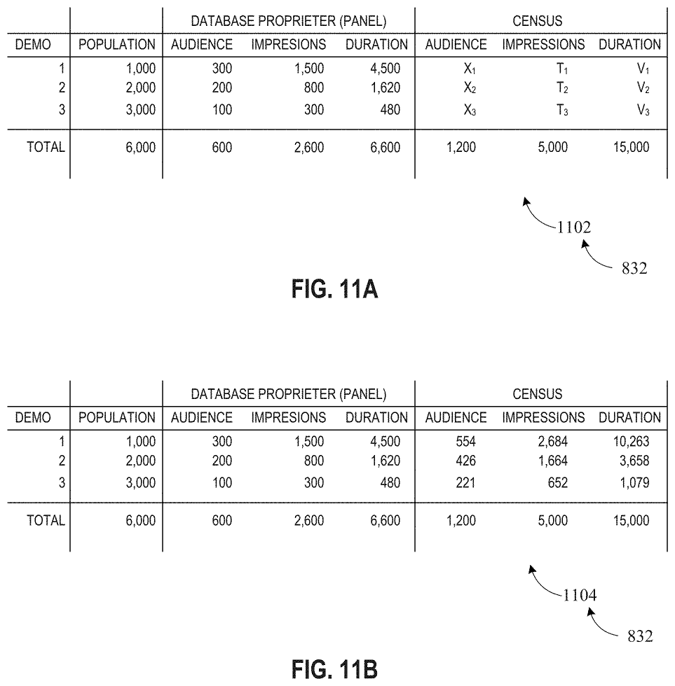

For example, the fifth scenario 810 is defined when the total census-level audience size {X_{⋅}} is known, but the total census-level impressions count {T_{⋅}} and the total census-level duration {V_{⋅}} are not known. For example, the sixth scenario 812 is defined when the total census-level audience size {X_{⋅}} and the total census-level duration {V_{⋅}} are known, but the total census-level impressions count {T_{⋅}} is not known. For example, the seventh scenario 814 is defined when the total census-level audience size {X_{⋅}} and the total census-level impressions count {T_{⋅}} are known, but the total census-level duration {V_{⋅}} is not known. For example, the eighth scenario 816 is defined when the total census-level audience size {X_{⋅}}, the total census-level impressions count {T_{⋅}}, and the total census-level duration {V_{⋅}} are known. The eight scenario 816 is explored for the discrete case (e.g., the eighth discrete scenario 832 of FIG. 8B) as an extended example of the processes taken by the audience metrics estimation circuitry 140 in FIGS. 11A-B. The eighth scenario 816 is also explored for the continuous case (e.g., the eighth continuous scenario 848 of FIG. 8C) as an extended example of the processes taken by the audience metrics estimation circuitry 140 in FIG. 13ABC.

FIG. 8B illustrates the preset values of the discrete cross-demographic total census parameter values in the example discrete logic table 860. The third column of the example discrete logic table 860 includes the difference between impression counts and durations {ΔT_{⋅}} instead of the total census-level durations {V_{⋅}}. The example discrete logic table 860 includes scenarios 818, 820, 822, 824, 826, 828, 830, and 832. If the example network interface 202 does not receive data (e.g., information, constraints, values) for total census-level unique audience size {X_{⋅}}, the total census-level impression counts {T_{⋅}}, and the difference between total impression counts and total durations {ΔT_{⋅}}, the discrete cross-demographic total census parameter values are not constrained. For example, the census-level unique audience size {X} is related to the first maximum entropy parameter value λ₁ wherein setting λ₁=0 based on the example network interface 202 not receiving census-level unique audience size {X_{⋅}} data is equivalent to predefining c₁=1. Setting λ₁=0 is equivalent to setting c₁=1 based on the transformation c₁=exp(λ₁) or c₁=e^{λ1}. Similarly, setting λ₂=0 based on the network interface 202 not receiving the total impression counts {T_{⋅}} data is equivalent to predefining c₂=1. Similarly, setting λ₃=0 based on the network interface 202 not receiving total the difference between impression counts and durations {ΔT_{⋅}} data is equivalent to predefining c₃=1.

FIG. 8C illustrates the preset values of the continuous cross-demographic total census parameter values in the example continuous logic table 870. The example continuous logic table 870 includes scenarios 834, 836, 838, 840, 842, 844, 846, and 848. If the example network interface 202 does not receive data (e.g., information, constraints, values) for total census-level unique audience size {X_{⋅}}, the total census-level impression counts {T_{⋅}}, and the total census-level impression durations {V_{⋅}}, the continuous cross-demographic total census parameter values are not constrained. For example, the census-level unique audience size {X} is related to the first maximum entropy parameter value λ₁ wherein setting λ₁=0 based on the example network interface 202 not receiving total census-level unique audience size {X_{⋅}} data is equivalent to predefining c₁=1. Setting λ₁=0 is equivalent to setting c₁=1 based on the transformation c₁=exp(λ₁) or c₁=e^{λ1}. Similarly, setting λ₂=0 based on the network interface 202 not receiving impression counts {T_{⋅}} data is equivalent to predefining c₂=1. Setting λ₃=0 based on the network interface 202 not receiving impression durations {V_{⋅}} data is equivalent to predefining c₃=0, based on the transformation c₃=λ₃.

FIG. 9 represents the triangular inequality and the rectangular grid used by the audience metrics estimation circuitry 140 to generate scaled durations used in the calculations to estimate census-level audience metrics. As used herein, “discrete duration” has at least a minimum time unit (e.g., one second). In order for a duration to be counted, the duration must have at least one impression, which results in the inequality d≥i. The inequality d≥i generates the triangular array 902 of valid {i, d} combinations as illustrated in FIG. 9. A scaled discrete duration r is equal to the subtraction of impressions i from the discrete durations d (e.g., r=d−i, where r>0). The probability distribution is now p_{(i,r)} defined on the rectangular grid 904 of FIG. 9, wherein i={1, . . . , ∞} and r={0, . . . , ∞}. The difference between the triangular array 902 and rectangular grid 904 is the initial starting points. For example, an individual with i=5 and r=2 would have 5 impressions i and 7 time units of duration d (e.g., 5+2=7).

FIG. 10A illustrates an example table 1002 which includes the audience metrics data matching the example fourth discrete scenario 824 of FIG. 8B. The example table 1002 is the example table 700 of FIG. 7 with example set of data available from subscriber data of FIG. 1 (audience size values 124, subscriber impression count data 126, and subscriber duration data 128) and an example set of data available for census-level total impressions 136 and total impression durations 138 of FIG. 1.

In the example of FIG. 10A, there is a total of three different demographics (k) that are considered. The population (e.g., universal audience Uₖ) for each demographic (e.g., k=1-3) ranges from a total of 1,000 individuals to a total of 3,000 individuals for demographics 1-3, respectively. The subscriber data includes audience values, impression values, and discrete duration values for each demographic, as well as values for total audience size, total impression counts, and total impression durations. The census-level data includes only total impression counts (e.g., 5,000) and total impression durations (e.g., 15,000), whereas demographic-specific census-level unique audience size, census-level impression counts, and census-level impression duration, as well as the total census-level audience size {X_{⋅}}, are all variables to be solved for using the methods described throughout this application and applied in the examples below. Knowing the total census-level impressions count {T_{⋅}}, and total census-level duration {V_{⋅}} constrains the second and third cross-demographic total census parameter values. The total census-level audience size {X_{⋅}} is unknown (e.g., unconstrained), wherein the first cross-demographic total census parameter value is set to a value of one (1). The example search space identification circuitry 226 generates the example search space according to the inequality bounds in accordance with Equations 153-154 listed below:

0≤c₂≤1.25 Equation 153

0≤c₃≤1.10 Equation 154

For each value of the second cross-demographic total census parameter value in between the range zero (0) and one point twenty-five (1.25), the example iteration circuitry 230 iterates the cross-demographic total census parameter value, and the example census-level metrics calculation circuitry 228 determines the estimated census-level audience data, impressions, and durations (e.g., according to discrete Equations 50-58 above). The census-level metrics calculation circuitry 228 determines values wherein the total impressions and total duration constraints (e.g., ΣXₖ=X_{⋅}, Tₖ=T_{⋅}, or ΣΔTₖ=ΔT_{⋅}). In the example of FIGS. 10A-B, the example iteration circuitry 230 landed on {c₂*,c₃*}={1.057027, 1.03865}, which is evaluated (e.g., verified, checked) by the example census-level metrics calculation circuitry 228. The sample second and third cross-demographic total census parameter values (e.g., c₂=1.057027 and c₃=1.03865) are input in the below Equation 155-162 (which are based on Equations 50-58, but have values based on the specific cross-demographic total census parameter values substituted in), and have the demographic index k removed for clarity:

W^{(T)}={231.193,165.596,88.5321} Equation 155

W^{(ΔT)}={184.065,168.311,93.0439} Equation156

∫^{(T)}={6.48809,4.83102,3.3886} Equation 157

∫^{(ΔT)}={16.9285,5.06021,2.00933} Equation 158

o={1.04343,5.93105,22.5929} Equation 159

X={489.373,288.557,127.157} Equation 160

T={3175.09,1394.02,430.883} Equation 161

V={11459.4,2854.18,686.384} Equation 162

Wherein in Equations 155-162, the example second and third cross-demographic total census parameter values (e.g., c₂=1.057027 and c₃=1.03865) match the first constraint wherein all impressions of each demographic (T₁ for the first demographic, T₂ for the second demographic and T₃ for the third demographic in this illustrated example) add up to the total census-level impressions count {T_{⋅}}. Similarly, the example second and third cross-demographic total census parameter values (e.g., c₂=1.057027 and c₃=1.03865) match the first constraint wherein all impression duration of each demographic (V₁ for the first demographic, V₂ for the second demographic and V₃ for the third demographic in this illustrated example) add up to the total impression duration {V_{⋅}}.

FIG. 10B is the solved audience metrics table 1004. As seen in FIG. 10B, there is a total of nine hundred and five (905) audience members in at the census-level database, while there is a total of six hundred (600) audience members in the subscriber database (e.g., database proprietor database, panel database, etc.). The audience size for the first demographic is four hundred and eighty nine (489) audience members, the audience size for the second demographic is two hundred and eight nine (289) audience members and the audience size for the third demographic is one hundred and twenty seven (127) audience members. The sum of the audience sizes of the three demographics is equal to the total census-level audience size of nine hundred and five (905) audience members (e.g., 489+289+127=905; ΣXₖ=X_{⋅}). Similarly, the impressions constraint and the duration constraint match, which verify the solution represented in the solved audience metrics table 1004.

FIG. 11A illustrates an example table 1102 which includes the audience metrics data matching the example eighth discrete scenario 832 of FIG. 8B. The example table 1102 is the example table 700 of FIG. 7 with example set of data available from subscriber data of FIG. 1 (subscriber audience size values 124, subscriber impression count data 126, and subscriber duration data 128) and an example set of data available for census-level total audience size 134, census-level total impressions 136 and total census-level impression durations 138 of FIG. 1.

In the example of FIG. 11A, three different demographics (k) are considered (e.g., a total of three). The population (e.g., universal audience Uₖ) for each demographic (e.g., k=1-3) ranges from a total of 1,000 individuals to a total of 3,000 individuals for demographics 1-3, respectively. The subscriber data includes audience values, impression values, and discrete duration values for each demographic, as well as values for total audience size, total impression counts, and total impression durations. The census-level data includes total census-level audience size {X_{⋅}} (e.g., 1,200), total census-level impressions count {T_{⋅}} (e.g., 5,000) and total census-level duration {V_{⋅}} (e.g., 15,000), whereas the demographic-specific census-level unique audience size, census-level impression counts, and census-level impression duration are variables to be solved for using the methods described throughout this application and applied in the examples below. Knowing the total census-level audience size {X_{⋅}}, the total census-level impressions count {T_{⋅}}, and the total census-level duration {V_{⋅}} constrains the first, second, and third cross-demographic total census parameter values. The example search space identification circuitry 226 generates the example search space according to the inequality bounds in accordance with Equations 163-165 listed below:

0≤c₁≤∞ Equation 163

0≤c₂≤1.25 Equation 164

0≤c₃≤1.10 Equation 165

The example search space identification circuitry 226 reduces the search space based on the Equations 65-73. The numerical values are shown below in Equation 166-176:

s⁽¹⁾=∞ Equation 166

s⁽²⁾=1.25 Equation 167

s⁽³⁾=1.1 Equation 168

t⁽²⁾={0.95,1.01333,1.14} Equation 169

t⁽³⁾={0.982143,1.11063,1.38889} Equation 170

c₂^{(min)}=0.95 Equation 171

c₂^{(max)}=1.14 Equation 172

c₃^{(min)}=0.982143 Equation 173

c₃^{(max)}=1.1 Equation 174

c₁^{(min)}=0 Equation 175

c₁^{(max)}=8.66457 Equation 176

Based on Equations 166-176, the example search space identification circuitry 226 improves the bounds in accordance with Equations 177-179 listed below:

0≤c₁≤8.66457 Equation 177

0.95≤c₂≤1.14 Equation 178

0.982143≤c₃≤1.10 Equation 179

The example iteration circuitry 230 iterates for the first, second, and third cross-demographic total census parameter values in the respective ranges of Equation 177-179. The census-level metrics calculation circuitry 228 determines census-level metrics values that satisfy the total audience constraint, the total impressions constraint and total duration constraints (e.g., ΣXₖ=X_{⋅}, ΣTₖ=T_{⋅}, and ΣVₖ=V_{⋅}). In the example of FIGS. 11A-B, the example iteration circuitry 230 landed on {c₁*, c₂*, c₃*}={2.25136, 0.992204, 1.02512}, which is evaluated (e.g., verified, checked) by the example census-level metrics calculation circuitry 228. The first, second and third cross-demographic total census parameter values (e.g., c₁=2.25136, c₂=0.992204 and c₃=1.02512) are input in the below Equations 180-188 (which are based on discrete Equations 50-58 but have values based on the specific cross-demographic values substituted in), and the equations removed the demographic index k for clarity:

W^{(T)}={309.355,204.678,101.559} Equation 180

W^{(ΔT)}={224.626,179.398,95.4776} Equation 181

∫^{(T)}={4.8488,3.90859,2.95394} Equation 182

∫^{(ΔT)}={13.6911,4.68569,1.93263} Equation 183

∫(V)={18.5399,8.59427,4.88657} Equation 184

o={0.806503,3.69849,12.5885} Equation 185

X={553.556,425.669,220.775} Equation 186

T={2684.08,1663.76,652.158} Equation 187

V={10262.8,3658.32,1078.83} Equation 188

Wherein in Equations 180-188, the first, second and third cross-demographic total census parameter values (e.g., c₁=2.25136, c₂=0.992204 and c₃=1.02512) match the first constraint wherein all impressions of each demographic (T₁ for the first demographic, T₂ for the second demographic and T₃ for the third demographic in this illustrated example) add up to the total census-level impressions count {T_{⋅}}. Similarly, the example first, second and third cross-demographic total census parameter values match the first constraint wherein all impression duration of each demographic (V₁ for the first demographic, V₂ for the second demographic and V₃ for the third demographic in this illustrated example) add up to the total impression duration {V_{⋅}}. Finally, the example first, second and third cross-demographic total census parameter values match the third constraint wherein each audience size of each demographic (X₁ for the first demographic, X₂ for the second demographic and X₃ for the third demographic in this illustrated example) add up to the total impression duration {X_{⋅}}.

FIG. 11B is the solved audience metrics table 1104. As seen in FIG. 11B, there is a total of twelve hundred (1,200) audience members in at the census-level database, while there is a total of six hundred (600) audience members in the subscriber database (e.g., database proprietor database, panel database, etc.). The audience size for the first demographic is five hundred and fifty-four (554) audience members, the audience size for the second demographic is four hundred and twenty-six (426) audience members and the audience size for the third demographic is two hundred and twenty-one (221) audience members. The sum of the audience sizes of the three demographics is equal to the total census-level audience size of twelve hundred (1,200) audience members (e.g., 554+426+221=1200; ΣXₖ=X_{⋅}). Similarly, the impressions constraint and the duration constraint match, which verify the solution represented in the solved audience metrics table 1104.

FIG. 12A illustrates an example table 1202 which includes the audience metrics data matching the example fourth continuous scenario 840 of FIG. 8C. The example table 1202 is the example table 700 of FIG. 7 with example set of data available from subscriber data of FIG. 1 (subscriber audience size values 124, subscriber impression count data 126, and continuous subscriber impression duration values 128) and an example set of data available for census-level total impressions 136 and continuous total impression durations 138 of FIG. 1.

In the example of FIG. 12A, three different demographics (k) are considered (e.g., a total of three). The population (e.g., universal audience Uₖ) for each demographic (e.g., k=1-3) ranges from a total of 1,000 individuals to a total of 3,000 individuals for demographics 1-3, respectively. The subscriber data includes audience values, impression values, and continuous duration values for each demographic, as well as values for total audience size, total impression counts, and total impression durations. The census-level data includes only total impression counts (e.g., 5,000) and total impression durations (e.g., 15,000), whereas demographic-specific census-level unique audience size, census-level impression counts, and census-level impression duration, as well as the total census-level audience size {X_{⋅}}, are all variables to be solved for using the methods described throughout this application and applied in the examples below. Knowing the total census-level impressions count {T_{⋅}}, and total census-level duration {V_{⋅}} constrains the second and third cross-demographic total census parameter values. The total census-level audience size {X_{⋅}} is unknown (e.g., unconstrained), wherein the first cross-demographic total census parameter value is set to a value of one (1). The example search space identification circuitry 226 generates the example search space according to the inequality bounds in accordance with Equations 189-190 listed below:

0≤c₂≤1.25 Equation 189

−∞≤c₃≤0.06667 Equation 190

The example search space identification circuitry 226 is to constrain the search space based on the continuous Equations 132-134. In some examples, the search space identification circuitry 226 constrains the search space based on the continuous Equations 151-152. The continuous Equations 132, 133, 134, 151, and 152 are stored in the example continuous logic circuitry 214. For example, the highest impression frequency (e.g., pageview frequency) among all demographics is ∫*=5, and the highest duration frequency is m*=15. For each value of the second cross-demographic total census parameter value in between the range, the example iteration circuitry 230 iterates the cross-demographic total census parameter value, and the example census-level metrics calculation circuitry 228 determines the estimated census-level audience data, impressions, and durations (e.g., according to continuous Equations 117-119). The census-level metrics calculation circuitry 228 determines values wherein the total impressions and total duration constraints (e.g., ΣTₖ=T_{⋅} and ΣΔTₖ=ΔT_{⋅}) are satisfied in accordance with Equations 191-193:

s⁽¹⁾={0.007143,0.004572,0.003592} Equation 191

s⁽²⁾={0.800000,0.750000,0.666667} Equation 192

s⁽³⁾={0.935507,0.883860,0.811936} Equation 193

In the example of FIGS. 13A-B, the example iteration circuitry 230 landed on {c₂*,c₃*}={1.057027, 0.024124}, which is evaluated (e.g., verified, checked) by the example census-level metrics calculation circuitry 228. The sample second and third cross-demographic total census parameter values (e.g., c₂=1.057027 and c₃=0.024124) are input in the below equations 178-183 (which are based on continuous Equations 126-131), but have values based on the specific cross-demographic total census parameter values substituted in), and the equations removed the demographic index k for clarity:

[symbol]

={6.47758,4.82555,3.38621} Equation 194

[symbol]

={23.5059,10.0672,5.42861} Equation 195

ô={0.091968,0.176098,0.0465294} Equation 196

\hat{X}={479 299 133} Equation 197

\hat{T}={3,013 1,445 452} Equation 198

\hat{V}={11,261 3,015 724} Equation 199

Wherein in Equations 194-199, the example second and third cross-demographic total census parameter values match the first constraint wherein all impressions of each demographic (T₁ for the first demographic, T₂ for the second demographic and T₃ for the third demographic in this illustrated example) add up to the total census-level impressions count {T_{⋅}}. Similarly, the example second and third cross-demographic total census parameter values match the first constraint wherein all impression duration of each demographic (V₁ for the first demographic, V₂ for the second demographic and V₃ for the third demographic in this illustrated example) add up to the total impression duration {V_{⋅}}.

FIG. 12B is the solved audience metrics table 1204. As seen in FIG. 12B, there is a total of nine hundred and eleven (911) audience members in at the census-level database, while there is a total of six hundred (600) audience members in the subscriber database (e.g., database proprietor database, panel database, etc.). The audience size for the first demographic is four hundred and seventy nine (479) audience members, the audience size for the second demographic is two hundred and ninety nine (299) audience members and the audience size for the third demographic is one hundred and thirty three (133) audience members. The sum of the audience sizes of the three demographics is equal to the total census-level audience size of nine hundred and eleven (911) audience members (e.g., 479+299+133=911; ΣXₖ=X_{⋅}). Similarly, the impressions constraint and the duration constraint match, which verify the solution represented in the solved audience metrics table 1204. The example continuous duration time unit determination circuitry 212 may scale the durations in a new unit, which results in a different third cross demographic total census parameter c₃* (scaled in the opposite direction). The estimated census audience sizes per each demographic and the impressions (e.g., pageviews) remain the same, while the estimated durations are scaled by the same original factor. For example, durations in minutes would be larger than the durations in hours.

FIG. 13A illustrates an example table 1302 which includes the audience metrics data matching the example eighth continuous scenario 848 of FIG. 8C. The example table 1302 is the example table 700 of FIG. 7 with example set of data available from subscriber data of FIG. 1 (subscriber audience size values 124, subscriber impression count values 126, and continuous subscriber duration data 128) and an example set of data available for census-level total audience size 134, census-level total impressions 136 and census-level total impression durations 138 of FIG. 1.

In the example of FIG. 13A, three different demographics (k) are considered (e.g., a total of three). The population (e.g., universal audience Uₖ) for each demographic (e.g., k=1-3) ranges from a total of 1,000 individuals to a total of 3,000 individuals for demographics 1-3, respectively. The subscriber data includes audience values, impression values, and discrete duration values for each demographic, as well as values for total audience size, total impression counts, and total impression durations. The census-level data includes total census-level audience size {X_{⋅}} (e.g., 1,000), total census-level impressions count {T_{⋅}} (e.g., 5,000) and total census-level duration {V_{⋅}} (e.g., 15,000), whereas the demographic-specific census-level unique audience size, census-level impression counts, and census-level impression duration are variables to be solved for using the methods described throughout this application and applied in the examples below. Knowing the total census-level audience size {X_{⋅}}, the total census-level impressions count {T_{⋅}}, and the total census-level duration {V_{⋅}} constrains the first, second, and third cross-demographic total census parameter values. The example search space identification circuitry 226 generates the example search space according to the inequality bounds in accordance with Equations 200-202 listed below:

0≤c₁<∞ Equation 200

0≤c₂≤1.25 Equation 201

−∞≤c₃≤0.06667 Equation 202

The example probability divergence determination circuitry 222 determines the census s-variables, which are equivalent to panel (e.g., subscriber) z-variables. The numerical values are shown below in Equations 203-205 (which are equivalent to Equations 191-193):

s⁽¹⁾={0.007143,0.004572,0.003592} Equation 203

s⁽²⁾={0.800000,0.750000,0.666667} Equation 204

s⁽³⁾={0.935507,0.883860,0.811936} Equation 205

The example iteration circuitry 230 iterates for the first, second, and third cross-demographic total census parameter values in the respective ranges of Equation 203-205. The census-level metrics calculation circuitry 228 determines census-level metrics values that satisfy the total audience constraint, the total impressions constraint and total duration constraints (e.g., ΣXₖ=X_{⋅}, Tₖ=T_{⋅}, and ΣVₖ=V_{⋅}). In the example of FIGS. 11A-B, the example iteration circuitry 230 landed on {c₁*, c₂*,c₃*}={1.313494, 1.037946, 0.020597} which is evaluated (e.g., verified, checked) by the example census-level metrics calculation circuitry 228. The first, second and third cross-demographic total census parameter values (e.g., c₁=1.313494, c₂ 1.037946 and c₃=0.020597) are input in the below equations (which are based on continuous Equations 126-131, but have values based on the specific cross-demographic values substituted in), and the equations removed the demographic index k for clarity:

[symbol]

={5.89473,4.51385,3.24638} Equation 206

[symbol]

={21.7064,9.72199,5.32663} Equation 207

ô={0.996818,0.205172,0.0564538} Equation 208

\hat{X}={499 340 160} Equation 209

\hat{T}={2,943 1,537 520} Equation 210

\hat{V}={10,836 3,310 854} Equation 211

Wherein in Equations 206-211, the first, second and third cross-demographic total census parameter values (e.g., c₁=1.313494, c₂ 1.037946 and c₃=0.020597) match the first constraint wherein all impressions of each demographic (T₁ for the first demographic, T₂ for the second demographic and T₃ for the third demographic in this illustrated example) add up to the total census-level impressions count {T_{⋅}}. Similarly, the example first, second and third cross-demographic total census parameter values match the first constraint wherein all impression duration of each demographic (V₁ for the first demographic, V₂ for the second demographic and V₃ for the third demographic in this illustrated example) add up to the total impression duration {V_{⋅}}. Finally, the example first, second and third cross-demographic total census parameter values match the third constraint wherein each audience size of each demographic (X₁ for the first demographic, X₂ for the second demographic and X₃ for the third demographic in this illustrated example) add up to the total impression duration {X_{⋅}}.

FIG. 13B is the solved audience metrics table 1304 wherein the continuous durations are scaled in minutes. As seen in FIG. 13B, there is a total of one thousand (1,000) audience members in at the census-level database, while there is a total of six hundred (600) audience members in the subscriber database (e.g., database proprietor database, panel database, etc.). The audience size for the first demographic is four hundred and ninety-nine (499) audience members, the audience size for the second demographic is three hundred and forty (340) audience members and the audience size for the third demographic is one hundred and sixty (160) audience members. The sum of the audience sizes of the three demographics is equal to the total census-level audience size of one thousand (1,000) audience members (e.g., 499+340+160=1,000; ΣXₖ=X_{⋅}). Similarly, the impressions constraint and the duration constraint match, which verify the solution represented in the solved audience metrics table 1204. The example continuous duration time unit determination circuitry 212 may scale the durations in a new unit, which results in a different third cross demographic total census parameter c₃* (scaled in the opposite direction). The estimated census audience sizes per each demographic and the impressions (e.g., pageviews) remain the same, while the estimated durations are scaled by the same original factor. For example, durations in minutes would be larger than the durations in hours.

FIG. 13C is solved audience metrics table 1306, wherein the continuous durations are scaled as hours. The continuous duration time unit determination circuitry 212 may perform the calculations with the durations in a different unit. However, the value for the audience size and the value for the impression counts (e.g., page views) in the solved audience metrics table 1306 is the same value for the audience size and the same value for the impression counts in the solved audience metrics table 1304 of FIG. 13B.

FIG. 13C is the example table wherein the duration is in hours. FIG. 13C illustrates solved audience metrics table 1306 with an example variable characterization based on scale independence and scale invariance, the example audience metrics estimation circuitry 140 of FIGS. 1-2 generating estimations of census-level unique audience and impressions. For example, as described in the example solutions used to populate table 700 of FIG. 7, as the time units used in impression duration (D) are scaled for any unit (e.g., seconds, minutes, hours, etc.), the estimated census-level impression duration (D) for each demographic also scales by the same factor, while the estimated audience size (A) and impression counts (R) can remain the same. As such, both audience and impression counts are independent of scale but impression duration is invariant to scale. The final census-level estimates {X, T, V} includes audience size and impression counts that are not affected by the scaling, while the impression duration is scaled, as previously illustrated in the example solutions for solved audience metrics table 1306 of FIG. 13C. In FIG. 13B, for the first demographic, the audience size is four hundred and ninety-nine (499) individuals and the impression count (e.g., page views) is two thousand nine hundred and forty-three (2,943) impressions. The duration for the first demographic is ten thousand, eight hundred and thirty-six (10,836) minutes. Scaling the minutes into hours (e.g., selecting hours as the unit of time) does not alter the audience size or the impression count as shown in FIG. 13C. In FIG. 13C, the duration for the first demographic is one hundred and eighty point six (180.6) hours, while the audience size is still four hundred and ninety nine (499) individuals and the impression count (e.g., page views) is still two thousand nine hundred and forty-three (2,943) impressions. The scaling may occur before calculations are performed.

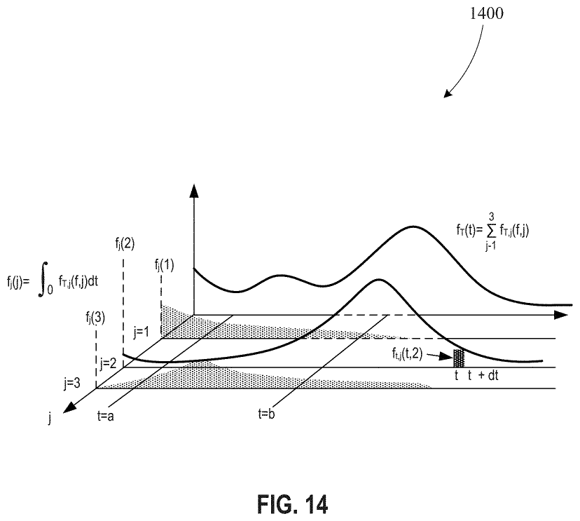

FIG. 14 is a visual example of a joint distribution 1400 which is continuous in a first dimension and discrete in a second dimension. FIG. 14 illustrates a joint distribution of T and J and the related marginal and conditional distributions. The joint probability density function of T and J is noted by f_{T,J}(t,j), the marginal probability function of J by f_{J}(j), and the marginal probability density function of T by f_{T}(t). In FIG. 14, J is a discrete random variable and T is continuous. In examples disclosed herein, the impression counts (R) were a discrete random variable, while the durations (D) were continuous.

FIG. 15 is a block diagram of an example processor platform 1500 structured to execute and/or instantiate the machine readable instructions and/or operations of FIGS. 3-6 to implement the apparatus of FIGS. 1-2. The processor platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1500 of the illustrated example includes processor circuitry 1512. The processor circuitry 1512 of the illustrated example is hardware. For example, the processor circuitry 1512 can be implemented by one or more integrated circuits, logic circuits, FPGAs microprocessors, CPUs, GPUs, DSPs, and/or microcontrollers from any desired family or manufacturer. The processor circuitry 1512 may be implemented by one or more semiconductor based (e.g., silicon based) devices. For example, the processor circuitry 1512 may be a general purpose processor programmed to execute instructions to instantiate some or all of the example network interface 202, the example data storage 204, the example duration metrics control circuitry 206, the example continuous duration control circuitry 208, the example discrete duration control circuitry 210, the example continuous duration time unit determination circuitry 212, the example continuous logic circuitry 214, the example discrete duration difference circuitry 216, the example discrete logic circuitry 218, the example probability distribution generation circuitry 220, the example probability divergence determination circuitry 222, the example cross-demographic total census parameter value determination circuitry 224, the example search space identification circuitry 226, the example census-level metrics calculation circuitry 228, the example iteration circuitry 230, and the example report circuitry 232.

The processor circuitry 1512 of the illustrated example includes a local memory 1513 (e.g., a cache, registers, etc.). The processor circuitry 1512 of the illustrated example is in communication with a main memory including a volatile memory 1514 and a non-volatile memory 1516 by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517.

The processor platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1522 are connected to the interface circuitry 1520. The input device(s) 1522 permit(s) a user to enter data and/or commands into the processor circuitry 1512. The input device(s) 1522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1524 are also connected to the interface circuitry 1520 of the illustrated example. The output devices 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1500 of the illustrated example also includes one or more mass storage devices 1528 to store software and/or data. Examples of such mass storage devices 1528 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1532, which may be implemented by the machine readable instructions of FIGS. 3-6, may be stored in the mass storage device 1528, in the volatile memory 1514, in the non-volatile memory 1516, and/or on a removable non-transitory computer readable storage medium such as a CD or DVD.

FIG. 16 is a block diagram of an example implementation of the processor circuitry 1512 of FIG. 15. In this example, the processor circuitry 1512 of FIG. 15 is implemented by a general purpose microprocessor 1600. The general purpose microprocessor circuitry 1600 execute some or all of the machine readable instructions of the flowchart of FIGS. 3-6 to effectively instantiate the circuitry of FIG. 2 as logic circuits to perform the operations corresponding to those software instructions. For example, the microprocessor 1600 may implement multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine readable instructions and/or operations represented by the flowchart of FIGS. 3-6.

The cores 1602 may communicate by an example first bus 1604. In some examples, the first bus 1604 may implement a communication bus to effectuate communication associated with one(s) of the cores 1602. For example, the first bus 1604 may implement at least one of an Inter-Integrated Circuit (I2C) bus, a Serial Peripheral Interface (SPI) bus, a PCI bus, or a PCIe bus. Additionally or alternatively, the first bus 1604 may implement any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2_ cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the L1 cache 1620, and an example second bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating point operations. In yet other examples, the AL circuitry 1616 may include first AL circuitry that performs integer based operations and second AL circuitry that performs floating point operations. In some examples, the AL circuitry 1616 may be referred to as an Arithmetic Logic Unit (ALU). The registers 1618 are semiconductor-based structures to store data and/or instructions such as results of one or more of the operations performed by the AL circuitry 1616 of the corresponding core 1602. For example, the registers 1618 may include vector register(s), SIMD register(s), general purpose register(s), flag register(s), segment register(s), machine specific register(s), instruction pointer register(s), control register(s), debug register(s), memory management register(s), machine check register(s), etc. The registers 1618 may be arranged in a bank as shown in FIG. 17. Alternatively, the registers 1618 may be organized in any other arrangement, format, or structure including distributed throughout the core 1602 to shorten access time. The second bus 1622 may implement at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 17 is a block diagram of another example implementation of the processor circuitry 1512 of FIG. 15. In this example, the processor circuitry 1512 is implemented by FPGA circuitry 1700. The FPGA circuitry 1700 can be used, for example, to perform operations that could otherwise be performed by the example microprocessor 1600 of FIG. 16 executing corresponding machine readable instructions. However, once configured, the FPGA circuitry 1700 instantiates the machine readable instructions in hardware and, thus, can often execute the operations faster than they could be performed by a general purpose microprocessor executing the corresponding software.

More specifically, in contrast to the microprocessor 1600 of FIG. 16 described above (which is a general purpose device that may be programmed to execute some or all of the machine readable instructions represented by the flowcharts of FIGS. 3-6 but whose interconnections and logic circuitry are fixed once fabricated), the FPGA circuitry 1700 of the example of FIG. 17 includes interconnections and logic circuitry that may be configured and/or interconnected in different ways after fabrication to instantiate, for example, some or all of the machine readable instructions represented by the flowchart of FIGS. 3-6. In particular, the FPGA 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the software represented by the flowchart of FIGS. 3-6. As such, the FPGA circuitry 1700 may be structured to effectively instantiate some or all of the machine readable instructions of the flowcharts of FIGS. 3-6 as dedicated logic circuits to perform the operations corresponding to those software instructions in a dedicated manner analogous to an ASIC. Therefore, the FPGA circuitry 1700 may perform the operations corresponding to the some or all of the machine readable instructions of FIGS. 3-6 faster than the general purpose microprocessor can execute the same.

In the example of FIG. 17, the FPGA circuitry 1700 is structured to be programmed (and/or reprogrammed one or more times) by an end user by a hardware description language (HDL) such as Verilog. The FPGA circuitry 1700 of FIG. 17, includes example input/output (I/O) circuitry 1702 to obtain and/or output data to/from example configuration circuitry 1704 and/or external hardware (e.g., external hardware circuitry) 1706. For example, the configuration circuitry 1704 may implement interface circuitry that may obtain machine readable instructions to configure the FPGA circuitry 1700, or portion(s) thereof. In some such examples, the configuration circuitry 1704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1706 may implement the microprocessor 1700 of FIG. 17. The FPGA circuitry 1700 also includes an array of example logic gate circuitry 1708, a plurality of example configurable interconnections 1710, and example storage circuitry 1712. The logic gate circuitry 1708 and interconnections 1710 are configurable to instantiate one or more operations that may correspond to at least some of the machine readable instructions of FIGS. 3-6 and/or other desired operations. The logic gate circuitry 1708 shown in FIG. 17 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations. The logic gate circuitry 1708 may include other electrical structures such as look-up tables (LUTs), registers (e.g., flip-flops or latches), multiplexers, etc.

The interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example Dedicated Operations Circuitry 1714. In this example, the Dedicated Operations Circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the processor circuitry 1512 of FIG. 15, many other approaches are contemplated. For example, as mentioned above, modern FPGA circuitry may include an on-board CPU, such as one or more of the example CPU 1720 of FIG. 17. Therefore, the processor circuitry 1512 of FIG. 15 may additionally be implemented by combining the example microprocessor 1600 of FIG. 16 and the example FPGA circuitry 1700 of FIG. 17. In some such hybrid examples, a first portion of the machine readable instructions represented by the flowchart of FIGS. 3-6 may be executed by one or more of the cores 1602 of FIG. 16 and a second portion of the machine readable instructions represented by the flowchart of FIGS. 3-6 may be executed by the FPGA circuitry 1700 of FIG. 17.

In some examples, the processor circuitry 1512 of FIG. 15 may be in one or more packages. For example, the processor circuitry 1600 of FIG. 16 and/or the FPGA circuitry 1700 of FIG. 17 may be in one or more packages. In some examples, an XPU may be implemented by the processor circuitry 1512 of FIG. 17, which may be in one or more packages. For example, the XPU may include a CPU in one package, a DSP in another package, a GPU in yet another package, and an FPGA in still yet another package.

A block diagram illustrating an example software distribution platform 1805 to distribute software such as the example machine readable instructions 1532 of FIGS. 3-6 to hardware devices owned and/or operated by third parties is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform 1805. For example, the entity that owns and/or operates the software distribution platform 1805 may be a developer, a seller, and/or a licensor of software such as the example machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532, which may correspond to the example machine readable instructions 300, 400, 500, 600 of FIGS. 3-6, as described above. The one or more servers of the example software distribution platform 1805 are in communication with a network 1810, which may correspond to any one or more of the Internet and/or any of the example networks 1526 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. For example, the software, which may correspond to the example machine readable instructions 1532 of FIG. 15 may be downloaded to the example processor platform 1500, which is to execute the machine readable instructions 1532 to implement the audience metrics estimation circuitry 140. In some example, one or more servers of the software distribution platform 1805 periodically offer, transmit, and/or force updates to the software (e.g., the example machine readable instructions 1532 of FIG. 15) to ensure improvements, patches, updates, etc., are distributed and applied to the software at the end user devices.

From the foregoing, it will be appreciated that example systems, methods, apparatus, and articles of manufacture have been disclosed to estimate census-level audience metrics based on discrete or continuous durations. Disclosed systems, methods, apparatus, and articles of manufacture improve the efficiency of using a computing device by reducing wasted computational resources of a computer by reducing a search space for cross-demographic parameter values. The efficiency of the computer device is improved because there are less cross-demographic parameter values to iterate. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to estimate census-level audience metrics based on discrete or continuous durations are disclosed herein. Further examples and combinations thereof include the following:

Example 1 includes an apparatus to estimate demographic census-level audience metrics comprising interface circuitry to access subscriber audience metrics data and total census-level audience metrics data, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations or the third operations to instantiate discrete duration difference circuitry to scale at least one of subscriber duration values or total census-level duration values to generate a scaled duration value that corresponds to an impression count of at least a threshold amount of duration time, cross-demographic total census parameter value determination circuitry to determine cross-demographic total census parameter values based on the scaled duration value, search space identification circuitry to determine a search space of possible cross-demographic total census parameter values, the search space to include the determined cross-demographic total census parameter values, census-level metrics calculation circuitry to determine census-level metrics based on the determined cross-demographic total census parameter values, the census-level metrics including demographic census-level audience size data and demographic census duration values, and report circuitry to output a report of the census-level metrics.

Example 2 includes the apparatus of example 1, wherein the census-level metrics further include demographic census impression count data and the threshold amount of duration time is at least one second.

Example 3 includes the apparatus of example 1, wherein the processor circuitry is to further instantiate iteration circuitry to iterate over the search space of possible cross-demographic total census parameter values to iteratively determine a census-level metrics.

Example 4 includes the apparatus of example 1, wherein the search space identification circuitry is to constrain the search space of cross-demographic total census parameter values based on total census-level audience size data.

Example 5 includes the apparatus of example 1, wherein the processor circuitry is to further instantiate probability distribution generation circuitry to generate a subscriber probability distribution and a census-level probability distribution.

Example 6 includes the apparatus of example 5, wherein the processor circuitry is to further instantiate probability divergence determination circuitry to use a Kullback-Leibler (KL) divergence to generate the cross-demographic total census parameter values based on the subscriber probability distribution and the census-level probability distribution.

Example 7 includes the apparatus of example 1, wherein the processor circuitry is to further instantiate duration metrics control circuitry to estimate the census-level metrics based on discrete duration values in response to an indicator variable.

Example 8 includes the apparatus of example 1, wherein the processor circuitry is to further instantiate duration metrics control circuitry to estimate the census-level metrics based on continuous duration values in response to an indicator variable.

Example 9 includes the apparatus of example 8, wherein the processor circuitry is to further instantiate continuous duration time unit determination circuitry to select a consistent time unit for durations before estimating the census-level metrics, wherein the audience size and the impression count remain consistent.

Example 10 includes the apparatus of example 1, wherein the census-level metrics calculation circuitry is to estimate census-level metrics for individual demographics.

Example 11 includes an apparatus comprising at least one memory, instructions, and processor circuitry to execute the instructions to scale at least one of subscriber duration values or total census-level duration values to generate a scaled duration value that corresponds to an impression count of at least a threshold amount of duration time, determine cross-demographic total census parameter values based on the scaled duration value, determine a search space of possible cross-demographic total census parameter values, the search space to include the determined cross-demographic total census parameter values, determine census-level metrics based on the determined cross-demographic total census parameter values, the census-level metrics including demographic census-level audience size data and demographic census duration values, and output a report of the census-level metrics.

Example 12 includes the apparatus of example 11, wherein the census-level metrics further include demographic census impression count data and the threshold amount of duration time is at least one second.

Example 13 includes the apparatus of example 11, wherein the processor circuitry is to iterate over the search space of possible cross-demographic total census parameter values to iteratively determine a census-level metrics.

Example 14 includes the apparatus of example 11, wherein the processor circuitry is to constrain the search space of cross-demographic total census parameter values based on total census-level audience size data.

Example 15 includes the apparatus of example 11, wherein the processor circuitry is to generate a subscriber probability distribution and a census-level probability distribution.

Example 16 includes the apparatus of example 15, wherein the processor circuitry is to use a Kullback-Leibler (KL) divergence to generate the cross-demographic total census parameter values based on the subscriber probability distribution and the census-level probability distribution.

Example 17 includes the apparatus of example 11, wherein the processor circuitry is to estimate the census-level metrics based on discrete duration values in response to an indicator variable.

Example 18 includes the apparatus of example 11, wherein the processor circuitry is to estimate the census-level metrics based on continuous duration values in response to an indicator variable.

Example 19 includes the apparatus of example 18, wherein the processor circuitry is to select a consistent time unit for durations before estimating the census-level metrics, wherein the audience size and the impression count remain consistent.

Example 20 includes the apparatus of example 11, wherein the processor circuitry is to estimate census-level metrics for individual demographics.

Example 21 includes a non-transitory computer readable medium comprising instructions that, when executed, cause processor circuitry to at least scale at least one of subscriber duration values or total census-level duration values to generate a scaled duration value that corresponds to an impression count of at least a threshold amount of duration time, determine cross-demographic total census parameter values based on the scaled duration value, determine a search space of possible cross-demographic total census parameter values, the search space includes the determined cross-demographic total census parameter values, determine census-level metrics based on the determined cross-demographic total census parameter values, the census-level metrics including demographic census-level audience size data and demographic census duration values, and output a report of the census-level metrics.

Example 22 includes the non-transitory computer readable medium of example 21, wherein the census-level metrics further include demographic census impression count data and the threshold amount of duration time is at least one second.

Example 23 includes the non-transitory computer readable medium of example 21, wherein the instructions are to cause the processor circuitry to iterate over the search space of possible cross-demographic total census parameter values to iteratively determine a census-level metrics.

Example 24 includes the non-transitory computer readable medium of example 21, wherein the instructions are to cause the processor circuitry to constrain the search space of cross-demographic total census parameter values based on total census-level audience size data.

Example 25 includes the non-transitory computer readable medium of example 21, wherein the instructions are to cause the processor circuitry to generate a subscriber probability distribution and a census-level probability distribution.

Example 26 includes the non-transitory computer readable medium of example 25, wherein the instructions are to cause the processor circuitry to use a Kullback-Leibler (KL) divergence to generate the cross-demographic total census parameter values based on the subscriber probability distribution and the census-level probability distribution.

Example 27 includes the non-transitory computer readable medium of example 21, wherein the instructions are to cause the processor circuitry to estimate the census-level metrics based on discrete duration values in response to an indicator variable.

Example 28 includes the non-transitory computer readable medium of example 21, wherein the processor circuitry is to estimate the census-level metrics based on continuous duration values in response to an indicator variable.

Example 29 includes the non-transitory computer readable medium of example 28, wherein the instructions are to cause the processor circuitry to select a consistent time unit for durations before estimating the census-level metrics, wherein the audience size and the impression count remain consistent.

Example 30 includes the non-transitory computer readable medium of example 21, wherein the instructions are to cause the processor circuitry to estimate census-level metrics for individual demographics.

Example 31 includes an apparatus for estimating census-level audience metrics, the apparatus comprising means for scaling at least one of subscriber duration values or total census-level duration values to generate a scaled duration value that corresponds to an impression count of at least a threshold amount of duration time, means for determining cross-demographic total census parameter values based on the scaled duration value, means for determining a search space of possible cross-demographic total census parameter values, the search space includes the determined cross-demographic total census parameter values, means for determining census-level metrics based on the determined cross-demographic total census parameter values, the census-level metrics including demographic census-level audience size data and demographic census duration values, and means for outputting a report of the census-level metrics.

Example 32 includes the apparatus of example 31, wherein the census-level metrics further include demographic census impression count data and the threshold amount of duration time is at least one second.

Example 33 includes the apparatus of example 31, the apparatus further including means for iterating over the search space of possible cross-demographic total census parameter values to iteratively determine a census-level metrics.

Example 34 includes the apparatus of example 31, the apparatus further including means for constraining the search space of cross-demographic total census parameter values based on total census-level audience size data.

Example 35 includes the apparatus of example 31, the apparatus further including means for generating a subscriber probability distribution and a census-level probability distribution.

Example 36 includes the apparatus of example 35, the apparatus further including means for using a Kullback-Leibler (KL) divergence to generate the cross-demographic total census parameter values based on the subscriber probability distribution and the census-level probability distribution.

Example 37 includes the apparatus of example 31, the apparatus further including means for estimating the census-level metrics based on discrete duration values in response to an indicator variable.

Example 38 includes the apparatus of example 31, the apparatus further including means for estimating the census-level metrics based on continuous duration values in response to an indicator variable.

Example 39 includes the apparatus of example 38, the apparatus further including means for selecting a consistent time unit for durations before estimating the census-level metrics, wherein the audience size and the impression count remain consistent.

Example 40 includes the apparatus of example 31, the apparatus further including means for estimating census-level metrics for individual demographics.

Example 41 includes a method for estimating census-level audience metrics, the method comprising scaling at least one of subscriber duration values or total census-level duration values to generate a scaled duration value that corresponds to an impression count of at least a threshold amount of duration time, determining cross-demographic total census parameter values based on the scaled duration value, determining a search space of possible cross-demographic total census parameter values, the search space includes the determined cross-demographic total census parameter values, determining census-level metrics based on the determined cross-demographic total census parameter values, the census-level metrics including demographic census-level audience size data and demographic census duration values, and outputting a report of the census-level metrics.

Example 42 includes the method of example 41, wherein the census-level metrics further include demographic census impression count data and the threshold amount of duration time is at least one second.

Example 43 includes the method of example 41, further including iterating over the search space of possible cross-demographic total census parameter values to iteratively determine a census-level metrics.

Example 44 includes the method of example 41, further including constraining the search space of cross-demographic total census parameter values based on total census-level audience size data.

Example 45 includes the method of example 41, further including generating a subscriber probability distribution and a census-level probability distribution.

Example 46 includes the method of example 45, further including using a Kullback-Leibler (KL) divergence to generate the cross-demographic total census parameter values based on the subscriber probability distribution and the census-level probability distribution.

Example 47 includes the method of example 41, further including estimating the census-level metrics based on discrete duration values in response to an indicator variable.

Example 48 includes the method of example 41, further including estimating the census-level metrics based on continuous duration values in response to an indicator variable.

Example 49 includes the method of example 48, further including selecting a consistent time unit for durations before estimating the census-level metrics, wherein the audience size and the impression count remain consistent.

Example 50 includes the method of example 41, further including estimating census-level metrics for individual demographics.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus to estimate demographic census-level audience metrics comprising:
interface circuitry to access subscriber audience metrics data and total census-level audience metrics data; and
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations or the third operations to instantiate:
discrete duration difference circuitry to scale at least one of subscriber duration values or total census-level duration values to generate a scaled duration value that corresponds to an impression count of at least a threshold amount of duration time;
cross-demographic total census parameter value determination circuitry to determine cross-demographic total census parameter values based on the scaled duration value;
search space identification circuitry to determine a search space of possible cross-demographic total census parameter values, the search space to include the determined cross-demographic total census parameter values;
census-level metrics calculation circuitry to determine census-level metrics based on the determined cross-demographic total census parameter values, the census-level metrics including demographic census-level audience size data and demographic census duration values; and
report circuitry to output a report of the census-level metrics.

2. The apparatus of claim 1, wherein the census-level metrics further include demographic census impression count data and the threshold amount of duration time is at least one second.

3. The apparatus of claim 1, wherein the processor circuitry is to further instantiate iteration circuitry to iterate over the search space of possible cross-demographic total census parameter values to iteratively determine a census-level metrics.

4. The apparatus of claim 1, wherein the search space identification circuitry is to constrain the search space of cross-demographic total census parameter values based on total census-level audience size data.

5. The apparatus of claim 1, wherein the processor circuitry is to further instantiate probability distribution generation circuitry to generate a subscriber probability distribution and a census-level probability distribution.

6. The apparatus of claim 5, wherein the processor circuitry is to further instantiate probability divergence determination circuitry to use a Kullback-Leibler (KL) divergence to generate the cross-demographic total census parameter values based on the subscriber probability distribution and the census-level probability distribution.

7. The apparatus of claim 1, wherein the processor circuitry is to further instantiate duration metrics control circuitry to estimate the census-level metrics based on discrete duration values in response to an indicator variable.

8. The apparatus of claim 1, wherein the processor circuitry is to further instantiate duration metrics control circuitry to estimate the census-level metrics based on continuous duration values in response to an indicator variable.

9. The apparatus of claim 8, wherein the processor circuitry is to further instantiate continuous duration time unit determination circuitry to select a consistent time unit for durations before estimating the census-level metrics, wherein the audience size and the impression count remain consistent.

10. The apparatus of claim 1, wherein the census-level metrics calculation circuitry is to estimate census-level metrics for individual demographics.

11. An apparatus comprising:
at least one memory;
instructions; and
processor circuitry to execute the instructions to:
scale at least one of subscriber duration values or total census-level duration values to generate a scaled duration value that corresponds to an impression count of at least a threshold amount of duration time;
determine cross-demographic total census parameter values based on the scaled duration value;
determine a search space of possible cross-demographic total census parameter values, the search space to include the determined cross-demographic total census parameter values;
determine census-level metrics based on the determined cross-demographic total census parameter values, the census-level metrics including demographic census-level audience size data and demographic census duration values; and
output a report of the census-level metrics.

12. The apparatus of claim 11, wherein the census-level metrics further include demographic census impression count data and the threshold amount of duration time is at least one second.

13. The apparatus of claim 11, wherein the processor circuitry is to iterate over the search space of possible cross-demographic total census parameter values to iteratively determine a census-level metrics.

14. The apparatus of claim 11, wherein the processor circuitry is to constrain the search space of cross-demographic total census parameter values based on total census-level audience size data.

15. The apparatus of claim 11, wherein the processor circuitry is to generate a subscriber probability distribution and a census-level probability distribution.

16. The apparatus of claim 15, wherein the processor circuitry is to use a Kullback-Leibler (KL) divergence to generate the cross-demographic total census parameter values based on the subscriber probability distribution and the census-level probability distribution.

17. The apparatus of claim 11, wherein the processor circuitry is to estimate the census-level metrics based on discrete duration values in response to an indicator variable.

18. The apparatus of claim 11, wherein the processor circuitry is to estimate the census-level metrics based on continuous duration values in response to an indicator variable.

19. (canceled)

20. The apparatus of claim 11, wherein the processor circuitry is to estimate census-level metrics for individual demographics.

21. A non-transitory computer readable medium comprising instructions that, when executed, cause processor circuitry to at least:
scale at least one of subscriber duration values or total census-level duration values to generate a scaled duration value that corresponds to an impression count of at least a threshold amount of duration time;
determine cross-demographic total census parameter values based on the scaled duration value;
determine a search space of possible cross-demographic total census parameter values, the search space includes the determined cross-demographic total census parameter values;
determine census-level metrics based on the determined cross-demographic total census parameter values, the census-level metrics including demographic census-level audience size data and demographic census duration values; and
output a report of the census-level metrics.

22.-50. (canceled)
